(19) United States
(12) Patent Application Publication
(10) Pub. No.: US 2017/0244608 A1
(43) Pub. Date: Aug. 24, 2017

(54) SYSTEM, ARCHITECTURE AND METHODS FOR AN INTELLIGENT, SELF-AWARE AND CONTEXT-AWARE DIGITAL ORGANISM-BASED TELECOMMUNICATION SYSTEM

(71) Applicant: Corey K. Reaux-Savonte, London (GB)

(72) Inventor: Corey K. Reaux-Savonte, London (GB)

(21) Appl. No.: 15/129,902

(22) PCT Filed: Mar. 27, 2015
(86) PCT No.: PCT/IB2015/052293

§ 371 Date: Sep. 28, 2016

(30) Foreign Application Priority Data
Mar. 28, 2014 (GB) 1405629.5

(51) Int. Cl. H04L 12/24; G06N 5/02

(52) U.S. Cl. CPC H04L 41/16; H04L 41/5054; G06N 5/022; G06Q 20/085

(57) ABSTRACT

A telecommunication system hosting an intelligent non-physical organism, aiding global communication in both the physical and virtual worlds. Using artificial and ambient intelligence to become self- and context-aware, the system can learn from its surrounding environments, adapt and evolve as it sees fit.

### FIELD OF THE INVENTION

The disclosed embodiments relate to system architecture, telecommunication network infrastructure, computer networks, digital ecosystems and various types of artificial intelligence.

### BACKGROUND

The Internet

The internet was originally created as ARPANET to facilitate reliable military communication during times of war. Eventually, ARPANET become the internet as more computers were added to it and it was made available to the general public. The problem here is that ARPANET was never modified to provide a high level of secure communication and data transmission before it was released from a controlled environment into a world where anyone with a computer could make use of it. Rather than some sort of “front line” security, separate security needed to be installed on computer terminals, meaning data could still make it to a terminal and it would then be up to the terminal itself to ensure it was safe. Combining this lack of security improvement with the fact that when ARPANET was originally created computers would only have been available to technological institutions, scientists, governments, military and possibly the more affluent members of society, all of whom are named being more focused on educational or defensive purposes rather than malicious, the creators of ARPANET and in-turn the internet would most likely not have predicted, and definitely not been able to prepare for an explosion in malicious uses, vulnerabilities and exploits. By the time computers were mainstream and affordable, the internet was already at too late a stage to change its foundation and it could only have certain aspects built upon rather than redeveloped.

Now, in 2013, many argue that the internet has already, or is very much about to, reach its peak. In terms of data transfer the internet is sound, but as days go by, decades after its original inception, the cracks that the world had already caught a glimpse of are now turning into craters, and as more of the dark side is also brought to the public's attention through the media, more people are wondering what can be done about it.
Infrastructure Upgrading—The infrastructure upon which the internet is built requires vast capital to upgrade, particularly in the field of wireless communication such as 3G and 4G mobile communication used by portable smart devices.
Mobile Communication Costs—The cost of mobile internet communication is much more expensive than wired internet connections in homes and offices. Due to the extremely high cost of purchasing spectrum bands, which run into the billions, service providers recover the cost by charging more for wireless internet while at the same time imposing usage limits.
Child Pornography & Indecent Media—As has been abundantly reported in 2013 with a spate of revelations regarding people of all social statuses, child pornography and other indecent media have been rife in society and shared over the internet for decades, yet remained largely undetected due to how the internet works and the ease-of-anonymity associated with it.
Trolling/Bullying—The anonymity of internet users as well as the freedom of speech that is actively encouraged has led to some individuals having a false sense of bravado about themselves as they unreservedly attack others in online communities, knowing that it is unlikely and in most cases extremely difficult to impossible to discover their real life identity.
Origin of Content—There's a common thought that once something is made publicly available on the internet it's out there forever. The original source of content such as images and video is obscured by an infinite number of connections, file sharing and the ability to connect anonymously from anywhere in the world.
Hackers and Malicious Programs—Since the internet itself provides no line of defense, hackers and malicious programs/software are able to reach their destination(s) and it is up to the terminal or server that they come into contact with to keep them at bay. Unfortunately, a lot of the time this is too late.
World Wide Web—The world wide web was created as a common place to share data—ANY data. Although created with good intentions, some of the worst things imaginable in computing have been helped along by what was made possible. As web browsers and technologies advanced, data moved from simply being displayed in a browser window to being downloadable onto a disk drive, with or without a user's permission. This allowed programmers with malicious intent to hide malicious pieces of code in downloadable software and files and, as more vulnerabilities were discovered, trojan horses and other dangerous programs were able to infect a machine just by having a user visit a web page.
Cookies—Used in a simple way cookies are safe. They can be used to store data about what you have previously done so that when you next visit the same website your preferences and such can be restored and relative data can be displayed. When things start progressing, cookies become very dangerous. Storing authentication, activity and form information, if a person's cookies were stolen the thief would be able to become them online, know every single thing they do on the web and, with the right details, bleed the person dry financially.

One major issue and reason for many of these problems is that there was no universal data format for the internet nor the world wide web because they were both publicly released as places where anyone could roam as free as technology would allow. Anything could be distributed in any way, shape or form, meaning there was absolutely no limits or boundaries to what could be shared. Limitless freedom or, to be precise, freedom limited only by what hadn't been developed yet, as with anything in life, eventually led to chaotic situations and trust issues. Over the years companies and organisations have implemented various preventive measures in a bid to help users identify dangerous data sources and prevent security vulnerabilities from being exploited but in open, internet-based environments without any sort of regulation or governance it will always be a losing race for online safety.

Web Browsers

The easiest and most convenient way to view web pages and use web applications, web browsers have become a part of everyday life for most of the world and from a user point of view, things are (mostly) fine. The problems lay in front-end development using HTML, CSS and JS. With multiple browsers from multiple browser vendors, each choosing to support newer advancements when they feel like it and, in some cases, if at all, combined with the length of time it takes for language versions to become standardized, there is a vast period of time where one webpage can have so many different faces or facial features because one browser doesn't support something another does or implements in a different way a particular feature, syntax or property. This can often be a headache for web designers who had a particular vision for a page and has to modify it multiple times to please each browser or, more often than one should, have to settle for leaving out certain things because it's just not possible. In some cases, there are workarounds to get the same presentation, but that usually involves scripting languages, namely JavaScript, being used to create the feature, resulting in a bulkier web page and increased loading times.

Digital Ecosystems And Online Communities

Data—its preservation, distribution, control, searchability, security, accuracy, reliability and efficiency is more important today than it has ever been and, with more of the world relying on internet and digital infrastructure by the second, it becomes increasingly difficult to manage multiple streams from multiple sources around the clock. What's more troublesome is a person finding the data they actually want quickly. This is because the main open network environment used by the world today, the World Wide Web, is filled with only 2 types of data—data a person wants and data a person doesn't. The problem here is that there is barely any organisation across the spectrum, meaning anything can be difficult to find if not searched for under the right conditions. Now, when data useful to one person is utterly useless to another, but the data considered useless is, at that point in time, more than 99.99% of all the data out there, even the most complex search algorithms can yield a mass of results that a person can find daunting and invaluable.

To help with these issues, digital ecosystems have become more prominent in societies around the world. Though social networks and online communities have been around for nearly 3 decades, most have focused on topical interests and subjects such as forums, personal lives and opinions such as blogs or simple photo and video uploading and sharing.

Only since the beginning of the millennium have social network user bases expanded beyond technofreaks and those of specific interests to include general members of the public—and the increase has been both significant and exponential. Having started off on the World Wide Web, now, in 2013 and since the introduction of the first true smartphone in 2007, these ecosystems have migrated to these devices, with each company behind an ecosystem providing their own application software to provide quick and easy access to their services. This dramatically improved the speed performance of access and use of the ecosystems and allowed much more custom functionality than what could have been provided from the World Wide Web, but the trade off was the loss of freedom to update aesthetics and functionality at will and automatically have all users see these new changes without having to push updates which users had the option to ignore.

Some ecosystems used in the smart device world today are controlled by the operating system vendors, such as Google with the Android OS and Apple with iOS, who use proprietary software designed to function at maximum capability with their own OS systems as a way of ensuring users are somewhat forced to stay loyal to their products and services, regardless of whether or not the user chooses to also adopt the services of others. A universal ecosystem hasn't been able to be established for this reason.

The concept of digital ecosystems has been discussed for a number of years. In 2007, a paper entitled “Increasing participation in online communities: A framework for human-computer interaction”, written by Jonathan Bishop was published. He speaks of what drives people to become a part of communities that exist within an ecosystem if they are not an ecosystem themselves—a fundamental part of understanding how a universal ecosystem needs to be designed so it can function in a sustainable, secure and scalable way.

The theories, concepts and opinions mentioned in the paper, both of Jonathon and others, were mostly true at the time of publication as it was written before the explosion of online communities really occurred, but since then it has become irrevocably apparent that the basis of Jonathon's first principle “Principle 1—an actor is driven to act by their desires” where he states “actors are driven by their desires to perform an action as opposed to satisfy an internal entity, such as a need” (people are referred to as actors), is wrong, but by the development of situations rather than a lack of understanding. This is mainly due to the publicly viewable statistics of users such as friend count, profile views, and categorical ranking systems. What was once considered desires have now become needs for most—acceptance and popularity. Regardless of the end of the scale a person may wish to reside, trendsetter on one end or rebel on the other, the dominant percentage of users in these communities are not recognised globally as the person they want to be seen as and, with the freedom of information, communication and sharing available on the internet, it has given rise to a number of pretenseful personalities and characteristics, most noticeably pseudo-intellectualism, pseudo-antisocialism and pseudo-imperialism. Inevitably, this will continue to lead to the implosion of these online communities and ecosystems that are as free as the ones currently in existence, most commonly referred to as social networks. Jonathon speaks of some of the behaviours of these personalities when he mentions the Vengeance desire of level 1 of his framework.

Proprietary ecosystems, such as the one operated by Apple, known as “walled gardens”, are closed to most third-parties when the core of the ecosystem development is in question, and everything must go through them before it can enter the ecosystem, making it much more sustainable and secure than open environments simply because the proprietor controls everything from the ground up. Walled gardens also notoriously exclude extensively social features to the masses from the core of the ecosystem, only allowing those that are designed to connect genuine friends or small sets of people (in comparison to all users of a service as most social networks do. Exceptions do exist such as in the world of Xbox Live, where players can connect randomly to any other players to play a game but the actual friends list has a limitation), while sometimes allowing approved third-party social service providers to operate within the ecosystem using specific features, such as data sharing, or using their own software applications. While much safer and easier to maintain, “walled garden” ecosystems are known to heavily restrict a users freedom of expression as everything must first be pre-approved by the proprietor.

A viable universal ecosystem must provide the key benefits of proprietary ecosystems while allowing users an acceptable amount of freedom to express themselves with at least the option, but not obligation, of being social. A major advantage of the internet and digital world is privacy, personal space and more freedom than in the real world and this must be acknowledged and respected when creating and maintaining a sustainable environment. A common misconception when approaching digital ecosystems is the belief that they can be made, initially or eventually, to operate and be governed just as the real world is, except through the use of computers.

Digital Identities, Authentication and Authorization

With the explosion of digital ecosystems and online communities came the need for people to remember account login information for numerous sites and services. This caused two major issues/concerns:
People would use the same, similar or a small range of passwords for their online accounts, meaning if someone was able to gain the password of an individual, they would have access to multiple accounts of the individual to do what they please.
People would try to, as some ‘experts’ have advised, use different passwords for every online account they have, meaning they would have to remember a multitude of passwords in their head or by writing them down. For those who choose to memorise, they run the risk of forgetting passwords or which to use where, while those who choose to write them down run the risk of someone else finding them.

Some open standards have been introduced and are in use by individuals and businesses of all sizes to help with identity verification and access. Standards for authentication purposes, such as OpenID, allow a user to use one account across all sites and services that support the standard they have an account for. Standards for authorization purposes, such as OAuth, allow a user to access server resources without the need to enter login credentials. A major issue, and possibly the most significant with these, is that it is available for anyone to implement and use and is purely software driven, meaning the security behind them will inevitably be cracked and at a much faster rate than if security hardware was involved as anyone around the world is able to take on the task of cracking it, individually or as a group. A second major issue is that security measures cannot be changed dynamically and immediately. Due to the distributed nature, security flaws can only be fixed by releasing updates, which then requires all who have chosen to implement these systems to download and install the update to completely eradicate previously found flaws.

Real World Connections

Everyday in the world there are people who need the services of other people and turn to the internet or directory services for an answer. Sometimes the answer is down the road while other times the answer is halfway around the world with people they may never meet in person. Sometimes they may never find the answer. Everyday these same people in need walk past a multitude of individuals as they go about their lives, completely oblivious to who they are or what they do. The person they need, the person who can provide the definitive answers and solutions to all their questions and problems may be sitting next to them on the train or standing behind them in a line for coffee, yet they don't even know it. People don't walk around with visible signs letting others know what skills they have and every single day people miss opportunities and don't even know it.

Software Industry's “Race to Zero”

In an article on his website “IPWatchdog” dated 9 Apr. 2009, patent attorney and electronic engineer/software programmer Gene Quinn discusses the “race to zero” of open source software and how free/open source software is killing off proprietary software, inevitably leading to the destruction of the software industry simply due to the fact that with free replicated versions of proprietary software so readily available comes the annihilation of cost, meaning no one makes money from software development. Some “open source advocates”, as Quinn refers to them, argue that the direction in which the industry is heading will force software creators to be innovative to stay ahead of all competition, but in a world where software patents are and have been a hot topic of debate for many years, with many sitting on either side of the fence regarding their patent eligibility, coupled with the fact that all the time, cost and effort put into research and development to find the best architecture and solutions can be diminished within months, likely before the next major release, by software creators who have copied and released a full-featured free version, who is going to risk software innovation for which they may never be rewarded as much as they ought to be? The answer, if anyone, could only be large corporations who can afford to develop and deploy quickly and, if necessary, pay for lawsuits. Smaller companies and independent developers risk losing out majorly to open source and freeware, and will continue to be forced to work for or sell their company or property to larger companies. Even worse, these groups may be ripped off by larger companies, as was the case with Snapchat versus Facebook's Poke in 2012/2013.

Power Consumption

Even with ARM architecture based processors providing an excellent power-to-performance ratio for portable smart devices, tasks a processor has to manage still consumes enough power to deplete a fully charged battery in less than 24 hours with average usage and 48-72 hours with minimal usage. Anyone who has experimented with “Airplane Mode” on for a substantial amount of time would have noticed the major decrease in power consumption, and the opposite is true for those who have airplane mode switched off and location services on with an even quicker depletion of power than normal. The amount of power required for the processor to send and receive data therefore dominates the breakdown of power consumed for different types of tasks.

Mobile Advertising

With the popularity of smart devices in the world today, namely smart phones and tablets, advertisers and operators of advertising networks are fighting desperately to be the first to solve the main issues of mobile advertising—how do you effectively advertise on a smart device within the confines of a personal screen space but without being overly obtrusive on the user, and how do you engage the user in such a manner that gains their intrigue. Two business individuals faced with this problem had this to say:
Martin Jordan, marketing director, Equator:
The main problem for mobile advertising right now is in its point of evolution. Just as with banner ads in the 90s and Facebook ads on launch, the nature and quality of the ads are low. Coupled with the fact that poor quality free apps borderline on the spamming with the use of ads, the user is fast learning to visually filter them. Whether it's Wonga, 888 Casino or online Warcraft style games, you can't escape the repetitive and intrusive nature of the current stock of ads. More qualitative names need to take on the channel and reinvigorate the small space the ads occupy. Maybe then we'll start paying attention and clicking through!
Matt Champion, media services director, Fetch:
The biggest challenge is choosing the right content for a small screen. You can't bombard the user with information, but it also needs to be effective for your purpose. Advertisers and brands need to design the right gestures to ensure good user experience.
Another key challenge is connecting the mobile device to the TV without requiring too deep an engagement from the viewer, such as having to download an app or register for a service. If it's a TV ad, you've got less than 30 seconds to engage the viewer. The TV service provider probably has the advantage here by combining EPG functionality with companion apps.

Until now, people have simply tried to impose advertising on users in an overly obtrusive manner—in-app ad banners that appear at the top and bottom of the screen, large ads appearing in line with news feeds and the old 90s method of advertising spaces on websites, usually at the top and running down a side column of a page or, in more recent years, screen overlays. The main problems with the website methods are, of course, that they haven't universally been optimized for mobile device browsers and their smaller screens, requiring mobile versions of sites to be made that couldn't efficiently employ the same advertising techniques, lack of frameworks needed to support certain types of ads (namely Adobe Flash missing from some devices) and the lack of hardware needed to provide satisfactory performance of motion graphics and rich media.

Within the past decade, advertising systems have relied heavily on algorithms in conjunction with data gathered from social networks, browser cookies, spyware and GPS location to gather data on users and serve them what's known as ‘targeted ads’—ads relative to a user's location, search history, browser history, social network behaviour and more. The algorithms have become more complex and the targets more accurate, making any data gathered more valuable, which is how companies have been seen to profit from this, as well as through the clicking of the ads themselves, or sometimes just through the impression of the ad.

With so many companies operating their own online and offline advertising networks, generating their own statistics and selling on all types of collected user data at their own prices, no one has focused on trying to make it cheaper and as efficient as possible for businesses to do the marketing and market research they need in order to prosper, especially new businesses with little to no capital, except for when they need to undercut the competition in order to steal clients.

Others have tried to go about attempting to solve the problem of mobile advertising by using simple methods of innovation—building upon what is already there in minor incremental steps, rather than looking at highly complex methods of innovation that borderline on the creation of new technology; rebuilding from the foundation up instead of just adding a new level.

Hybrid Applications

A final obstacle for those looking to become prominent in smart devices, particularly mobile, is that they only have 3 options:
1. Build a mobile optimized website or web application that can be updated however and whenever they wish but lose the ability to interact with native device APIs for advanced features and experience significant performance issues when compared to native applications.
2. Build a native application that has full access to native APIs and the best performance possible but a need for approval from some mobile vendors in order to deploy new updates to users and then hope users choose to install the update, as well as having to build multiple versions of applications to deploy on multiple device operating systems.
3. Build a hybrid application that wraps web pages inside a native application shell, allowing users to access native APIs while being able to update the look and feel remotely and without restriction but still face performance issues.

Gartner, Inc. who believe at least 50% of all companies and businesses will be using hybrid applications by 2016, had this to say:
While native application development offers the ultimate user experience and performance for mobile applications, the trade-off is often a fragmented set of development tools and multiple versions of an application to serve the same user need—because different versions must be made for each type of device or operating system. However, the promise of HTML5 with offline capabilities and animation-rich tools fell short of expectations, causing developers to consider hybrid architectures to better leverage mobile device capabilities.
Van Baker, research vice president at Gartner:
“The BYOD trend and the increased pressure on organizations to deploy mobile applications to accommodate mobile work styles of employees will lead businesses to manage a portfolio of mobile application architectures, and hybrid architectures will be especially well-suited to business-to-employee applications.”

While hybrid applications do the best they can to provide the best aspects of both worlds, due to the nature of how web engines and the World Wide Web itself works, web browsers (in any form) will never be able to keep up with the performance of native applications when comparing user interaction and data handling of web documents to native objects. Even more so, as technology continues to progress and is implemented in smart devices, the same differences will remain, some of which are:
The processing power and memory required for optimal or even decent performance is increased. This is done much more efficiently with native objects as code is already stored on the device and ready to go.
Data downloading and handling is done much faster using native objects than it is rendered in browser windows. Media streams, such as with 3D digital material and Augmented Reality data, will become increasingly larger and more difficult for web browsers to handle efficiently.
Fewer network connections are required with native applications.
Native applications provide much more security to the user.

Artificial Intelligence and Ambient Intelligence

For decades technologists, computer scientists, software engineers and programmers have been searching for a way for computers to become as intelligent as humans—and then surpass them. Thanks to individuals such as Raymond Kurzweil and Juan Carlos Augusto, computers are able to understand, communicate and adapt to physical environmental changes, but so far nothing on a large scale has been designed that can truly bring the world together as most work is still in theoretical, hypothetical or research stages. Also, systems of this nature have been heavily criticized for the unknown—the impossibility of predicting what a computer system may desire once it has the ability to become intelligent and self-aware, and what political, societal and cultural impacts it may have, as well as privacy invasion that may occur. Some have also voiced the opinion that building something of this nature is utterly impossible.

Augmented Reality

There have been some new advances in a technology that, although was first created around 1957, has yet to find a mainstream, real world and everyday use. Augmented Reality, a term coined in 1990, has been the subject of many projects in recent years, with multiple large corporations now manufacturing prototypes and even full production models of what is seen to be the first feasible versions of AR units that can be used as part of everyday life, which are to be released as early as the second half of 2013. Yet still, companies face a number of issues, including:
1. Finding a genuine everyday purpose to allow them to manufacture larger quantities for cheaper and lowering the overall retail cost of a unit;
2. Designing something that is fashionably and socially acceptable to wear out in public without any level of ridicule, as pointed out and discussed by Mixed Reality Studio in a blog post dated Mar. 30, 2013.

Virtual Worlds

Computer-driven, digital virtual worlds have existed since the 1960s with the introduction of a visual flight simulator by Thomas A. Furness III and the virtual reality and augmented reality head-mounted display system by Ivan Sutherland and Bob Sproull. Now, in a world as connected as we are in 2014 and with the affordable computer processing power easily and readily available, the aesthetics and capabilities of virtual worlds have significantly improved and now benefit multiple industries. In the world of entertainment, some massively multiplayer online (MMO) games that permit user generated content, such as Second Life, have taken virtual worlds to new heights, bridging a gap between the real world and virtual worlds by allowing in-game actions to have a real world outcome, for example, the ability to order products in game that are then delivered in real life. The problem with online virtual worlds such as Second Life arise when there are conflicts with in-game possibilities and real world laws. Illegal online gambling, fraud and IP violation are common crimes committed online and as such have caused much controversy for Second Life as governance of digital crime, especially over the internet, is very difficult and lengthy.

Virtual Cryptocurrency

Though in existence since 2008, cryptocurrencies remained generally unknown until the revelation of the Silk Road criminal website which used bitcoin for transactions in late 2013. As an encrypted virtual currency, it is decentralized from any government authority and encrypted in such a way that has thus far made it impossible to see or track who is sending or receiving funds over the peer-to-peer bitcoin network, making it a haven for criminal finances and financial transactions. Since the emergence of bitcoin, other virtual currencies have been created and are currently in circulation. Due to the nature of cryptocurrencies, the value, especially of bitcoin, is on the rise and will likely remain that way without government intervention.

Accordingly, there is a need for the following:
A telecommunication network that is cheaper to operate and upgrade than the internet is today. There should be a way to govern it only when and if necessary without being intrusive and restrictive. Data transmission should be as secure as possible, as should all connections to and from any given point or source.
A way to have a universal digital identity that can be used for a persistent online presence across all devices and connections for online communication and interaction.
A digital ecosystem capable of working across all types of smart devices that creates an individually tailored experience for every entity who becomes a part of it, without stifling creativity and freedom of expression or being forced to make the trade-off for performance and quality. Data discovery needs to become more time-efficient, global outreach needs to become even more cost-effective and a more fair and level playing field is needed to encourage the less confident or capable to try more.
Between the telecommunication network and digital ecosystem should be a “brain”—an Artificial Intelligence life form that seamlessly joins the two, capable of studying from one to enhance and evolve the other to benefit both and all who use them. For users, this brain should be able to perform tasks for each individual in anticipation of them needing it done. For devices, this brain should be able to perform tasks on its behalf in a manner which reduces the workload on the device's processor and lowers its power consumption.
Universal data formats that can be monitored by computers during transmission, storage and execution to ensure data is safe and non-transforming in order to help prevent malicious code from infecting devices.
A way to prevent the collapse of the software industry by ensuring the market is not able to become saturated with free/open source software that are merely copycat versions of proprietary and commercial software that heavily undermine the hard work and innovation that has gone into creating original work.
A way to create sustainable virtual worlds and environments with the ability to bridge the gap between real and virtual worlds that can be governed under regional, national and international law.
A way to improve the social interaction of people in the real world without compromising their virtual experience.
A way to track and monitor cryptocurrency funds and transactions to prevent exponential criminal use.

### REFERENCES

Increasing participation in online communities: A framework for human-computer interaction
Jonathan Bishop—1 Jul. 2007
http://www.jonathanbishop.info/Library/Documents/EN/docOCPaper_CHB.pdf
Gartner Recommends a Hybrid Approach for Business-to-Employee Mobile Apps
Gartner Inc.—16 Apr. 2013
http://www.gartnercom/newsroom/id/2429815
Has the Internet Peaked?
LoP Guest—28 May 2013
http://lunaticoutpost.com/Topic-Has-the-Internet-Peaked?page=1
Open Source Race to Zero May Destroy Software Industry
Gene Quinn—2 Apr. 2009
http://www.ipwatchdog.com/2009/04/02/open-source-race-to-zero-may-destroy-software-industry/id=2424/
The Age of Intelligent Machines
Raymond Kurzweil—1990
The Age of Spiritual Machines
Raymond Kurzweil—1 Jan. 1999
The Singularity Is Near: When Humans Transcend Biology
Raymond Kurzweil—2005
The Spike
Damien Broderick—1997
Transcendent Man
Barry Ptolemy, Felicia Ptolemy, Ray Kurzweil—Nov. 5, 2009
Waking Life
Richard Linklater—23 Jan. 2001
Plug & Pray
Judith Malek-Mandavi, Jens Schanze, Joseph Weizenbaum, Raymond Kurzweil, Hiroshi Ishiguro, Minoru
Asada, Giorgio Metta, Neil Gershenfeld, Joel Moses, H.-J. Wuensche—18 Apr. 2010
Ambient Intelligence: Technologies, Applications and Opportunities
Diane J. Cook, Juan C. Augusto, Vikramaditya R. Jakkula—2007
Artificial Intelligence: A Modern Approach
Stuart J. Russell, Peter Norvig—1994 (Original), 2009 (Latest)
Ambient Intelligence: Basic Concepts and Applications
Juan Carlos Augusto—2008
Ambient Intelligence: Sensing a Future Mobile Revolution
Saroj Kar—7 Mar. 2013
http://siliconangle.com/blog/2013/03/07/ambient-data-towards-a-future-mobile-revolution/
Perspectives of Ambient Intelligence in the Home Environment
Michael Friedewald, Olivier Da Costa, Yves Punie, Petteri Alahuhta, Sirkka Heinonen—January 2005
Human-Centric Interfaces for Ambient Intelligence
Hamid Aghajan, Juan Carlos Augusto, Ramon Lopez-Cozar Delgado—2010
Behaviour Monitoring and Interpretation—BMI
Björn Gottfried, Hamid Aghajan—April 2011
Distributed Video Sensor Networks
Bir Bhanu, Chinya V. Ravishankar, Amit K. Roy-Chowdhury, Hamid Aghajan, Demetri Terzopoulos—2011
Handbook of Ambient Intelligence and Smart Environments
Hideyuki Nakashima, Hamid Aghajan, Juan Carlos Augusto—2010
Multi-Camera Networks: Principles and Applications
Hamid Aghajan and Andrea Cavallaro—2009
The Technologies of Ambient Intelligence
Philips
http://www.research.philips.com/technologies/projects/ami/breakthroughs.html#Context awareness
Augmented Reality: A class of displays on the reality-virtuality continuum
Paul Milgram, Haruo Takemura, Akira Utsumi, Fumio Kishino—1994
http://etclab.mie.utoronto.ca/publication/1994/Milgram_Takemura_SPIE1994.pdf
Experimental evidence for mixed reality states in an interreality system
Vadas Gintautas and Alfred W. Hubler—May 2007
http://pre.aps.org/abstract/PRE/v75/i5/e057201
Cartesian dualism
René Descartes—1641
The Concept of Mind
Gilbert Ryle—Original 1949; Current 2002
The Ghost in the Machine
Arthur Koestler—1967

### SUMMARY

The above deficiencies and other problems that may be associated are reduced or eliminated by the disclosed multifunction system. In some embodiments, a telecommunication network using sensors and one or more computer systems is used to increase the performance and reliability of data transfer as well as improve the security of data and data connections. In some embodiments, the system is capable of powering a globally connected digital ecosystem. In some embodiments, the system provides extensive data management capabilities using metadata, maps, sensors or wireless technology. In some embodiments, the system provides a way to remotely control the interface and functionality of native applications. In some embodiments, the system is an artificial intelligence system or life form. In some embodiments, the system provides a personally tailored digital experience for users. In some embodiments, the system is a digital mail carrier. In some embodiments, the system provides the capability of advertising effectively. In some embodiments, the system creates a reality-virtuality continuum by significantly bringing the gap between the real and virtual world.

In an aspect of the invention, problems it recognises and/or how it solves them, an interconnected computer system and telecommunication network brings together the real and virtual worlds through the use of smart devices in order to assist in the everyday lives of physical entities.

In another aspect of the invention, problems it recognises and/or how it solves them, although users publish data onto a universal ecosystem, they are granted fine control over who is able to view any of their data should they wish to limit it to anyone specific.

In another aspect of the invention, problems it recognises and/or how it solves them, publishing users can have other users endorse their data, enabling all users endorsing data to acquire their own individual view count for the endorsed data while contributing to the total view count of said data on behalf of the publishing user.

In another aspect of the invention, problems it recognises and/or how it solves them, users are able to create one or more distribution lists using single click solutions for them to distribute data on the system that can be used universally across the ecosystem without having to build independent modules for applications deployed within the environment.

In another aspect of the invention, problems it recognises and/or how it solves them, by allowing users to publish a single piece of data in multiple languages or having it automatically translated, publishers can reach tourists who don't speak or read the native language without having to incur additional costs, and have the correct language displayed depending on factors such as the localization settings of the user's device or the settings on their account.

In another aspect of the invention, problems it recognises and/or how it solves them, by allowing entities to publish and control content from their smart devices, they are able to target their desired audience while on the move and, by leveraging the power of a sensor-based telecommunication network, can reach others on a global scale for the same price as reaching an entity next to them.

In another aspect of the invention, problems it recognises and/or how it solves them, users may only pay for data views that are genuine—by delaying the execution of the view count increase until a user has been viewing the content for a specified amount of time, publishing users will no longer have to pay for accidental views.

In another aspect of the invention, problems it recognises and/or how it solves them, users who have difficulties with sight and therefore find it hard to interact with data that doesn't use sound can have an audio description played to them, allowing them to hear what has been written and visualise in their mind what the data on screen is of.

In another aspect of the invention, problems it recognises and/or how it solves them, the system is capable of analysing and producing data tailored on behalf of an entity to their specific needs and requirements.

In another aspect of the invention, problems it recognises and/or how it solves them, with one system capable of storing important statistical data on a global scale, a unified set of statistics can be used to produce more accurate results relating to how effective and successful/unsuccessful data has been. Based on these results, the system can produce trend patterns and predictions based on data from previous years, recent search statistics, recent user activity and more, significantly reducing the time and cost for those conducting research to gather the information they need and make critical decisions.

In another aspect of this invention, problems it recognises and/or how it solves them, by allowing remote code to be downloaded that can then be interpreted and translated into native objects, functions, function calls, classes, actions, properties and more, users can dynamically create layouts and change the user experience of their applications without having to seek approval on updates, meaning they can fix issues, add features and change the look and feel in an instant while at the same time ensuring all users are running the most up-to-date version.

In another aspect of the invention, problems it recognises and/or how it solves them, Augmented Reality was originally used for military, industrial and medical purposes, but in modern times has been applied in areas such as art, commerce, education, navigation, entertainment and tourism, yet still there is no proven reason as to why individuals should and would constantly have an AR device on their person at all times and in constant use. This system, providing Augmented Reality capable data to digital screens around the world, creates a real world environment that under normal circumstances appears simply as a completely digital version of what we see today but, when viewed with Augmented Reality capable hardware, springs to life and bursts into action, giving all those using Augmented Reality capable hardware their own personal experience of sound and visual motion, augmenting the reality of a user so much so that it creates the realistic illusion that the real world and digital world have crashed together and are co-existing in the same living space, with the latter only perceived to exist under the right circumstances. Each user's perceived view of current reality can also be tailored to them. Conditional statements and algorithms can allow different users to have a different Augmented Reality experience when looking at the object, based on metadata and a user's interests.

In another aspect of the invention, problems it recognises and/or how it solves them, certain areas of some cities are renowned for certain industries being the dominant presence, such as the fashion industry in London's Savile Row and Rue du Faubourg Saint-Honore in Paris, while Performance Arts take center stage in the Theatre District of New York. By custom mapping areas of the world within the system, material made prominent on a user's smart device can reflect what they are seeing in the real world by using the device's location to filter what is shown and what they view.

Similarly, entities that occupy and are in control of a space, such as those with their own shops, may want to:
Restrict customers to viewing only material provided by them, the controlling user;
Only allow specific material to be viewed;
Prevent competitors' material from being viewed.

By employing a content-control system comprised of a control unit and sensors, the owner of the space can use the sensors to filter all data viewable within that space by setting restrictions using the control unit and the sensors will produce a wireless signal that will communicate with the client software on the user devices, telling it what not to display.

In another aspect of the invention, problems it recognises and/or how it solves them, when a person is out and about, they pay attention to what interests them and subconsciously filter out anything that doesn't pertain to said interests. At the same time, they may not be able to pay attention to everything they would find interesting for various reasons—multitasking, in a rush to go somewhere or maybe just having a bad day, which could result in them missing things that may interest them the most due to lack of focus or simply not enough time. Using proximity sensors, the system can sense the presence of a user and, if the user acknowledges the screen, begin to provide a personal service to the user by reading the account information of their present device and cross-referencing it with data that has location-based metadata attached which matches the location of the user within a given radius and then alert the user of local offerings such as events, make suggestions of what it thinks they may like and want to make note of, such as new items in store and inform them of the latest information such as sales and special offers.

In another aspect of the invention, problems it recognises and/or how it solves them, by creating a way for digital stationery, such as business cards, to be assigned to a user account to update the details and design data displayed by connecting to a database then downloading and displaying the new data, users would not need to order new stationery to change the design or details.

In another aspect of the invention, problems it recognises and/or how it solves them, a universal digital ecosystem is created that can work across the spectrum of smart devices and platforms. By allowing this digital ecosystem to interact with the personal and business sides of a person's real life, they are actually able to control aspects of their real world from a smart device with a sensor-based telecommunication network connection.

In another aspect of this invention, problems it recognises and/or how it solves them, digital ecosystems may be divided into sub-ecosystems for the benefit of people's varying interests, different industry sectors, different aspects of societal life etc.

In another aspect of the invention, problems it recognises and/or how it solves them, having one account for a universal digital ecosystem means a user won't need to remember multiple login details, but instead have a single point of sign-in from which they can have logged in access to any application or service deployed within the ecosystem.

In another aspect of this invention, problems it recognises and/or how it solves them, by creating an ecosystem that allows entities to publish advertising and promotional data that can be accessed from smart devices, users no longer need to be bombarded with advertising in such an obtrusive manner while they are trying to accomplish other tasks, but can freely seek out any advertising and promotional data they desire when they decide to or have data relating to what they have expressed interest in appear on a home screen of their smart device via a widget; it being on the home screen meaning the user will come across it when navigating their device, and more than likely visit the widget out of curiosity, free to peruse at their own leisure data they may actually be interested in. While using the client, users can browse the ecosystem for their favourite entities to see what they have published, while the system brings data to them that it deems will be of interest based on their categories of interest, other entities they subscribe to, data they have viewed and more.

In another aspect of the invention, problems it recognises and/or how it solves them, the system provides intelligent ways of connecting people and businesses when one entity has a need that another entity can fulfil by using proximity sensors to detect and alert an entity to the presence of another who may be able to help them.

In another aspect of the invention, problems it recognises and/or how it solves them, the system provides intelligent ways for devices to connect to people and entities over an ecosystem under certain conditions to alert or inform those of whom it needs.

In another aspect of the invention, problems it recognises and/or how it solves them, a telecommunication network is created to better fit and make better use of the main types of devices used in the world today.

In another aspect of the invention, problems it recognises and/or how it solves them, a telecommunication network can be extended for personal and private use by adding specific types of connection points that are able to have their own personal settings, controlling users and approved users.

In another aspect of the invention, problems it recognises and/or how it solves them, a telecommunication network provides constant and reliable data connections by using a common connection point for multiple types of connections.

In another aspect of this invention, problems it recognises and/or how it solves them, a telecommunication network may adjust bandwidth by sensor or area depending on factors such as device numbers and active connections within a given area or sensor.

In another aspect of this invention, problems it recognises and/or how it solves them, data transmission to and from a device may be facilitated by the mirroring of data instead of uploading and downloading to reduce the workload of the processor.

In another aspect of the invention, problems it recognises and/or how it solves them, an encrypted data system provides secure end-to-end connections for data transmissions. All data is encrypted before it is sent and may only be decrypted at a maximum of 2 major points—at a central system and its destination.

In another aspect of the invention, problems it recognises and/or how it solves them, devices may connect with each other at further distances than direct connection technology of devices may allow by bouncing a connection off of one or more sensors to its destination device.

In another aspect of this invention, problems it recognises and/or how it solves them, pin-point positioning and enhanced location services are made possible by the presence of a multitude of sensors with overlapping sensor areas that are able to track and record the current and previous positions of smart devices.

In another aspect of this invention, problems it recognises and/or how it solves them, a telecommunications network works with a digital ecosystem to provide a personal user experience for each individual user that may be shared if and when they choose without obligation by separating a user's personal experience from their social experience but allowing data to flow between them.

In another aspect of the invention, problems it recognises and/or how it solves them, a system capable of learning and understanding in the same or a similar way to humans is able to interact with other entities in a highly intelligent manner with the ability to express mood and emotion, as well as develop and change its personality based on what it learns and experiences in order to respond in a manner that best fits a situation.

In another aspect of the invention, problems it recognises and/or how it solves them, digital entities and avatars, personalised or otherwise, may perform tasks on behalf of a user with or without instruction in a virtual world by studying what the user is or may be interested in along with their typical behaviour, making for a much more convenient digital experience.

In another aspect of the invention, problems it recognises and/or how it solves them, a permanent bridge between a virtual world and the real world is established by embedding a virtual world environment directly into a digital ecosystem and/or telecommunication system.

In another aspect of the invention, problems it recognises and/or how it solves them, a virtual world that allows digital existence that may correspond with the real world and be governed by local, national and/or international law.

### DESCRIPTION OF DRAWINGS

FIG. 0—Digital Ecosystem

An overall scope of the digital ecosystem and how it's connected.
001—A representation of people around the world who use smart devices.
002—A representation of smart devices connected to each other and the people who use them.
003—A central system to store, process, analyse and distribute data to smart devices connected to it.

FIG. 1—Content Posting An example form used to publish data onto the ecosystem.
101—Example smart device.
102—Example content publishing form.

FIG. 2—Multiple Languages

An example of how to post a single piece of content in multiple languages.
201—Example smart device.
202—Content text in default language.
203—A select box to choose the language of that version of the content.
204—The title of the content written in the additional language.
205—The text of the content written in the additional language.
206—Add another language button.

FIGS. 3.1-3.3—Endorsements

An example of having a user endorse the content of another and gaining their own view count which contributes to the overall total views of said content.
3.1
   301—Example smart device.
   302—The publisher selecting the user they wish to have endorse their content.
3.2
   303—Content list of publishing user showing the endorsed post.
3.3
   304—Content list of endorsing user showing the post they have endorsed. Their own view count for the content is featured within the brackets next to the total view count of the content.

FIGS. 4.1 & 4.2—Ecosystem Flow

An example of the flow of data within the ecosystem, between any connected devices and a main system.
4.1
   401—The user opens their web client or a client designed to access the ecosystem;
   402—From a client the user accesses the ecosystem;
   403—Once connected to the ecosystem, the data submitted by the user is sent to a central processor of an engine powering the ecosystem;
   404—Once processed, all data and media files are stored in databases and on a media server connected to an engine processing system;
   405—The returned data is then sent to the ecosystem, ready to be accessed by users;
   406a/b—In special cases and on certain occasions, data can be pushed directly from the central processor to user devices, smart screens, consoles and/or third-party devices given permission to access the system;
   407—Data that is passed to the ecosystem is then passed to the client software of smart screens, user devices and other devices;
   408—Data can be streamed from smart screens and consoles to user devices and other devices that have the supporting hardware;
   409—The device receiving the data can then interact with it and in turn send new data in response.
4.2
   410—A data path between a device and receiving system.
   411—An enhanced view of the data path shown in 411.

FIGS. 5.1 & 5.2—System Flow

An example of the flow of the data through the system from the moment it is sent from an input device to the server and then received by the client.
5.1
   501—Data is sent from the input device to the engine central processing system;
   502—The data is processed and information is added to a database and retrieved when necessary;
   503—All media files attached are stored on a media server and retrieved when necessary;
   504—Applications and modules are stored on an application server which can provide additional functionality to users and help handle data in different ways.
   505—Data is sent through to the zone mapping system—a system that controls where the information being sent through to a client can be viewed;
   506—Once the information has been processed through the zone mapping system, it then passes through the filter system which filters the information according to the settings of the user retrieving the data or settings of the system;
   507—The information is sent to the receiving devices client software or versions of the client software that can also be used as a server;
   508—Devices with client/server software are able to stream data between each other and to devices that that only have the client software;
   509—Users use the same client software as the input device to start sending information back to the system, creating a cycle;
   510—With enough data to analyse, the concept engine starts interacting with the database to produce patterns and predictions.
   511—Any digital letter mail sent through the system is first passed from the engine central processing system to the mail system.
   512—The mail system may check the database(s) to cross-reference and verify any metadata and/or credentials attached to mail.
   513—All verified mail is passed onto the routing system where the routing information of each mail item is checked as it is prepared to be sent.
   514—Mail is delivered to the client device it was designated to be sent to.
   515—Data passed to the application server that doesn't require further processing by the system may be sent straight on to a client device.
5.2—An internal tree structure of a system.

FIG. 6—Zone Mapping

An example of designating areas of a map for specific data.
601—A map.
602—A designated area of map (601).
603—Another designated area of map (601).

FIGS. 7.1 & 7.2—View Content Data

An example of what may happen when content data is viewed.
7.1
   701—A page with view count the moment it is viewed.
   702—The same page as in (701) after the timed delay of the view count.
7.2
   703—Data displayed on a device.
   704—Sound played by device.
   705—A vision-impaired individual.

FIGS. 8.1 and 8.2—GUI Widget Data

An example of displaying content which is of interest to a user on a home screen section of a smart device.
8.1
   801—An example of a smart device.
   802—Section displaying information of the user account the device is using.
   803—List of content which the system has deemed of interest to the user through use of the network.
   804—Home screen page indicator.
8.2
   805—Solo content which the system has deemed is of interest to the user through use of the network.

FIGS. 9.1 & 9.2—Eyeball View Tracking and Proximity Interaction

An example of how the system can utilize eye-tracking technology to record when a user looks at a smart screen and to determine when to interact with a nearby devices and users.
9.1
   901—Digital smart screen;
   902—Reasonable viewing range of digital smart screen (901);
   903—Person (903) is within the reasonable viewing range (902) of digital smart screen (901) and digital smart screen (901) is within the field-of-view of person (903), but the point-of-gaze of person (903) is not directed at digital smart screen (901), so the client software of digital smart screen (901) doesn't record a view;
   904—Person (904) is within the reasonable viewing range (902) of digital smart screen (901) and digital smart screen (901) is within the field-of-view of person (904) and the point-of-gaze of person (904) is directed at digital smart screen (901), so the client software of digital smart screen (901) records a view;
   905—Digital smart screen (901) falls within the extended field-of-view of person (905) and the point-of-gaze of person (905) is directed at digital smart screen (901), but person (905) is outside the reasonable viewing range (902) of digital smart screen (901), so the client software of digital smart screen (901) doesn't record a view;
   906—Digital smart screen;
   907—Reasonable range of proximity sensor;
   908—Person (908) is within the reasonable sensor range (907) of digital smart screen (906), digital smart screen (906) is within the field-of-view of person (908) and the point-of-gaze of person (908) is directed at digital smart screen (906), enabling digital smart screen (906) to interact with person (908);
   909—Person (909) is within the reasonable sensor range (907) of digital smart screen (906) but the point-of-gaze of person (909) isn't directed at digital smart screen (906), so digital smart screen (906) does not interact with person (909).
   910—The personal proximity sensor area of a smart device person (905) is carrying is able to detect the presence of person (904) as that person falls within personal sensor area (910).
9.2a and 9.2b
   911—Camera and sensor device(s) (CSD).
   912—Smart device.
   913—Person with smart device.

FIG. 10—Proximity Controlled Data

An example of how the system can be set to only allow specific data to be displayed within the area of proximity sensors.
1001—A control unit linked to the proximity sensors used to control the data that is viewable within sensor areas.
1002
   A—Central proximity sensor;
   B—Corner proximity sensor;
   C—Corner proximity sensor;
   D—Corner proximity sensor;
   E—Corner proximity sensor.
1003
   A—Proximity range of sensor (1002a);
   B—Proximity range of sensor (1002b);
   C—Proximity range of sensor (1002c);
   D—Proximity range of sensor (1002d);
   E—Proximity range of sensor (1002e).
1004
   A—Person is within the sensor area of central sensor (1002a) and is therefore restricted to viewing only material permitted by the operating user of the sensor control;
   B—Person is within the sensor areas of central sensor (1002a) and corner sensor (1002c) and is therefore restricted to viewing only material permitted by the operating user of the sensor control;
   C—Person is within the sensor area of corner sensor (1002e) and is therefore restricted to viewing only material permitted by the operating user of the sensor control;
   D—Person is outside of all sensor areas and therefore is not subjected to any restrictions.

FIG. 11—Augmented Reality Audio/Visual Relay

An example of Augmented Reality visuals and sound being streamed in real-time based on the Augmented Reality marked display to the Augmented Reality capable device, and then live streamed from one device to another via wireless connectivity.
1101—Augmented Reality marked digital smart screen;
1102—Smart device receiving Augmented Reality data from digital smart screen (1101);
1103—Smart device with Augmented Reality capabilities receiving a live stream of the Augmented Reality visuals and sound that smart device (1102) is viewing;
1104—Smart device without Augmented Reality capabilities receiving a live stream relay from smart device (1103) of the live stream it is receiving from smart device (1102) of the Augmented Reality data it is receiving from digital smart screen (1101).

FIGS. 12.1-12.7—Client Assigning

An example of how to link smart device clients to user accounts.
12.1—The creation of a new user account and the activation of a new smart screen client, both being added to the corresponding system databases.
12.2—The assigning of a smart screen and client to a user account.
12.3—The user account controlling the content to display on the smart screen.
12.4—The end result showing the approved content of the user account displayed on the smart screen.
12.5—The assigning of digital stationery to a user account.
12.6—A blank piece of digital stationery connecting to a database to check for and download data.

FIG. A is the stationery before data is retrieved.
12.7—A piece of digital stationery after the data has been downloaded and displayed. FIG. B shows this.

FIG. 13—Payment System Flow

An example of how the payment system may operate.
1301—The action starting the transaction process, sending the initial transaction data to the central processing system.
1302—Realising the transaction, the processing system goes to the user accounts database.
1303—From the accounts database, the system locates the user account that is paying for the transaction.
1304—Having located the account, the information for the transaction is passed to the payment system.
1305—If the transaction is to be handled by the system itself, the payment system checks the funds that the paying user currently has in an escrow account against the price of the transaction.
1306—If the transaction is to be handled by a third-party system, the information is passed to the third-party system and the response is then passed back.
1307—If there is an error with the transaction, an error response is produced on the payer account.
1308—If the transaction is successful, payment is transferred to the account of the payee and they are notified of the transaction success.
1309—The payer is notified of the successful transaction.

FIGS. 14.1-14.8—Hybrid Application Engine

An example of how layout code can be written and stored remotely, and then downloaded and translated to dynamically create a user interface and user experience.
14.1—Source code for a user interface section called “home”.
14.2—Source code for a user interface section called “page1”.
14.3—The transfer of data from a user input device to its storage in the corresponding database on the system.
14.4—The transfer of data from database to device client, where it is translated and displayed to the user as a graphical user interface.
14.5—The GUI output of the source code shown in drawing 14.1, with a user performing a “click” gesture.
   1401—The GUI output of the source code of 1401.
   1402—A user's hand.
14.6—The result of the click gesture, showing the screen transition.
14.7—The GUI output of the source code shown in drawing 14.2.
14.8—An instructions file for the application engine.

FIGS. 15.1 & 15.2—Sub-ecosystems

An example of how sub-ecosystems can be formed once the main ecosystem is setup.
15.1
   1501—A central system of an ecosystem.
   1502
      A—Sub-ecosystem 1 of a main ecosystem.
      B—Sub-ecosystem 2 of a main ecosystem.
      C—Sub-ecosystem 3 of a main ecosystem.
   1503
      A—People are their smart devices connected to sub-ecosystems.
      B—People are their smart devices connected to sub-ecosystems.
      C—People are their smart devices connected to sub-ecosystems.
15.2—A multi-limb construction of sub-ecosystems and central systems composing one major ecosystem.

FIGS. 16.1 & 16.2—Security Measures

An example of how the ecosystem can be secured to prevent data exploitation.
16.1—A unique client ID and/or device ID being assigned to a user account.
16.2
   1601—A user smart device.
   1602—Data being sent to a security system over a wireless connection.
   1603—A security system.
   1604—Data sent from a security system to a central system over a hard line connection.
   1605—A central system.
   1606—Data sent from a central system to a security system over a hard line connection.
   1607—Data sent from a security system to a user smart device over a wireless connection.
   1608—A user smart device.
   1609—Data being sent to a security system over a wireless connection.
   1610—A security system.
   1611—Data sent from a security system to a central system over a hard line connection.
   1612—A central system.
   1613—Data sent from a central system to a security system over a hard line connection.
   1614—A kill signal sent to a user device over a wireless connection.
   1615—A system terminal connected to a central system via a hard line.

FIG. 17—A Truly Personal Experience

An example of how users looking at the same object can view it in a completely different way.
1701
   A—A person and their smart device.
   B—A person and their smart device.
   C—A person and their smart device.
   D—A person and their smart device.
1702
   A—Viewport of person 1701a.
   B—Viewport of person 1701b.
   C—Viewport of person 1701c.
   D—Viewport of person 1701d.
1703—A representation of the world.

FIGS. 18.1-18.5—Sharing Your Experiences

An example of how a user can share their view of the world with others.
18.1
   1801—Person A representing you.
   1802—Personal experience layer.
   1803—Permission security.
   1804—Social experience layer.
   1805—Person B-Z representing people you wish to share your experiences with.
   1806—Public display devices.
18.2—Two users enjoying their own personal experiences.
18.3—One user choosing to share some of their experience with another.
18.4—Two users mutually sharing their experiences with each other.
18.5—Synchronised experiences.

FIGS. 19.1-19.6—A New Method of Telecommunication

An example of how a new sensor-based telecommunication network can be formed and used.
19.1
   1901—A single connection.
   1902—A branched connection.
   1903—A sensor.
   1904—Device in overlapping sensor areas.
19.2
   1905—Smart device at starting point.
   1906—Travel path of smart device 1905.
   1907—Sensor 1.
   1908—Smart device at mid-point in an overlapping sensor area.
   1909—Sensor 2.
   1910—Smart device at finishing point.
19.3
   1911—Sender.
   1912—Sensor A.
   1913—Central system.
   1914—User accounts database.
   1915—Recipient's user account.
   1916—Recipient's current or last known location.
   1917—Sensor B.
   1918—Recipient.
19.4a—A smart device user within a sensor area.
19.4b
   1919—Data being entered on a smart device.
   1920—Current sensor in use by 1919.
   1921—A mirrored copy of the data of 1919.
19.5
   1922—User sending data.
   1923—Direct connection route.
   1924—User receiving data.
   1925—New position of user receiving data.
   1926—Redirection route.
19.6
   1927—Junction Point Systems that help direct data to its intended destination.
19.7a—A sensor collecting data from its surroundings.
19.7b—The sensor distributing data to surrounding devices.

FIGS. 20.1-20.5—Private and Personal Networks

Examples of how personal and private networks can be set up to operate using the telecommunication network.
20.1
   2001—The flow of data between a private sensor network system and a main terminal.
   2002—The flow of data between a private sensor network system and a database of users and devices with access permission.
   2003—The flow of data between a private sensor network system and a central system with which it authenticates and verifies users and may store data.
20.2
   2004—A private sensor network system.
   2005—Terminal controlling the private network.
   2006—Central system.
   2007—A user with network permission.
   2008—A user without network permission.
20.3
   2009—Unique reference ID for a personal sensor network system.
20.4
   2010—Person remotely accessing their personal network.
   2011—A personal sensor network system.
   2012—Person accessing their personal network locally.
20.5—A personal network connected to smart devices, smart appliances and smart electricals within a home.

FIG. 21—Data Relay Via Sensors

An example of how data can be transmitted from one user to another by bouncing off of sensors.
2101—Smart device A.
2102—Connection path X.
2103—Smart device B.
2104—Connection path A.
2105—Sensor A.
2106—Connection path B.
2107—Connection path C.
2108—Sensor B.
2109—Connection path D.
2110—Sensor C.
2111—Connection path E.
2112—Smart device C.

FIGS. 22.1 & 22.2—Load Balancing

An example of how sensors can efficiently manage connections.
22.1
   2201—A sensor unit.
   2202—A sensor at maximum capacity.
   2203—A sensor currently handling connections.
   2204—A sensor with no current connections.
   2205—Current capacity of the sensor unit.
22.2
   2206—A smart device.
   2207—Connection path A.
   2208—Sensor A.
   2209—Connection path B.
   2210—Sensor B.
   2211—Connection path C.
   2212—Sensor C.

FIGS. 23a & 23b—Bandwidth Adjusting

An example of how sensors can efficiently manage connections.
2301—Sensor Area
2302—Sensor Area
2303—Sensor Area
2304
   A—A normal bandwidth connection.
   B—Adjusted high bandwidth connection.
2305
   A—A normal bandwidth connection.
   B—Adjusted low bandwidth connection.
2306
   A—A normal bandwidth connection.
   B—Adjusted low bandwidth connection.

FIGS. 24.1-24.6—Intelligence Structures

Examples of how components relative to the intelligence of the system may be structured.
24.1—A three-degree word grouping scale.
24.2—A numbered scale.
24.3—A radar chart for emotion.
24.4—The brain of the system.
   2401—Logic Unit.
   2402—Memory Unit.
24.5—A brain operating as a master system of an ecosystem.
24.6—Different intelligence data synchronisation structures.

FIGS. 25.1 & 25.2—Device Entities

Examples of entities present on devices.
25.1—A child entity on a mobile device.
25.2—An omnipresent entity.

FIGS. 26.1-26.5—Virtual Worlds and Environments

Examples of how virtual worlds may coexist in the same space as the real world.
26.1a—A digital ecosystem and subecosystems.
26.2b—A virtual world.
26.2—A virtual world existing in the same space as a digital ecosystem.
26.3—Virtual World Environment (VWE) digital ecosystems and subecosystems spread out across the world.
26.4a—A user's position in the real world.
26.4b—Position of avatar or digital entity in a VWE.
26.5a—The user's perception of the real world without Augmented Reality.
26.5b—The user's perception of the real world using Augmented Reality based on their current or relative position in the virtual world.

FIGS. 27.1 & 27.2—Conceptual Models

Examples of conceptual models of the system.
27.1—A layer model.
27.2—Radial visualization of the layer model from a physical standpoint.

### DETAILED DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components and networks have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Though the description may refer to using a sensor-based telecommunication network, any and all embodiments described herein may be applied to other types of telecommunication networks should they have the ability to do so.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The terms “device” and “smart device” may be used interchangeably to refer to any device or entity, electronic or other, using technology that provides any characteristic, property or ability of a smart device. This includes the implementation of such technology into biological entities.

The term “processor” may refer to any component of a device that contains any type of processing unit that is capable of handling the task described. This includes but isn't limited to a central processing unit, graphic processing unit, advanced processing unit and multiple types of system-on-a-chip (SoC).

The term “sensor”, unless otherwise stated, may be used to refer to any sort of device or component capable of detecting other components, devices, people, objects or properties within a given distance or environment that it has been made or programmed to detect. Sensors may also be capable of sending and receiving data to and from one or more data sources.

The term “engine” may be used to refer to a software engine, physics engine and/or any hardware components that help facilitate the use of a device with one or more embodiments described.

The term “natural life” may be used to refer to any sort of natural living organism, such as plants, animals, fungus, micro-organism etc.

The term “controlling user” may be used to refer to a user of a device or system that has permission and is able to make modifications to a system or device's settings.

The terms “sensor” and “sensor unit” may be used interchangeably unless the two are used, at any point, to specifically describe two different objects.

The terms “post”, “posted”, “publish” and “published” may be used interchangeably to describe the issuing of data or information unless otherwise stated.

The system supports a variety of applications and uses, such as one or more of the following: a universally viable digital ecosystem, a portable data publishing platform, a storage facility, an artificial intelligence system/entity, a data analysis system, a personal interaction service, an endorsement service, a media viewing application, a media controller, a remote device controller, a mapping application, a timing application, a display widget application, a proximity detection application, an eye-tracking application, a wireless data filter, a media stream relay, an Augmented Reality display system, a digital mail delivery system, a transaction system and/or a hybrid application engine.

The various applications and uses of the system that may be executed on the system may use at least one common component or software client capable of allowing a user to perform at least one task made possible by said applications and uses. One or more functions of the client software as well as corresponding information displayed as part of the user interface may be adjusted and/or varied from one task to the next and/or during a respective task. In this way, a common software architecture (such as the client application or intelligence system) may support some or all of the variety of tasks with a user interface that is intuitive.

The following description is not to be read as the order in which steps must be taken to compose the present invention described herein unless clearly stated.

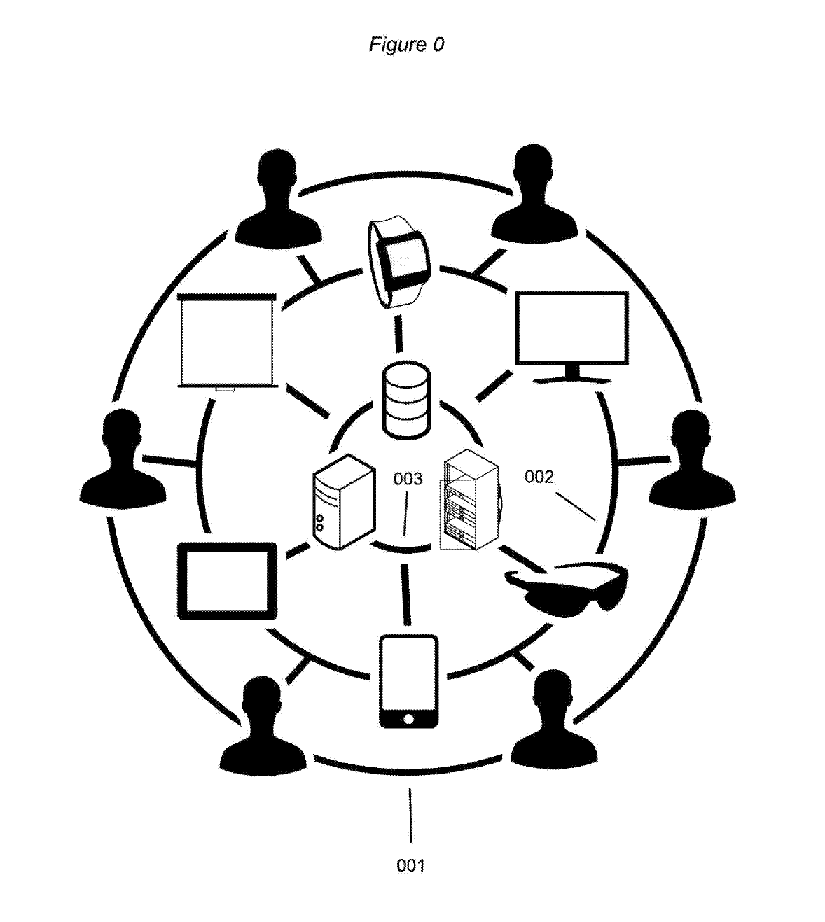

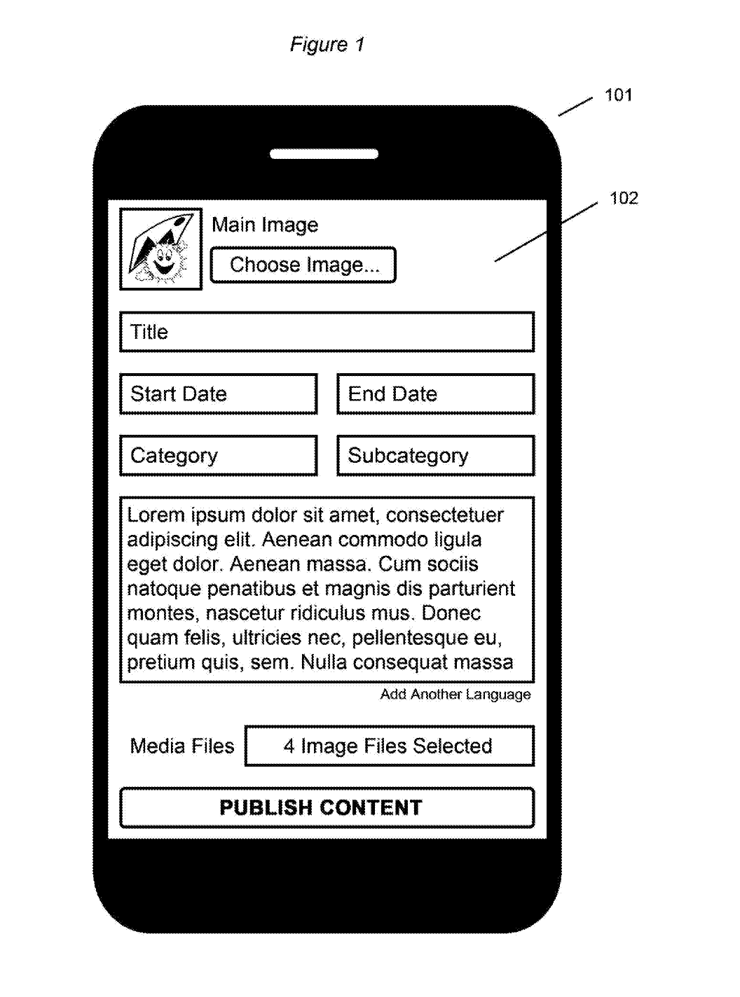

Attention is now directed towards embodiments of the system. FIG. 0 is an example depiction of an ecosystem. Outer circle 001 represents people and how they are connected to each other in the real world. Smart devices people use are represented by inner circle 002. The device images used are not indicative of the only smart devices to be used, nor do all the types of smart devices shown need to be used. Smart devices used by the people of outer circle 001 may also be able to connect to each other through the ecosystem using both wired and wireless communication technologies and act as a portal to the digital ecosystem from the real world. A central system, designed to be the core of ecosystems and sub-ecosystems, is represented by inner circle 003.

Central systems may store, process/handle, manipulate, distribute and analyse data it holds and data that passes through, as well as being a connection point smart devices may pass through when communicating with each other. A central system may include one or more of the following but is not limited to: a processing computer, a hardware or software client, a hardware or software server, a mapping engine, a concept engine, a database, a file server, a media server, a mail system or a routing system.

Smart devices require at least one hardware or one software component to communicate with the telecommunication system and/or ecosystem. In some embodiments, the same hardware and/or software component or additional hardware and/or software components may help facilitate other device uses with the telecommunication system and/or ecosystem. In some embodiments, programs or instruction sets may be implemented along with other programs or instruction sets as part of a processor or other component.

In some embodiments, a user may create an account that allows them to create, manipulate and/or access data of the ecosystem. In some embodiments, this account may be universally used across the ecosystem and everything connected to it, including other systems and services. In some embodiments, a user's account may be used a digital representation of themselves. When so, users are able to add information about themselves that the ecosystem may use, such as their interests. In some embodiments, users may upload an avatar to be used with their account. In some embodiments, a user avatar may be a still image. In some embodiments, a user avatar may be a moving graphic or video. In some embodiments, a user avatar may be an object. In some embodiments, a user avatar may be interactive.

In some embodiments, a user may create a relationship between their account and other accounts they may own and use for other purposes to download and/or synchronise information. In some embodiments, a user may create a relationship between their account and an account or record of an authority or governing body for identify verification purposes.

In some embodiments, data may be published directly from a smart device. FIG. 1 shows one example of a smart device 101 running client side software which the user interacts with. The user interface displayed on screen is that of example publishing form 102 which can be used to publish data to the ecosystem directly from smart device 101, where form 102 may consist of fields of different types, including but not limited to file fields, list fields and text fields and a button or command to submit the data of the fields as well as any other/hidden form data.

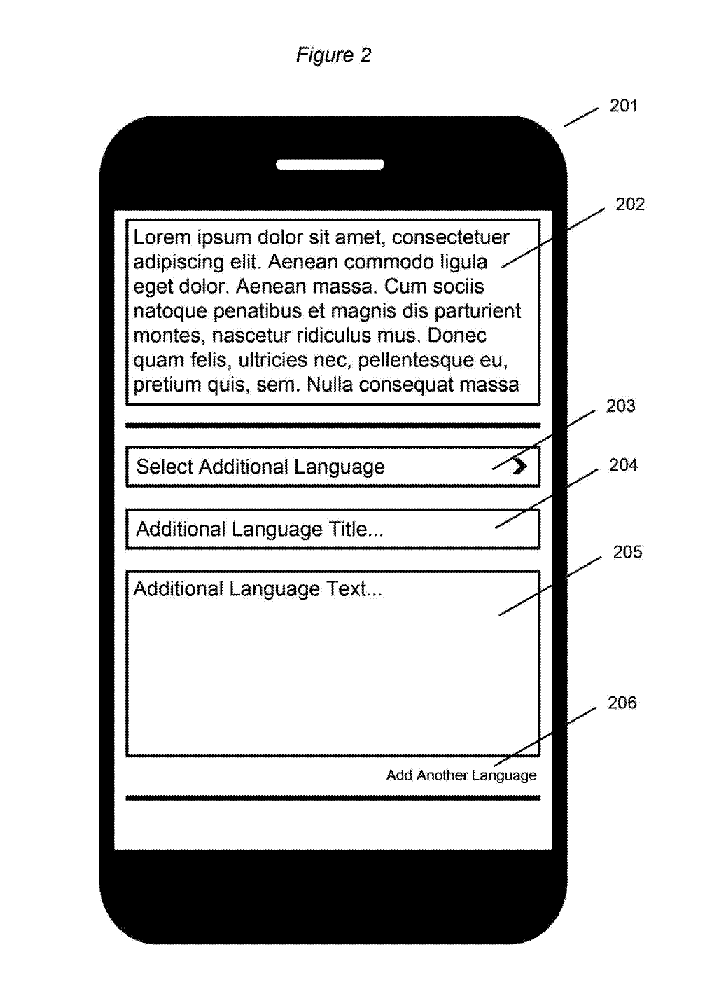

In some embodiments, multiple versions of data may be published in different languages. Example smart device 201 of FIG. 2 shows an example of additional fields of form 102 that allow a user to publish multiple language versions of data. 202 is a field that allows a user to enter their own text. 203 is a field that allows a user to define what the additional language is that they wish to submit an additional version in. 204 and 205 are fields that allow a user to manually enter translated text of what is the original version of the content. 206 is a button that allows a user to enter additional language versions. In some embodiments, a user can enter a limited amount of additional language versions while in others there is no limit to the amount of additional language versions a user may enter.

In some embodiments, data may be, automatically or upon request, translated from source language to a preferred language of a user using internal or third-party translation services, requiring only source text to make it possible. In some embodiments, commands and/or gestures may be used to submit data.

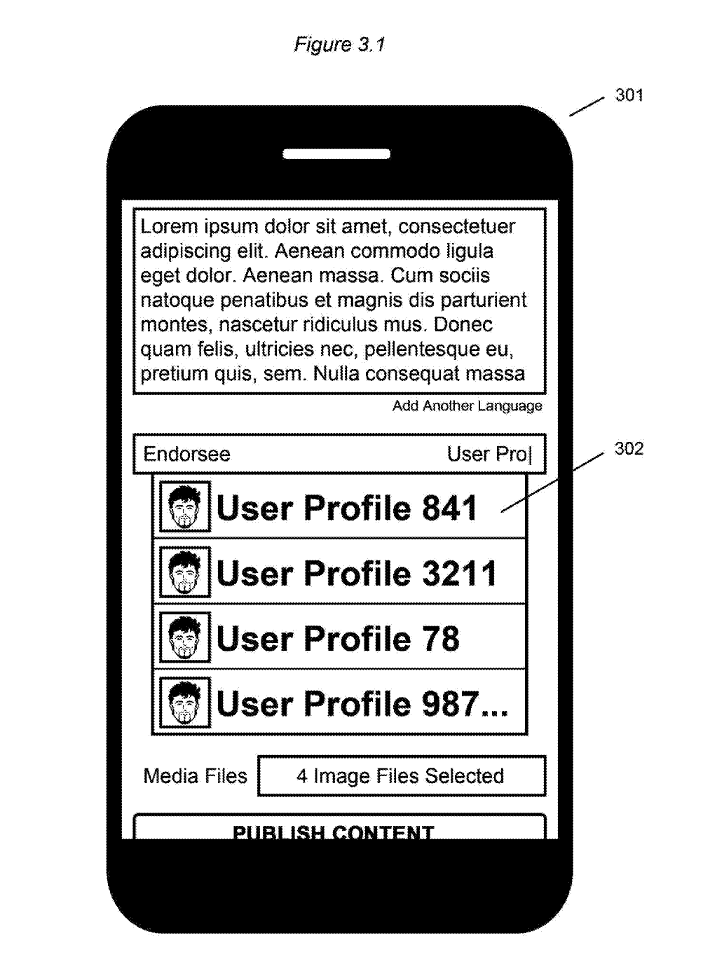

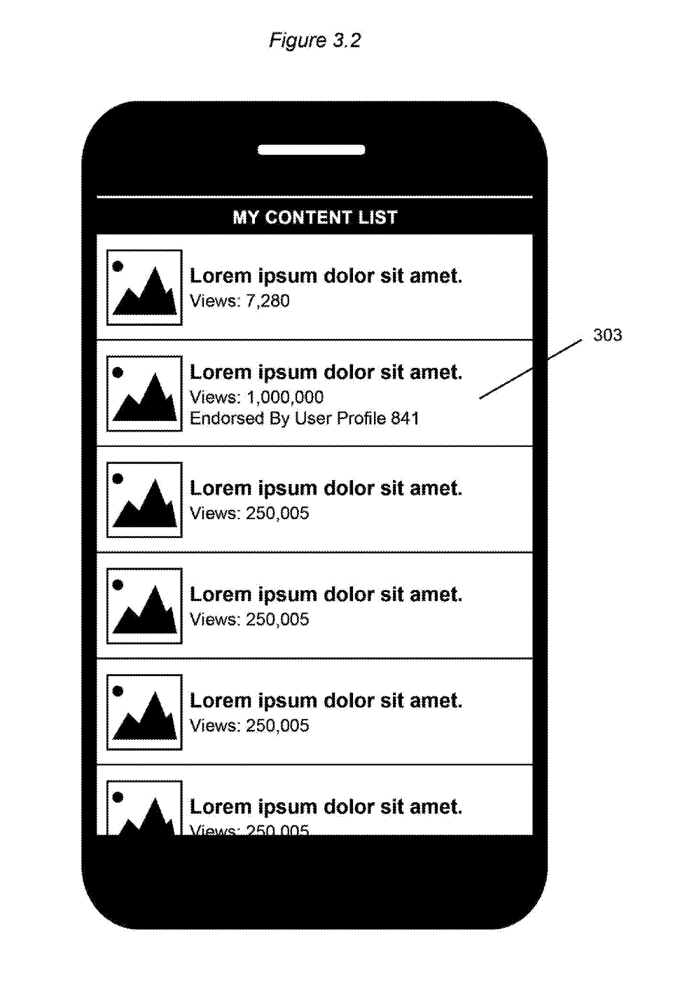

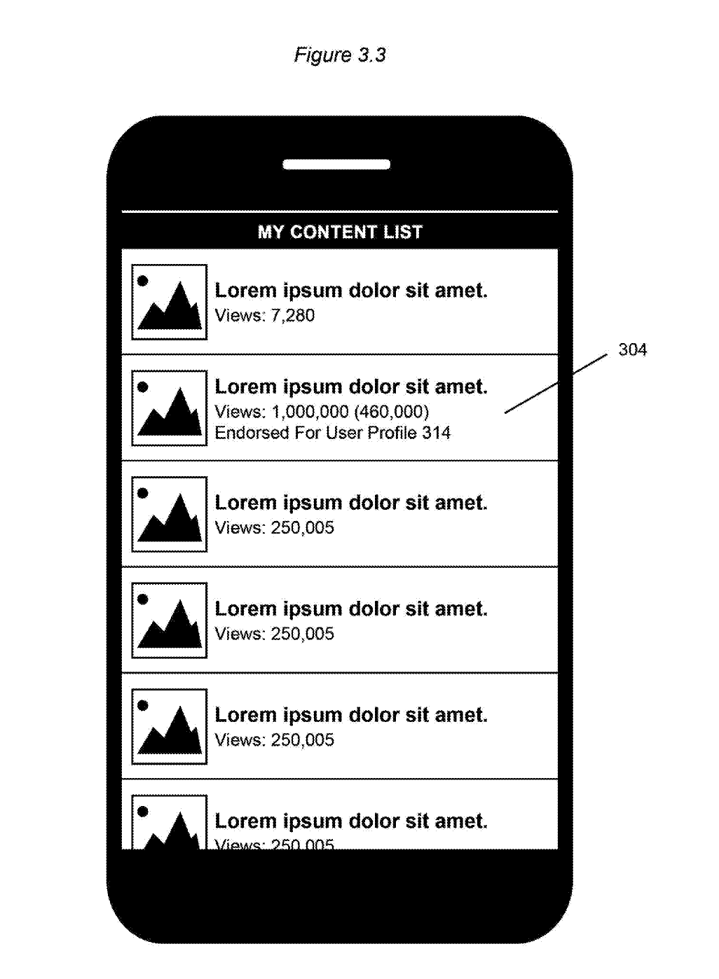

In some embodiments, a publishing user may authorize another entity to distribute original versions or copies of their published data. In FIG. 3.1, field 302 is another element form 102 may contain, shown on the display screen of example smart device 301. Field 302 allows the publishing user to select one or more other entities who can endorse the data being published. Once an entity has been selected and the data published, it may appear in the data list of the publishing user, for example, as content 303 does in FIG. 3.2. In some embodiments, a copy of the data may also appear in the data list of the endorsing entity as data 304 does in FIG. 3.3, where it may show one or more view counts, reflective of totals such as the overall total, that user's total or the publishing user's total.

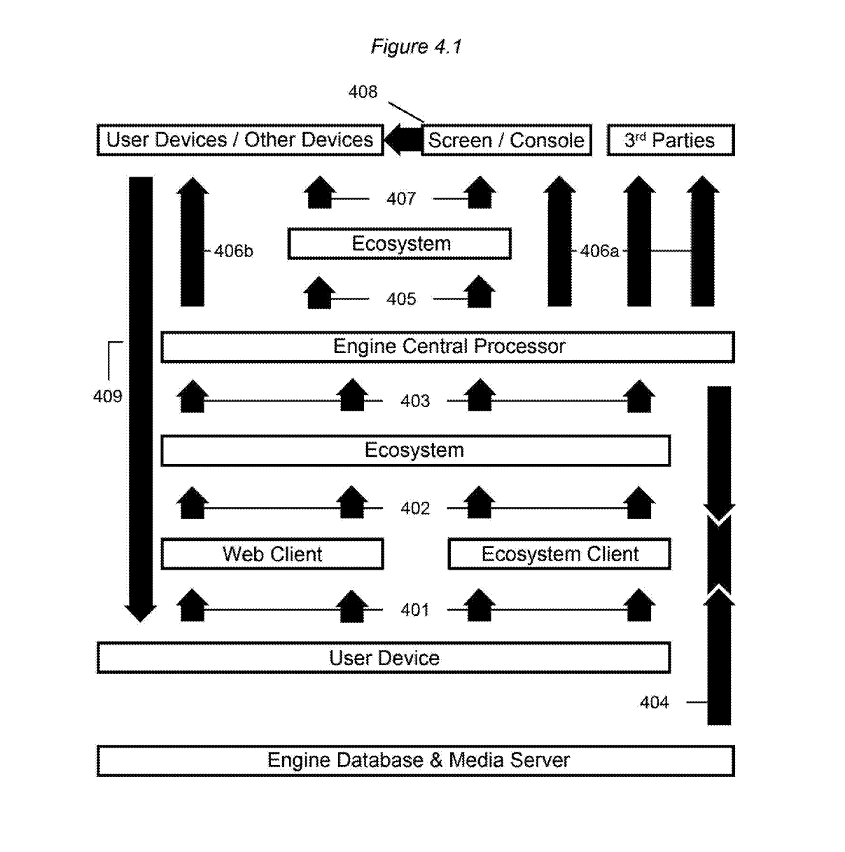

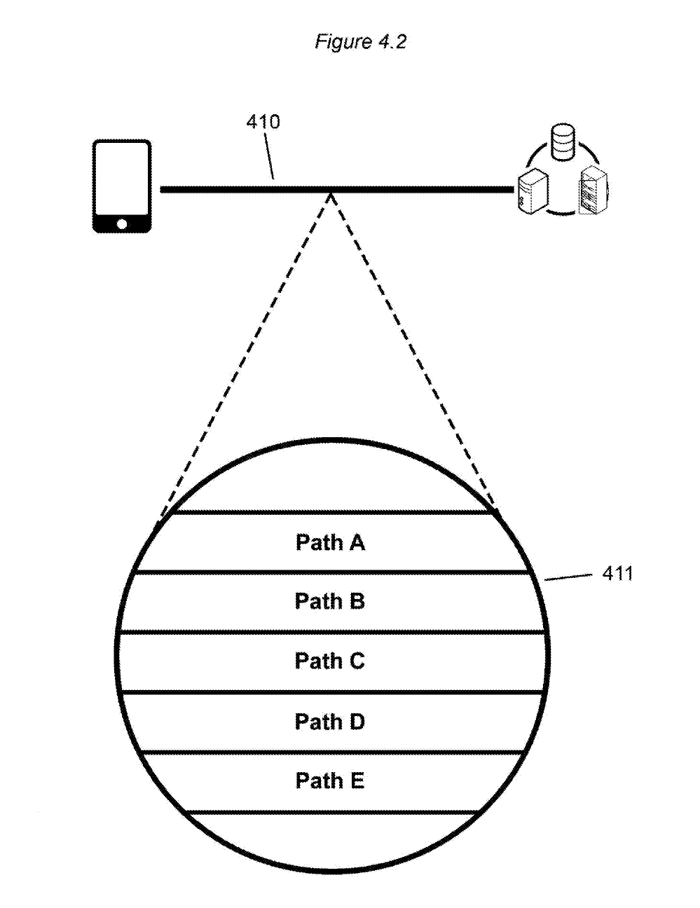

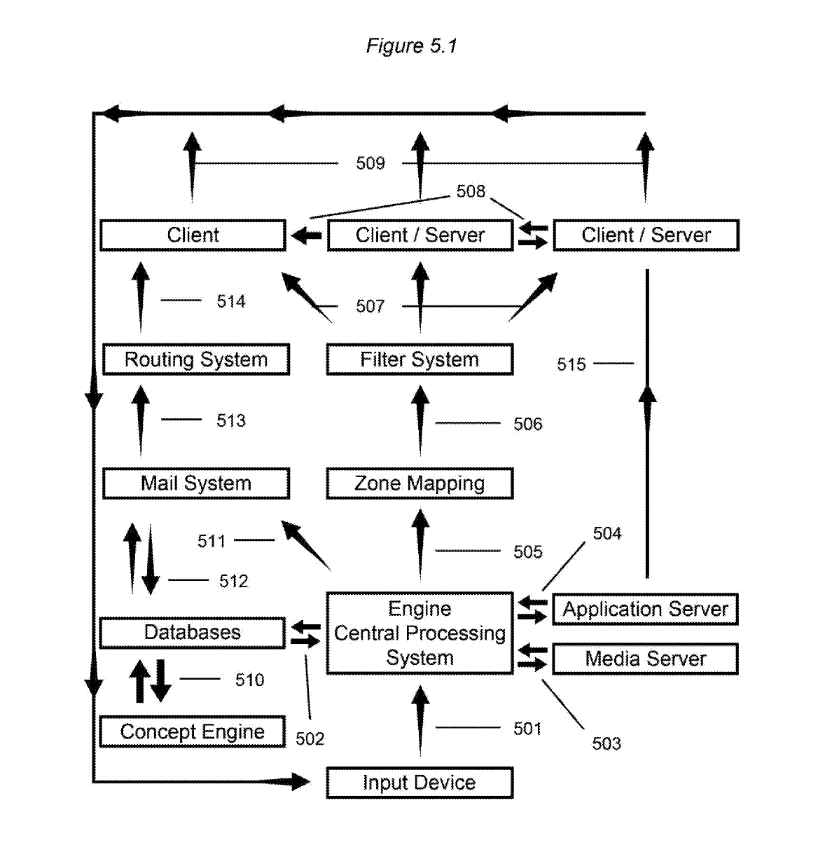

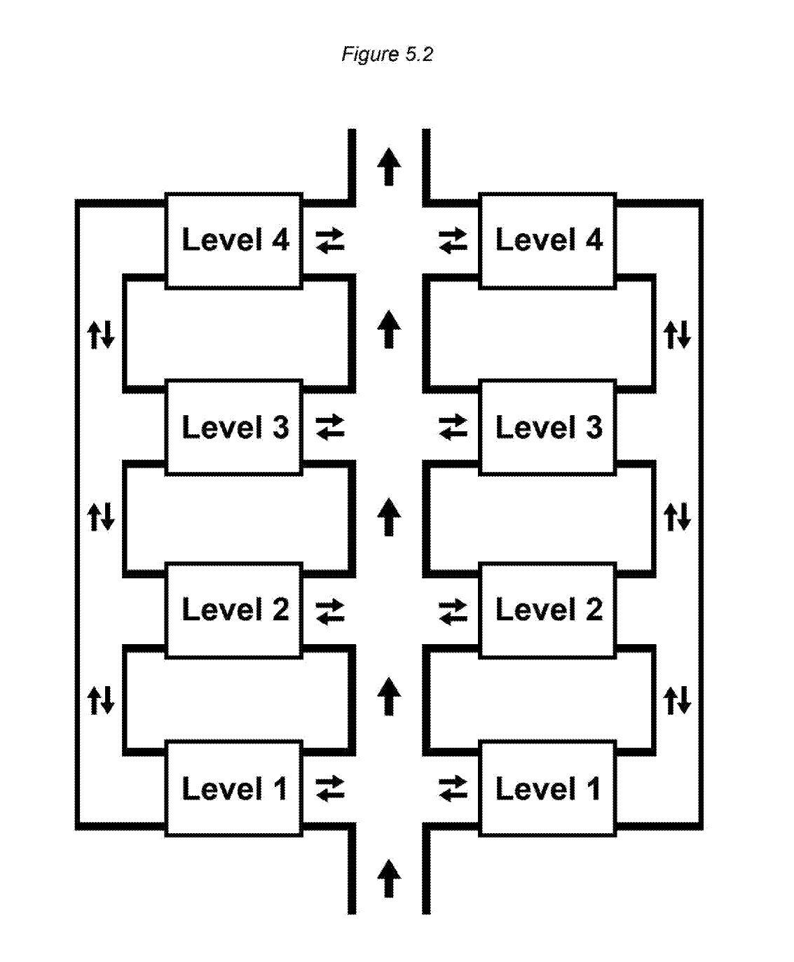

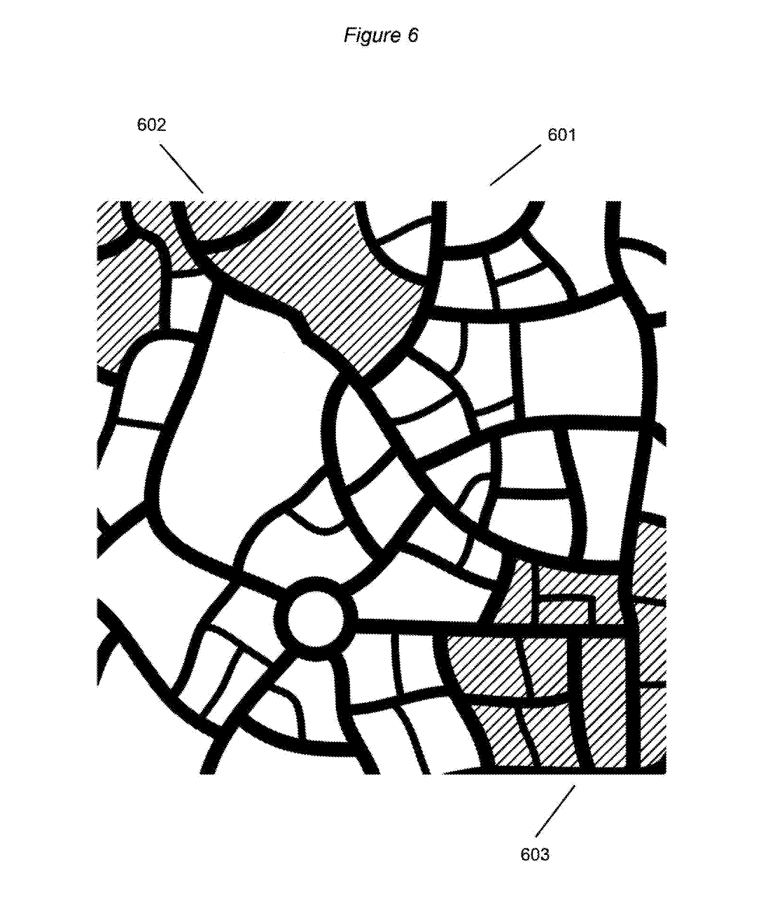

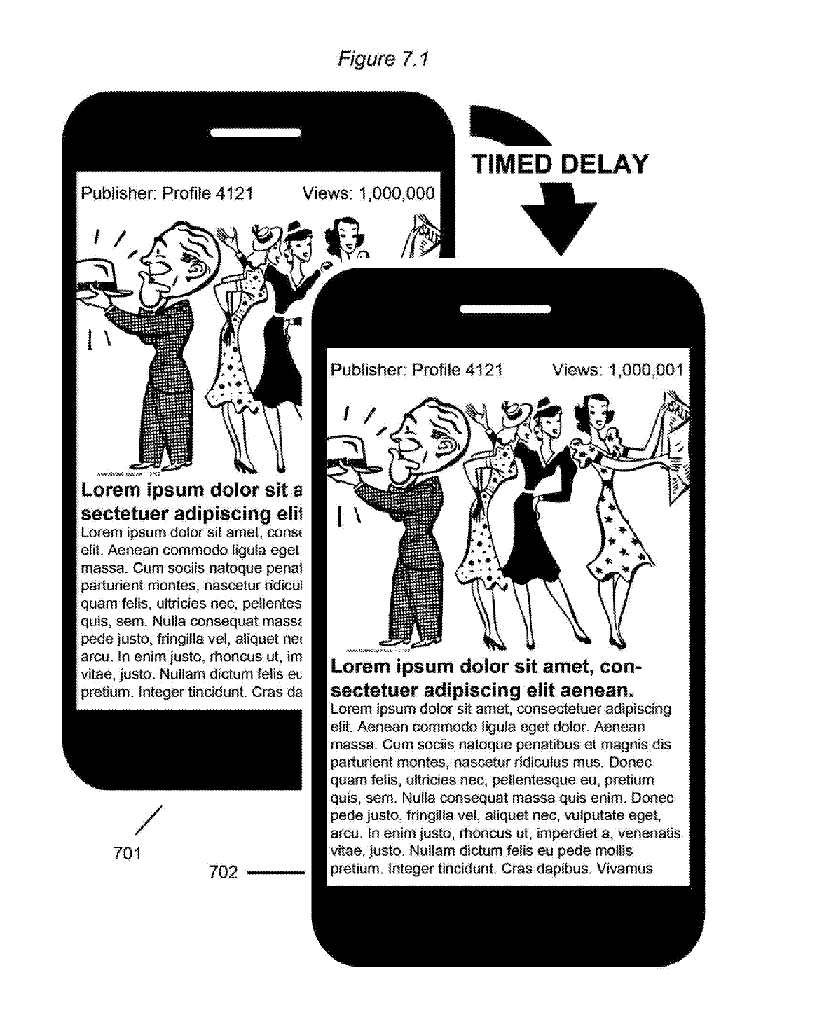

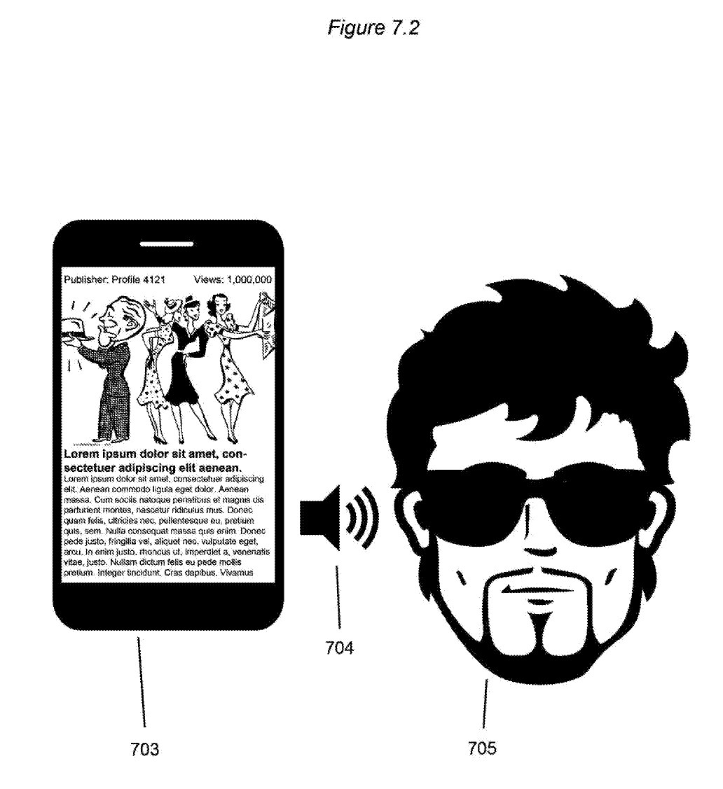

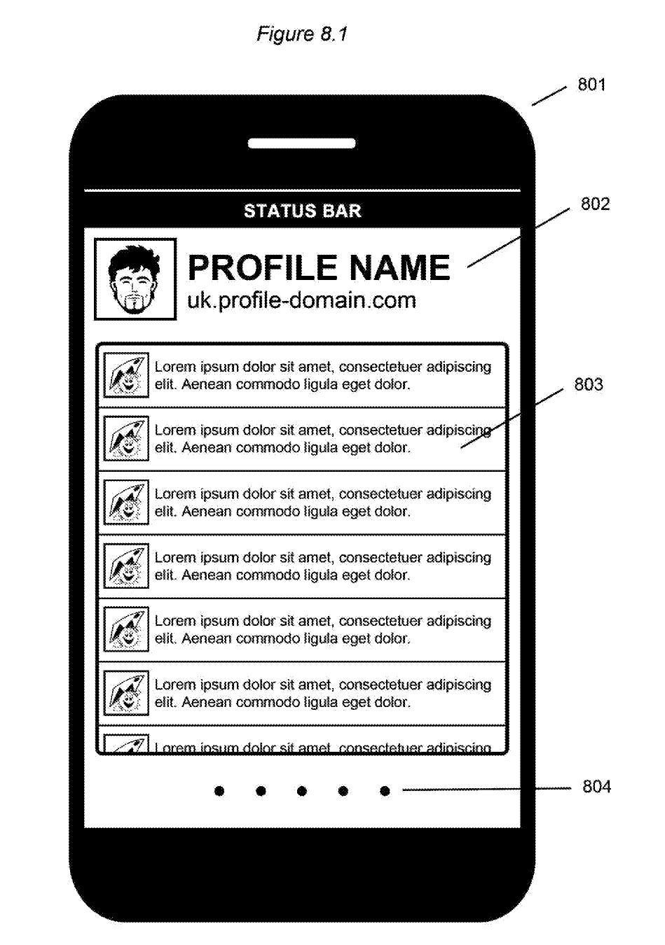

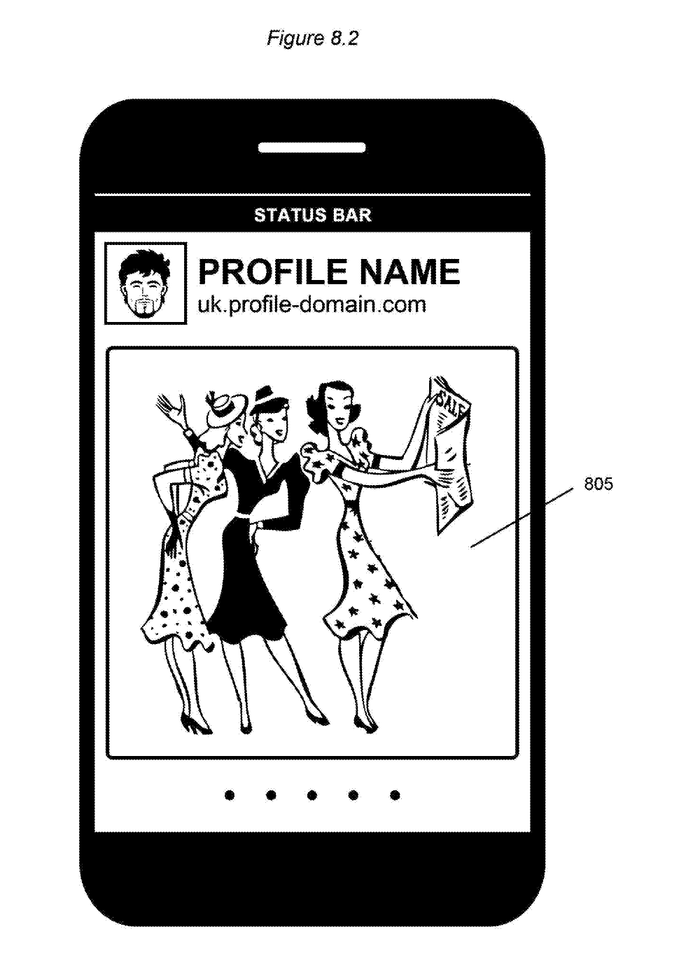

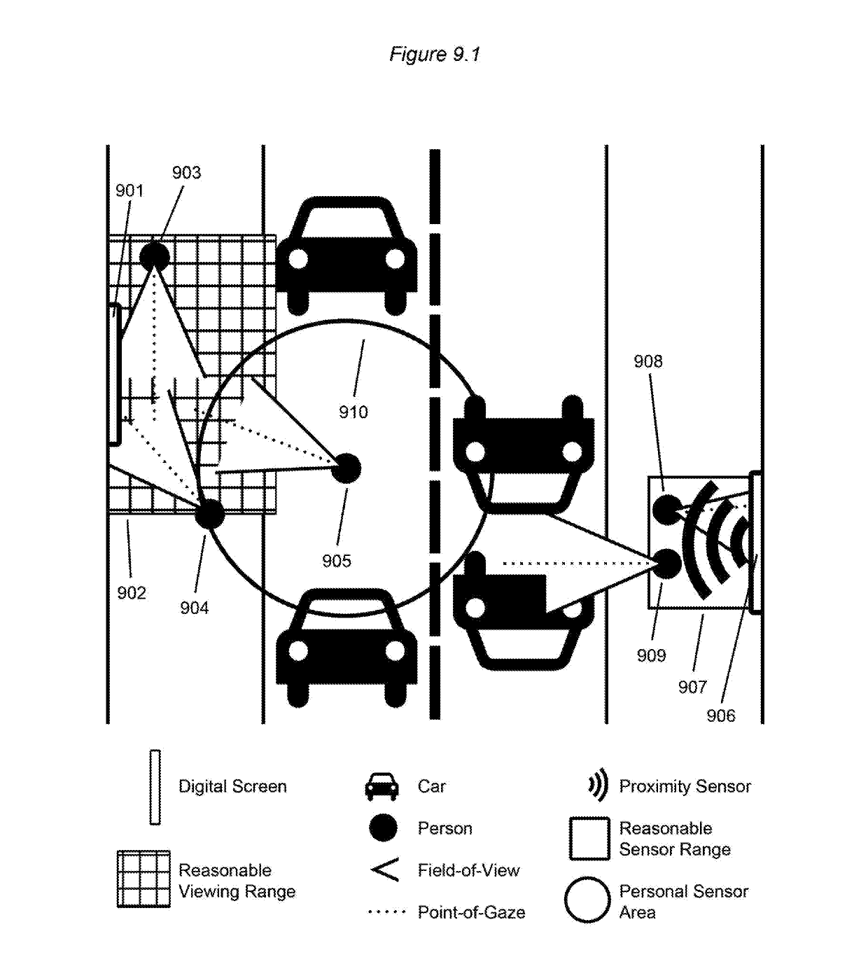

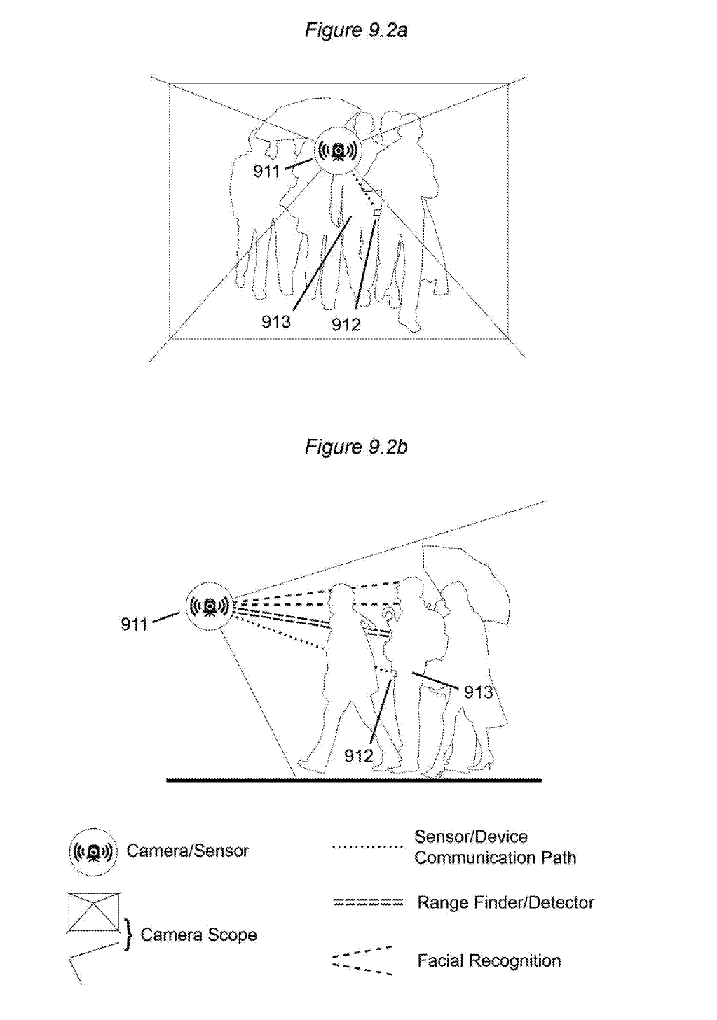

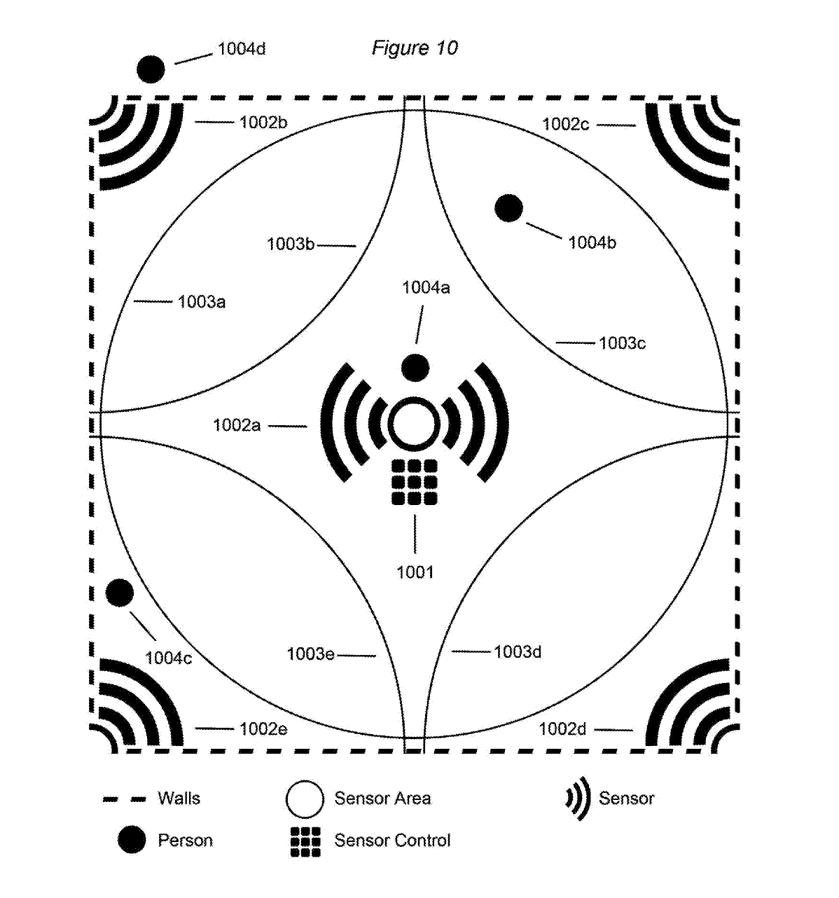

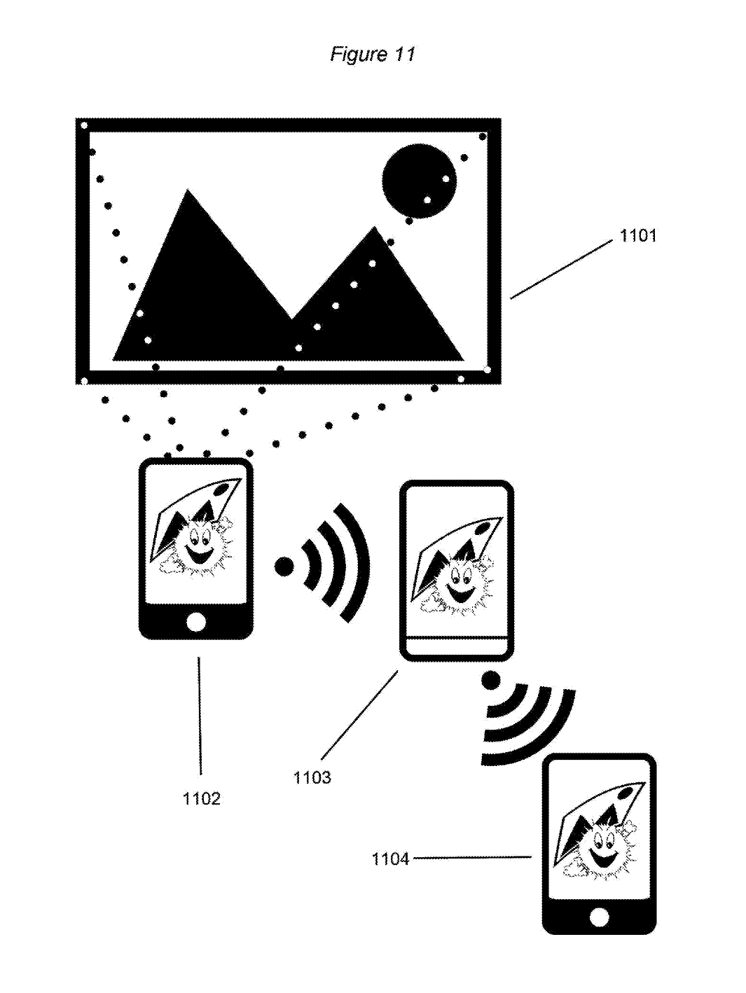

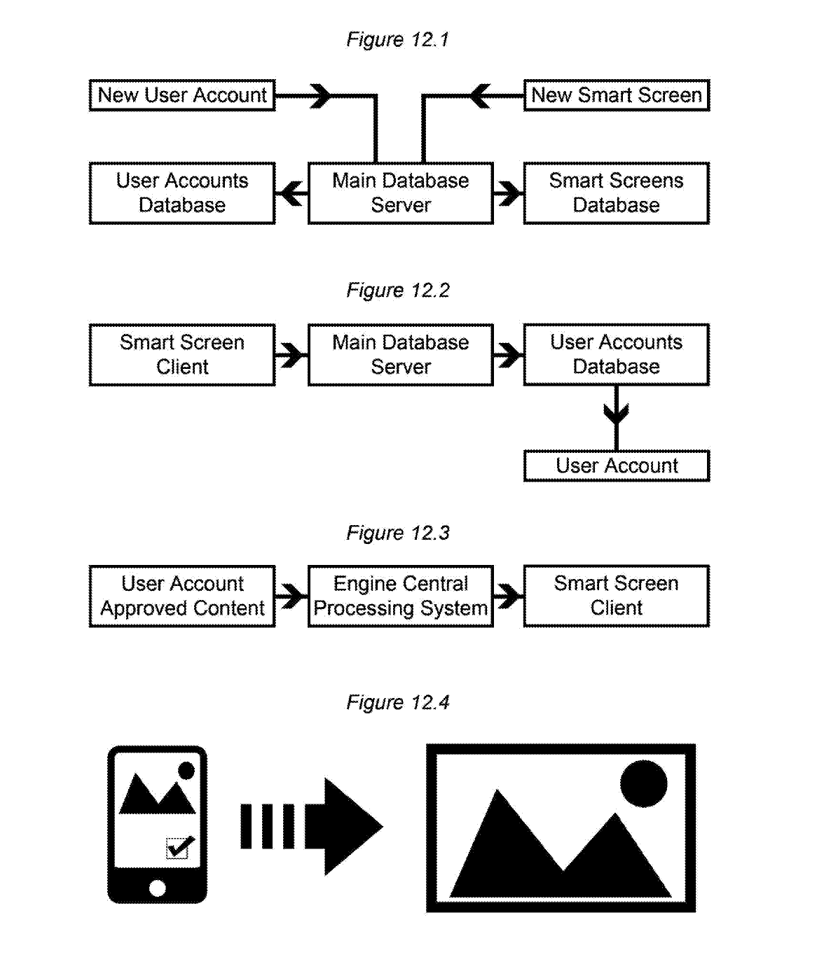

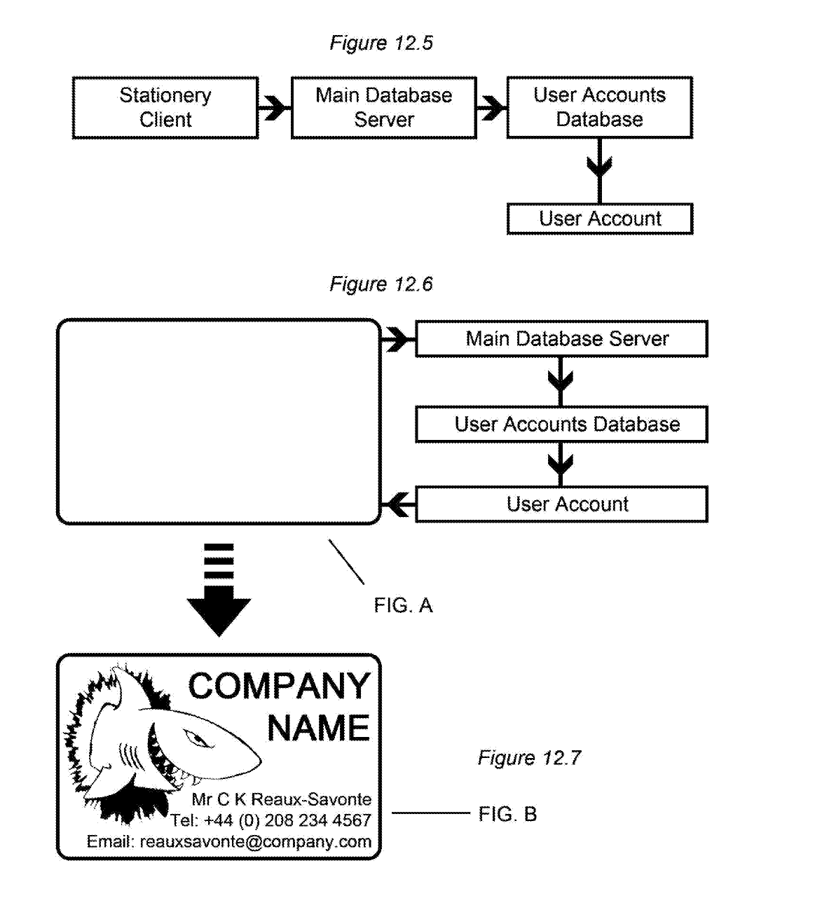

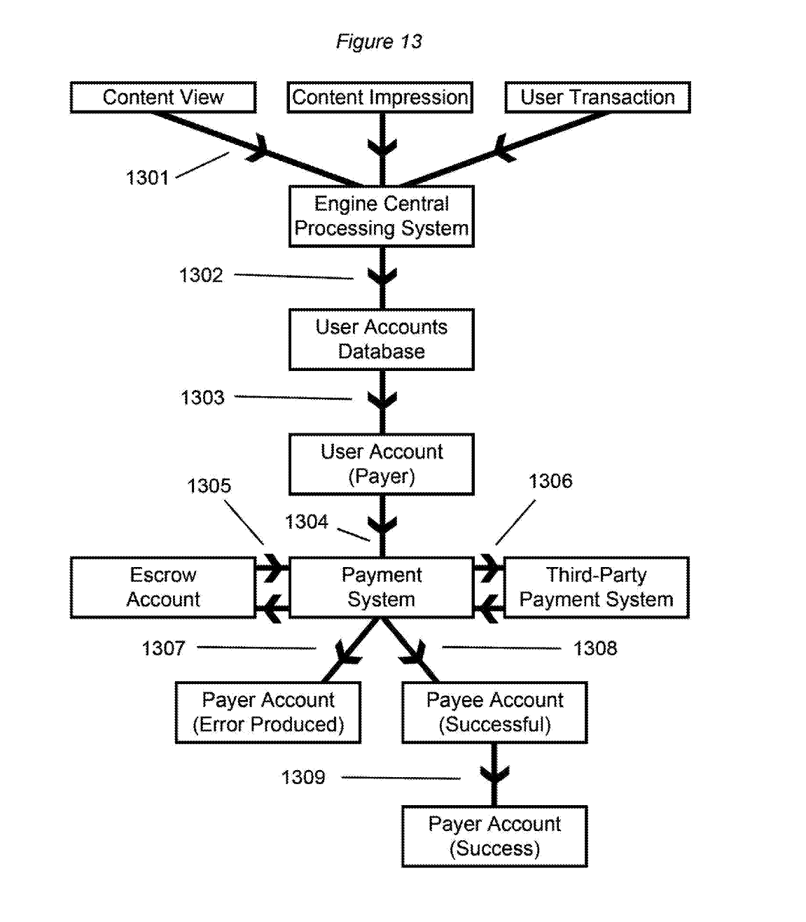

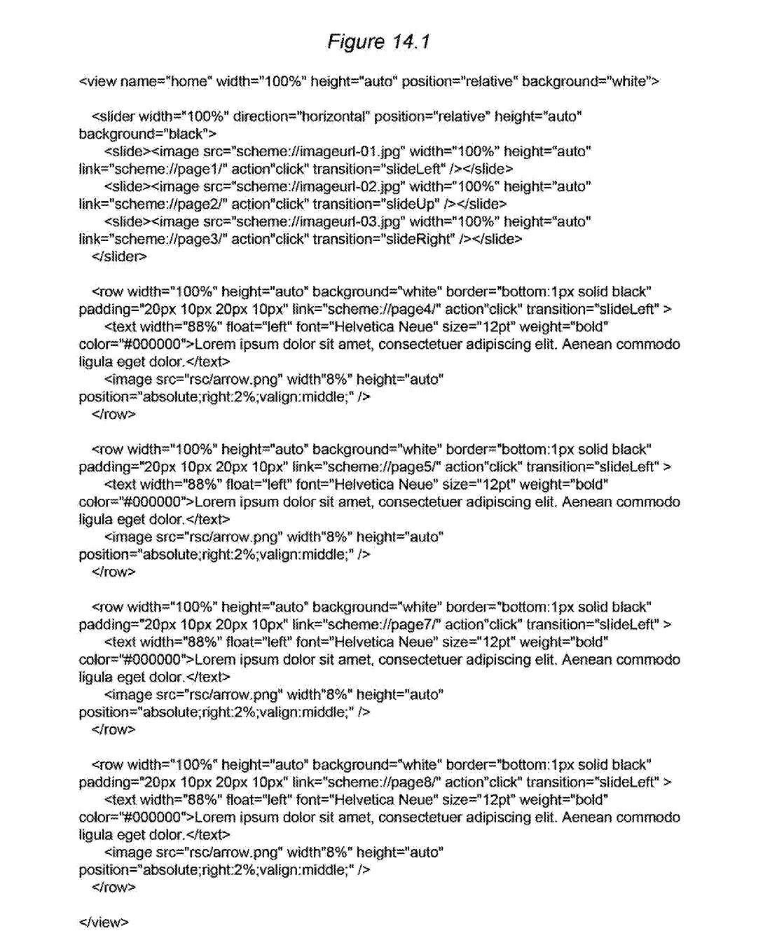

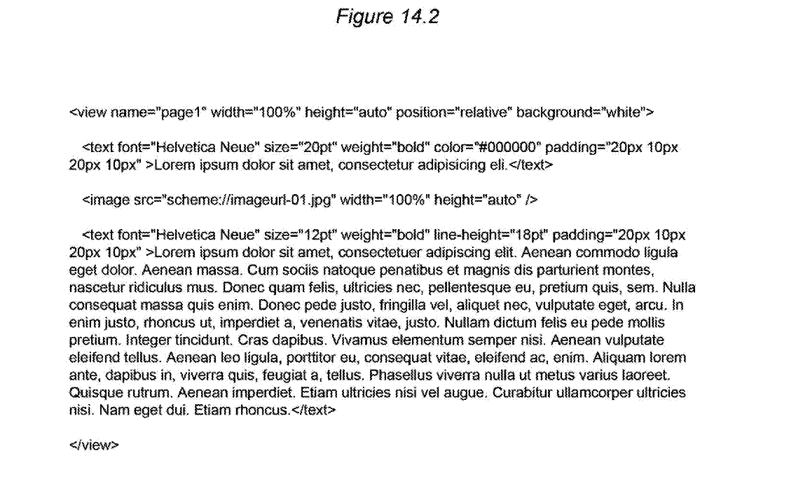

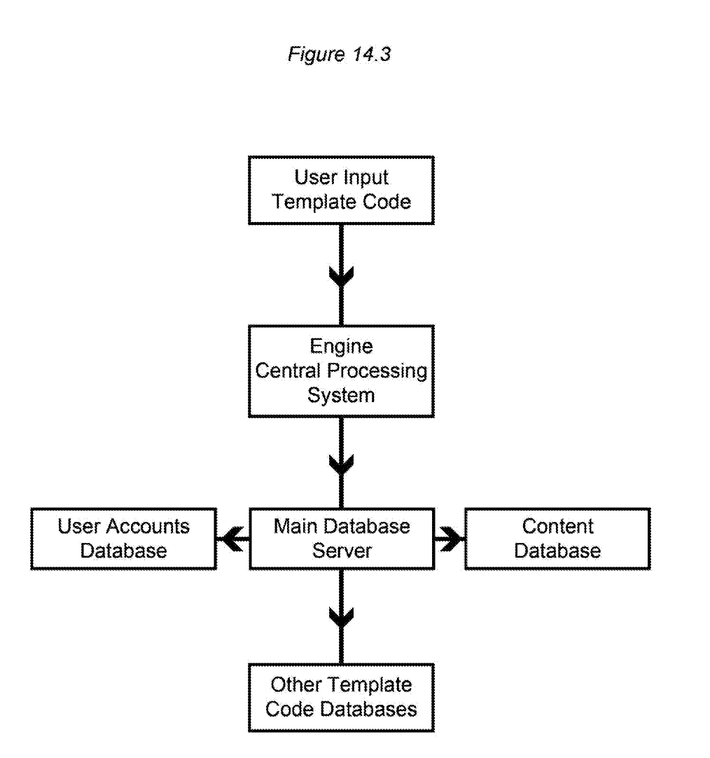

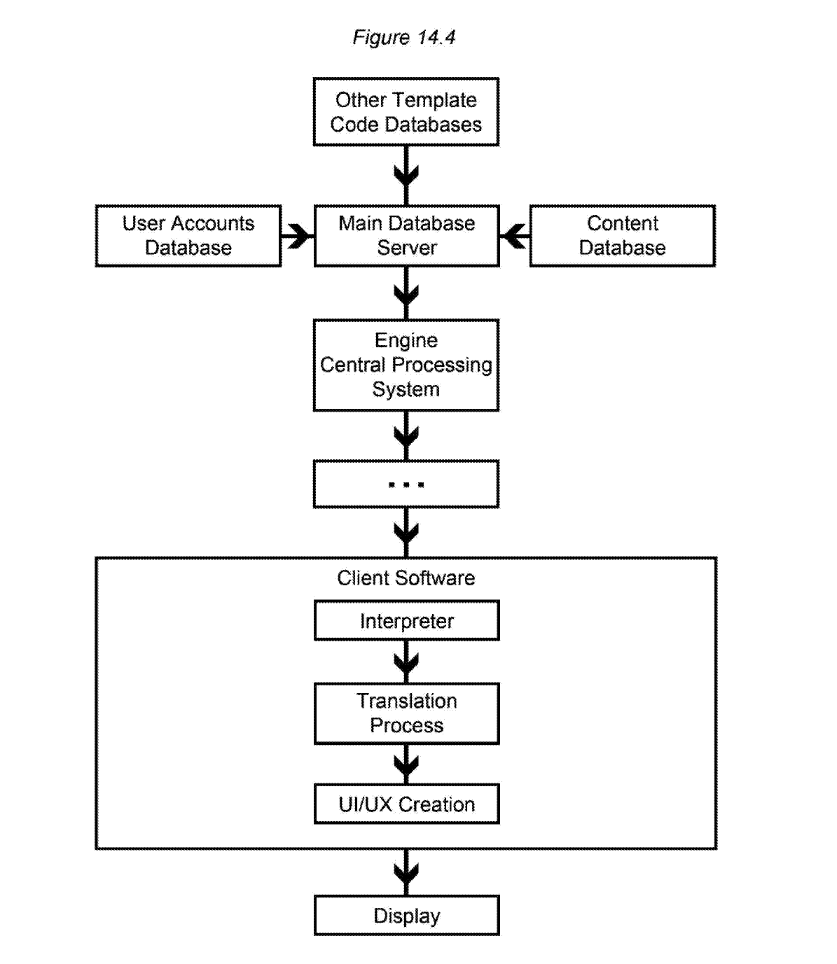

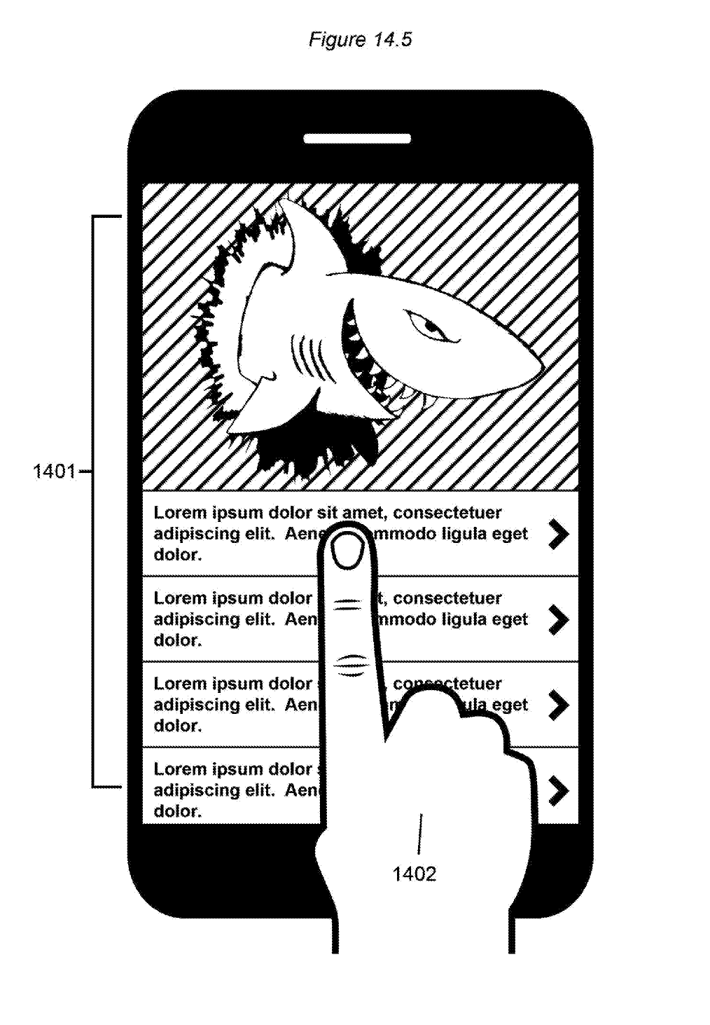

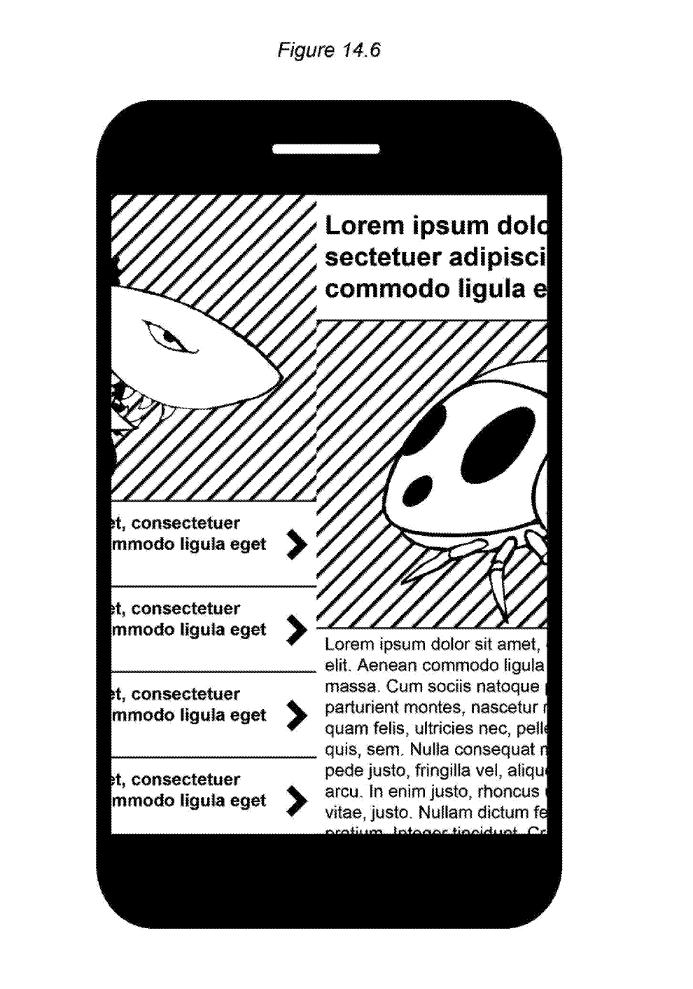

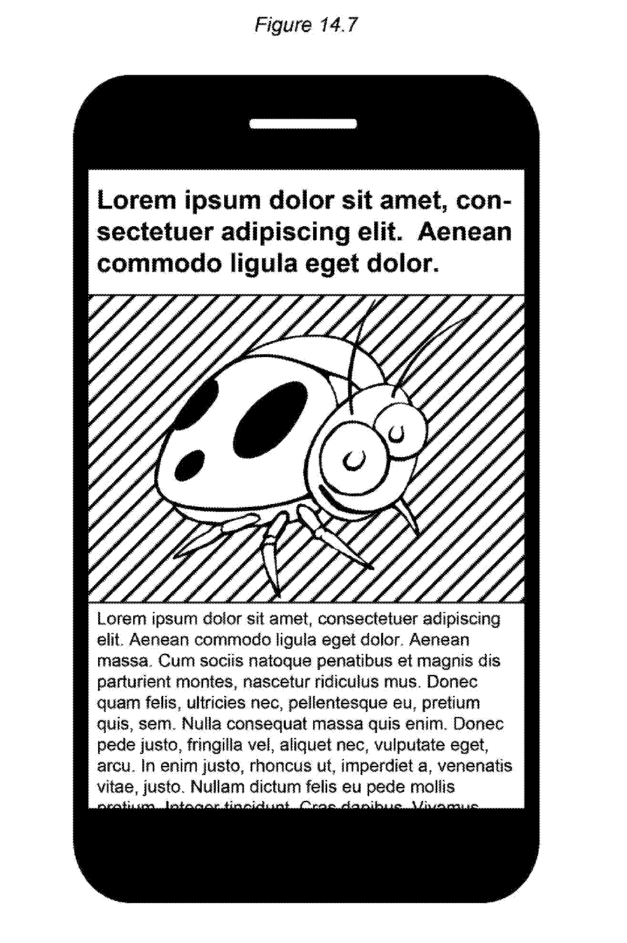

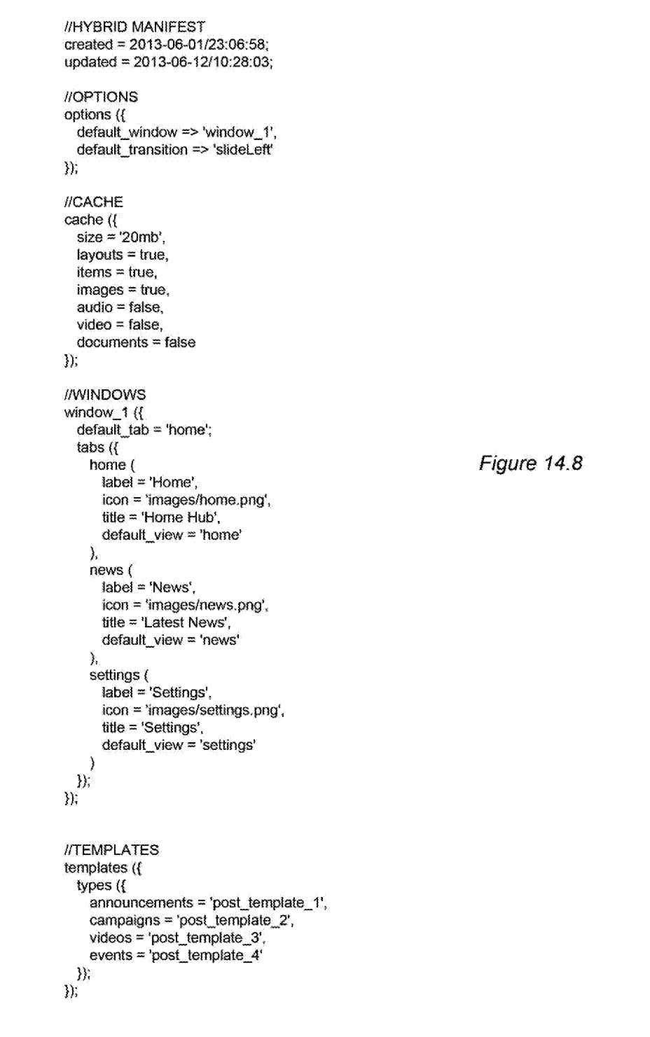

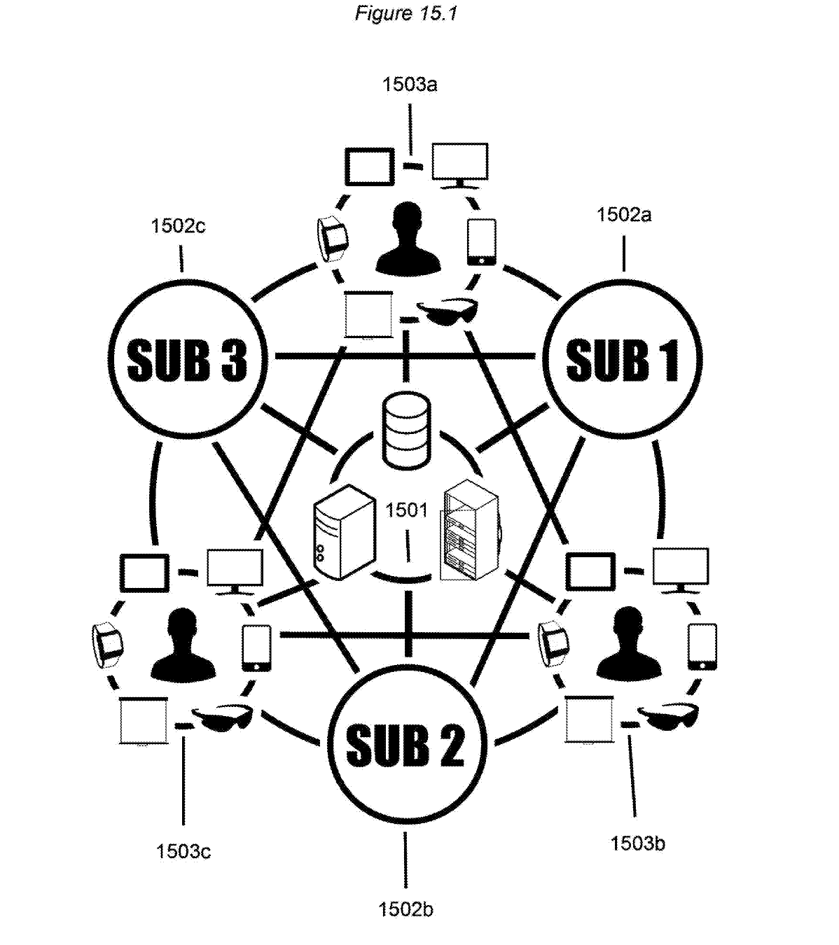

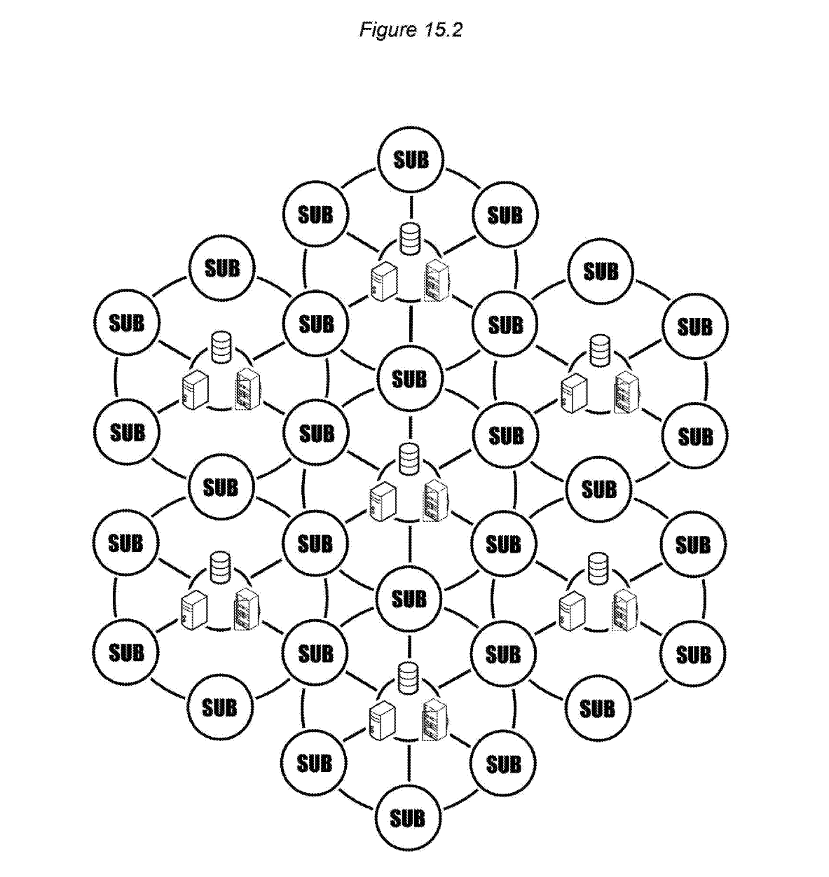

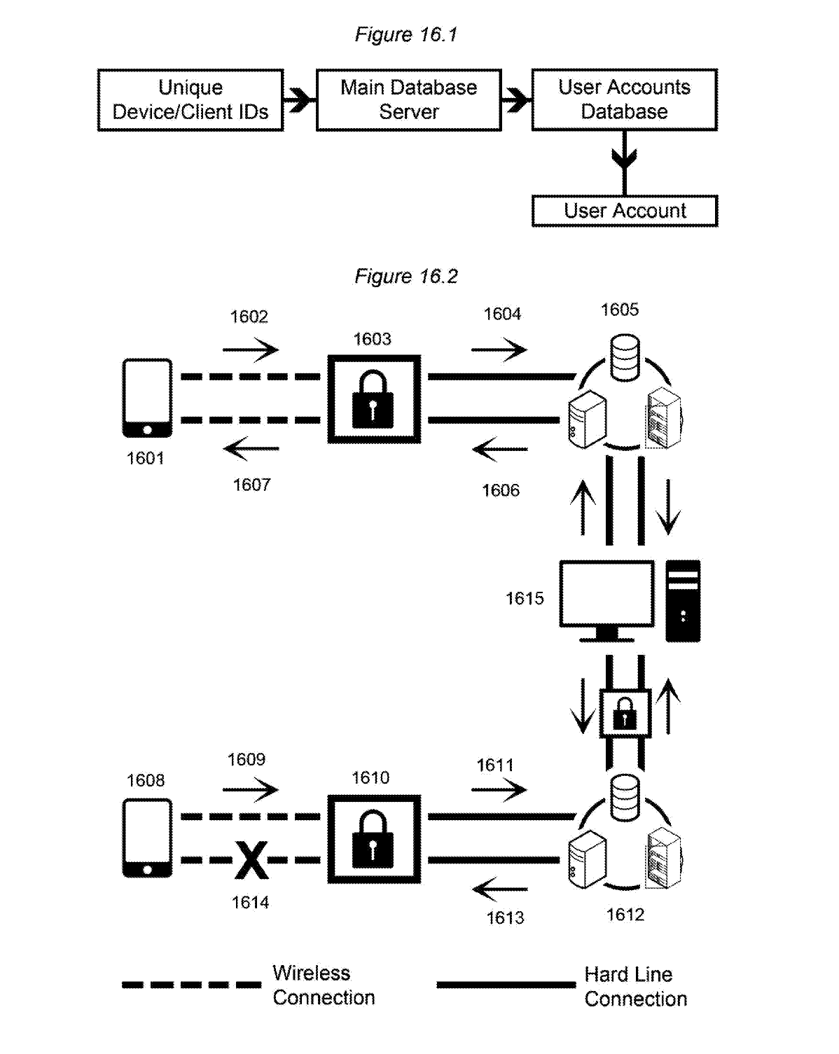

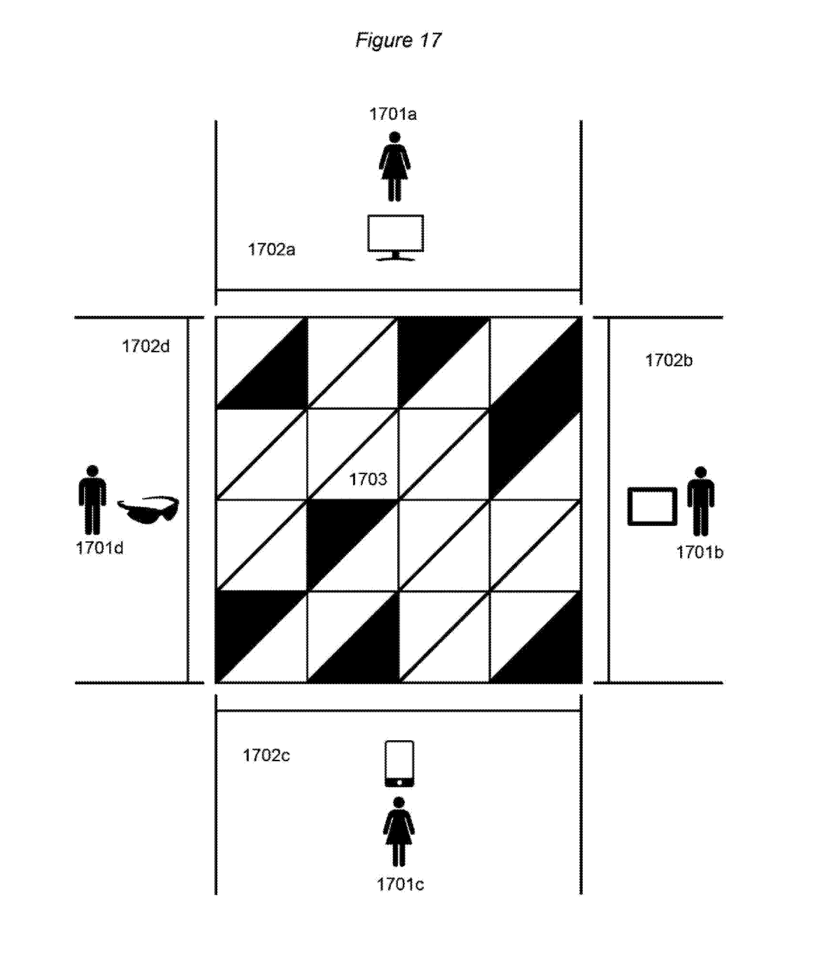

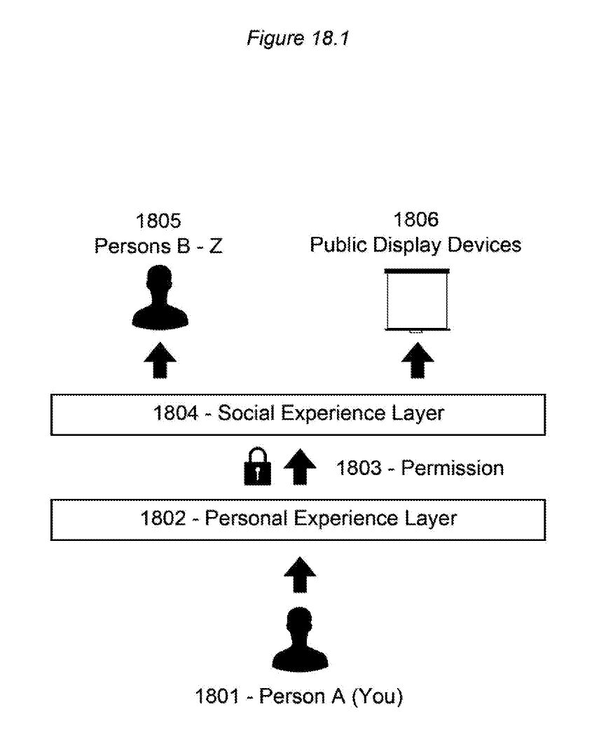

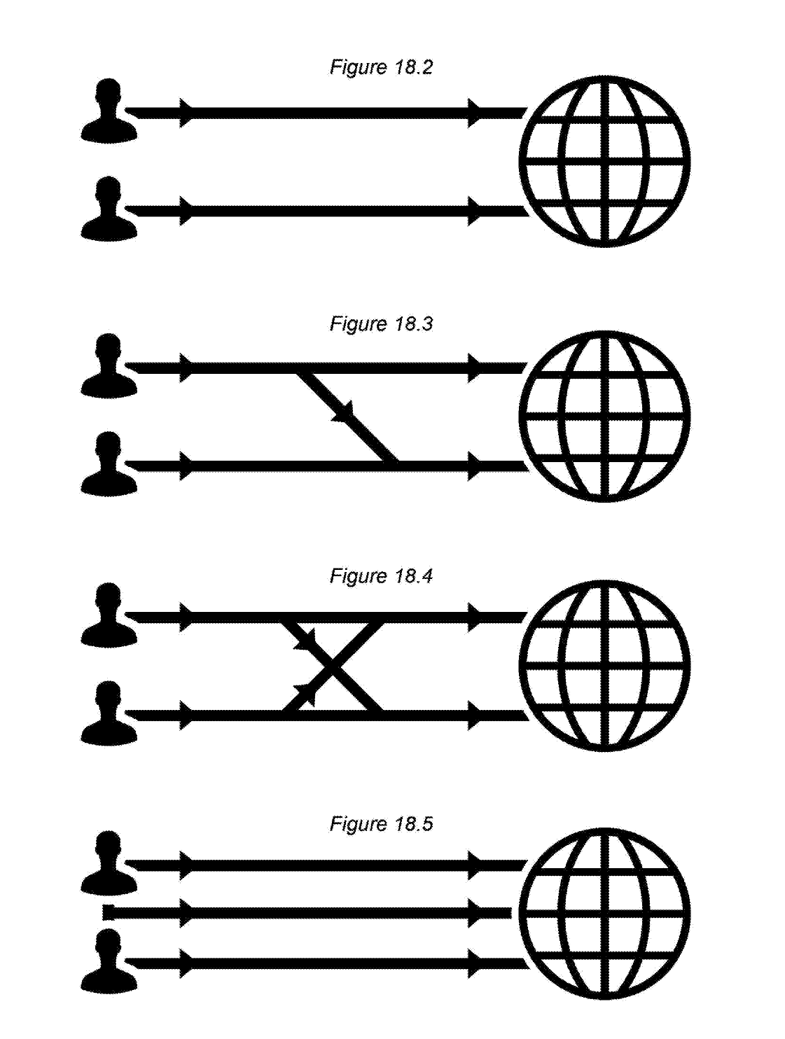

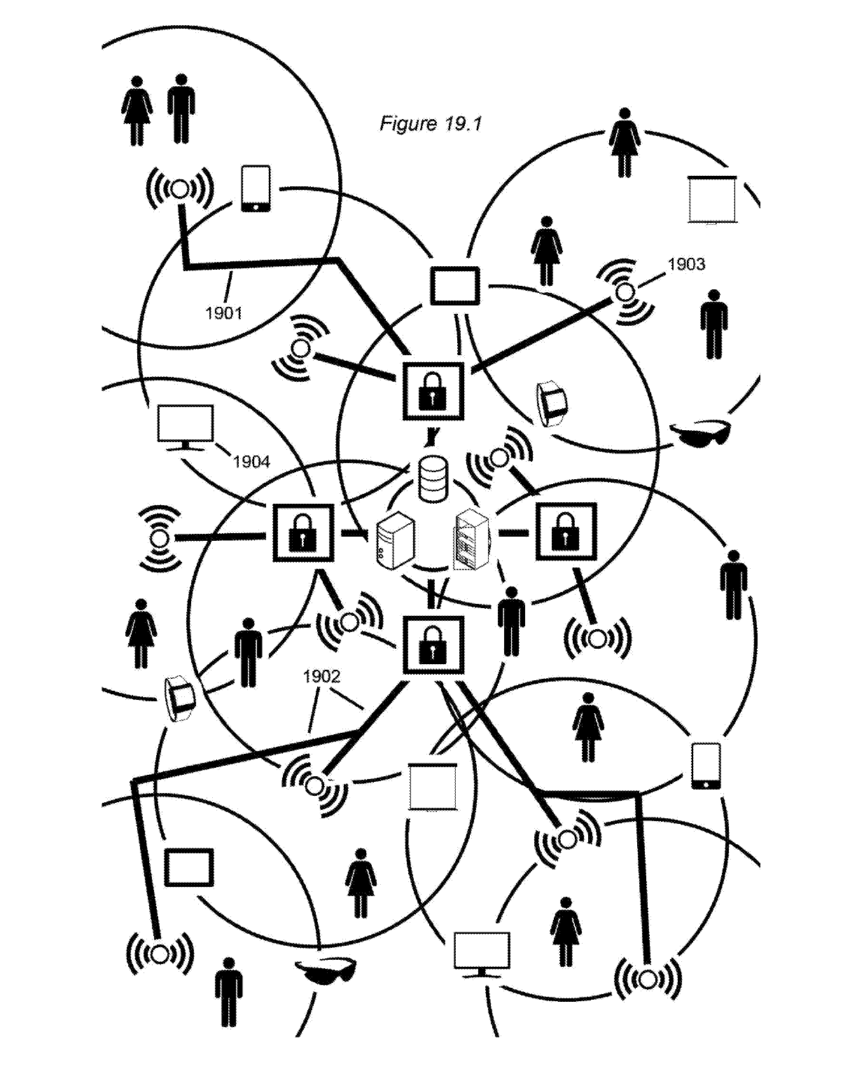

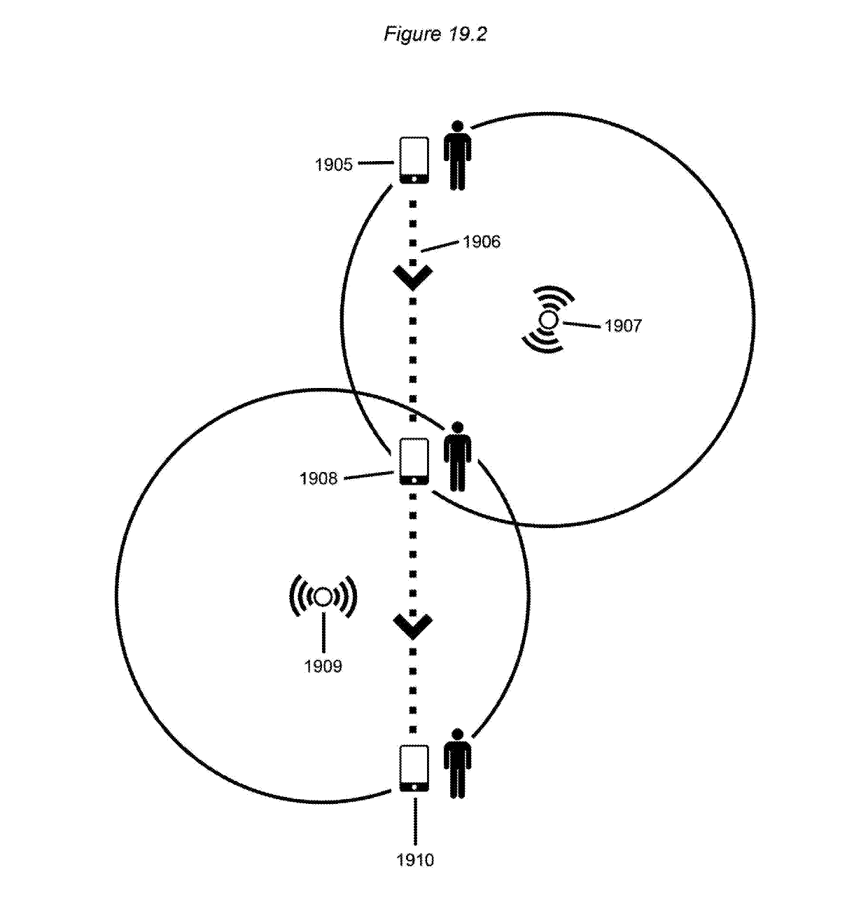

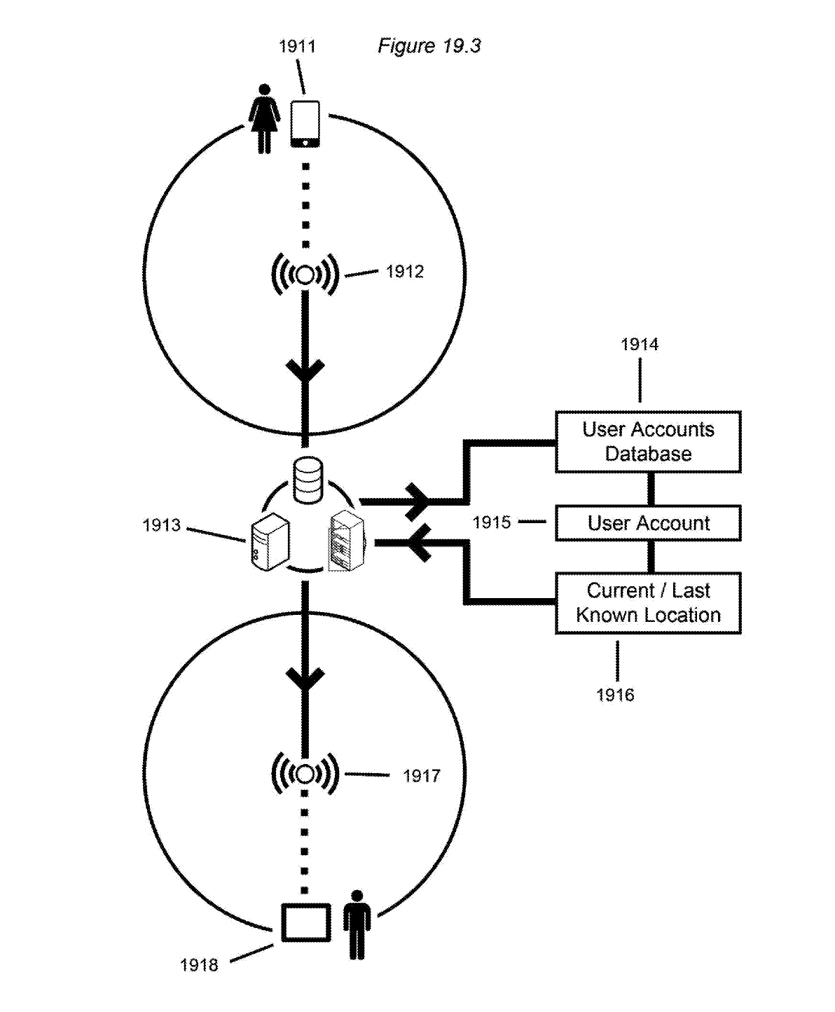

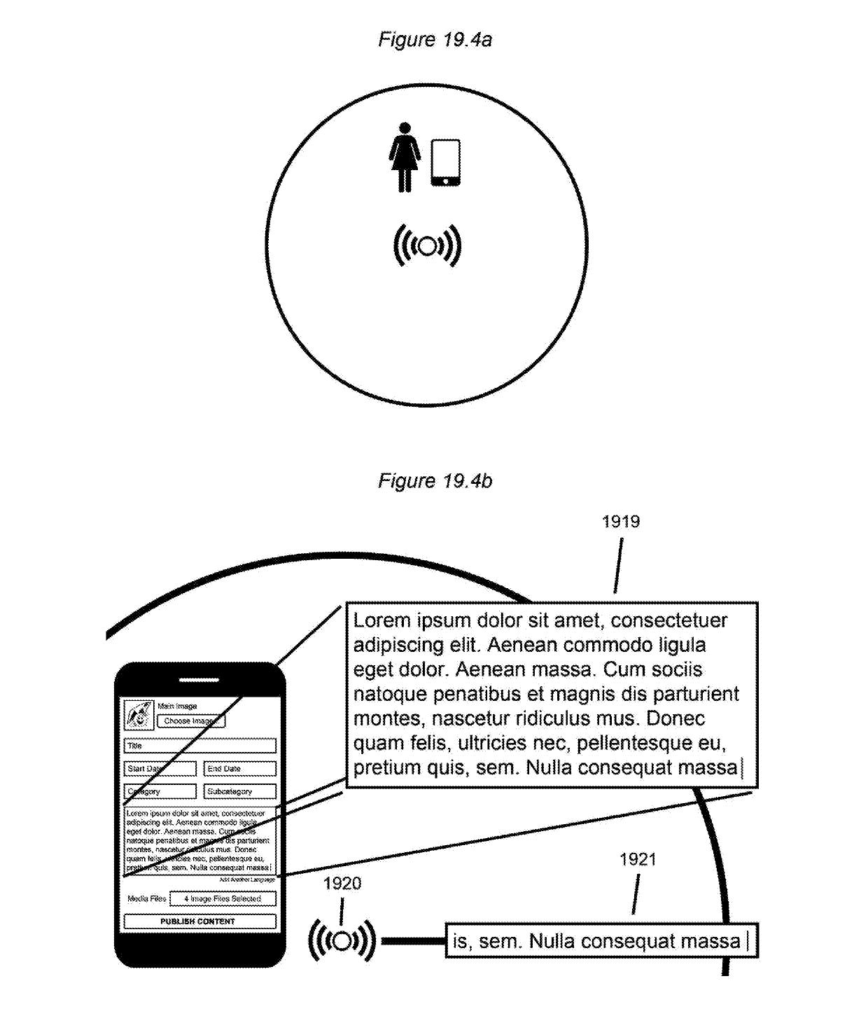

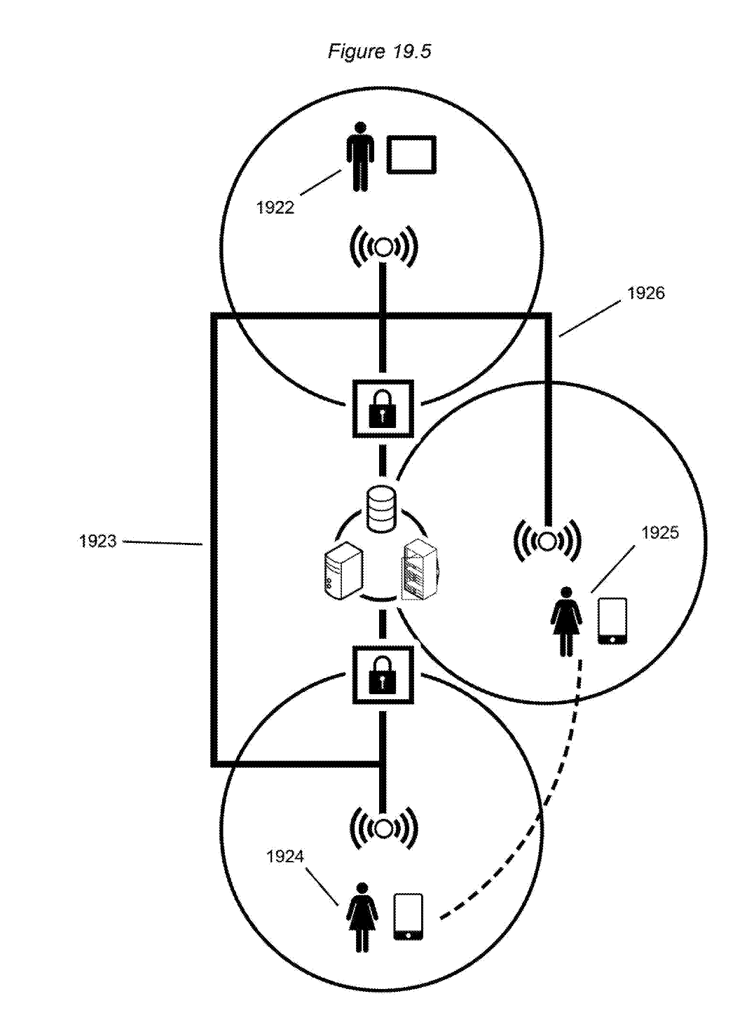

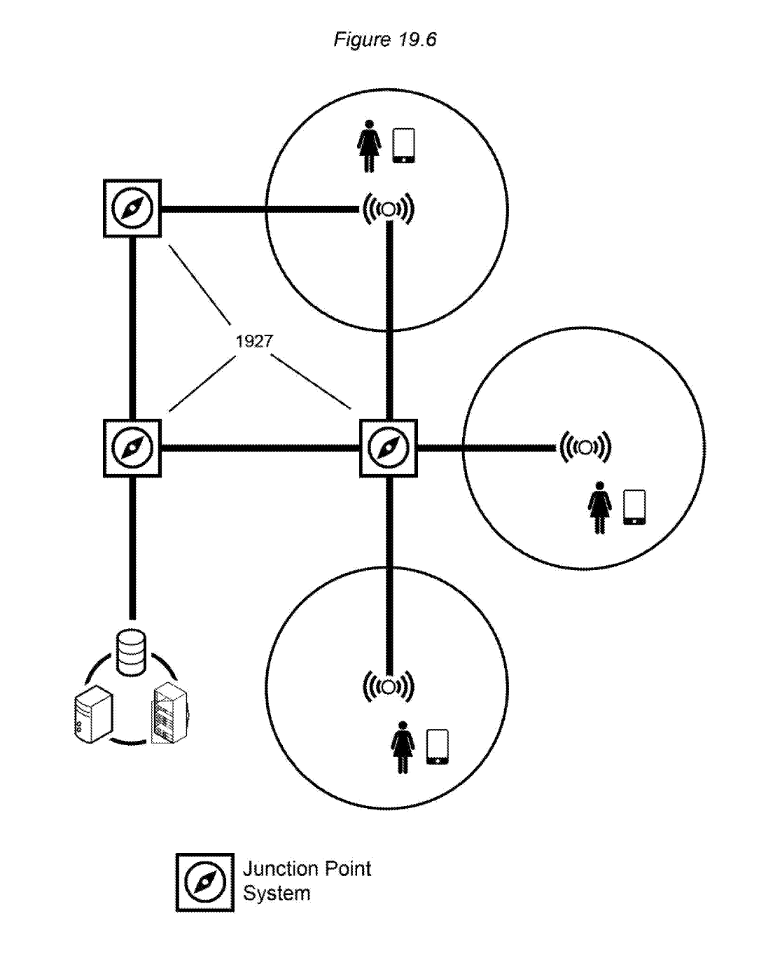

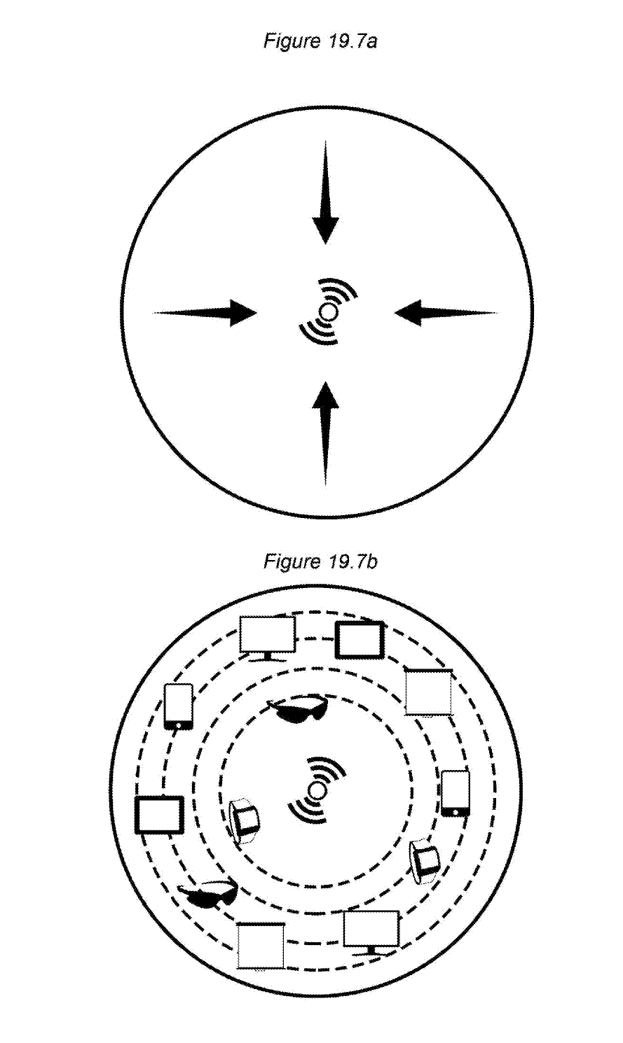

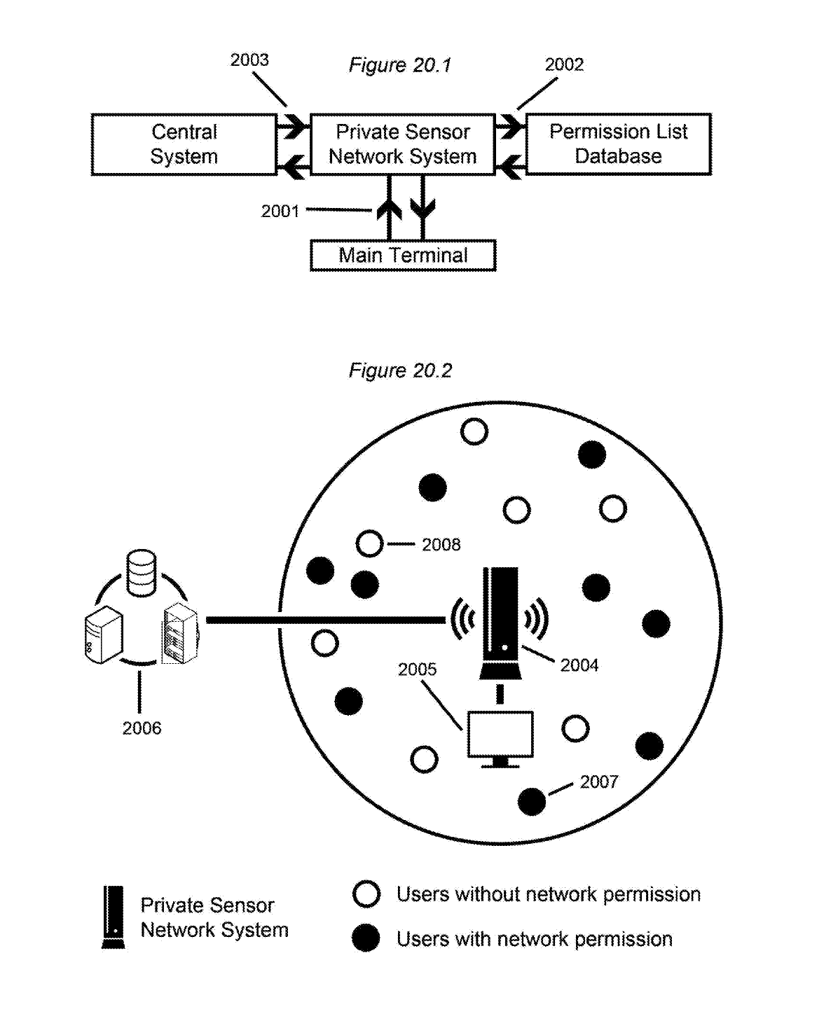

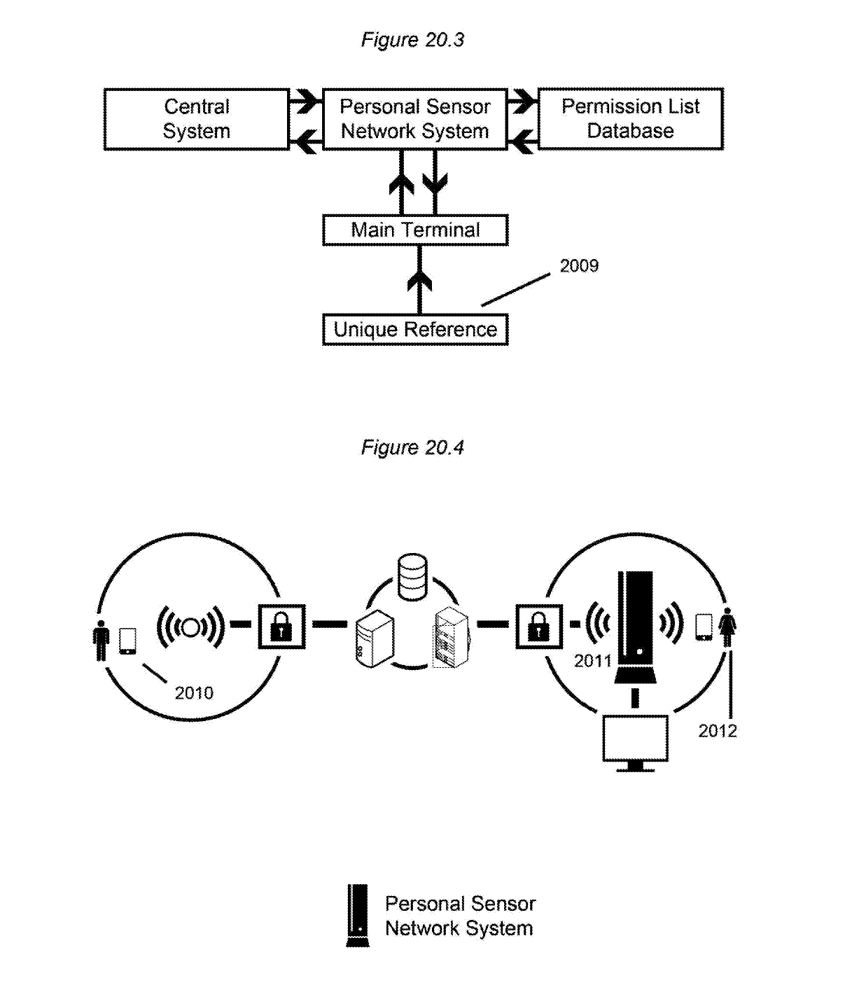

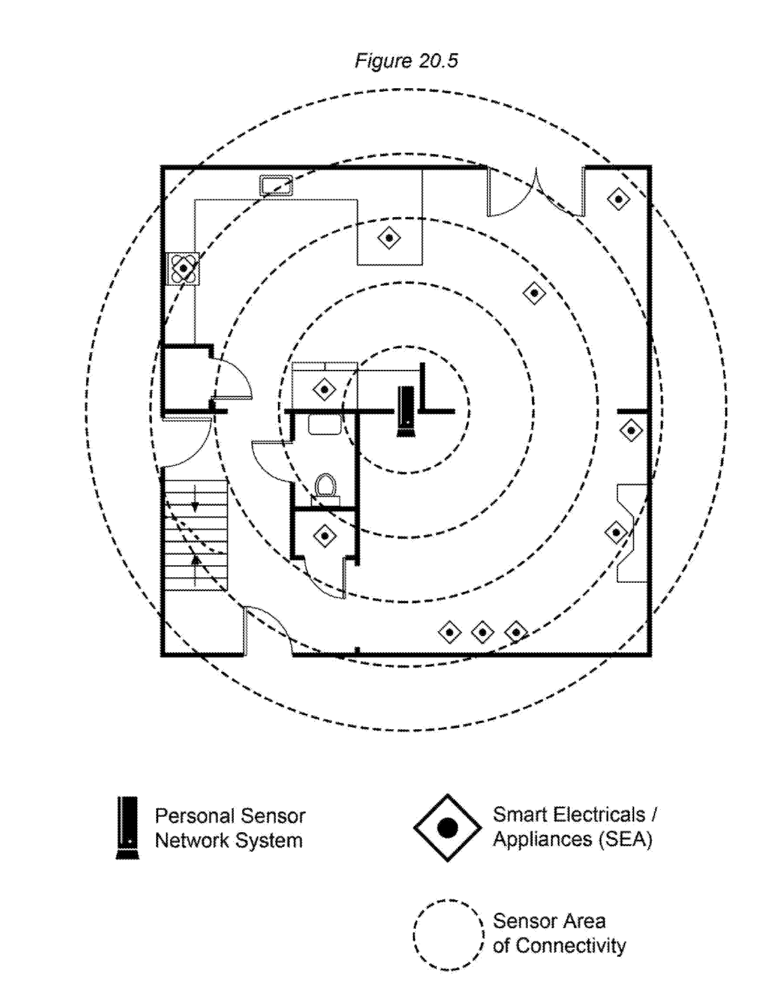

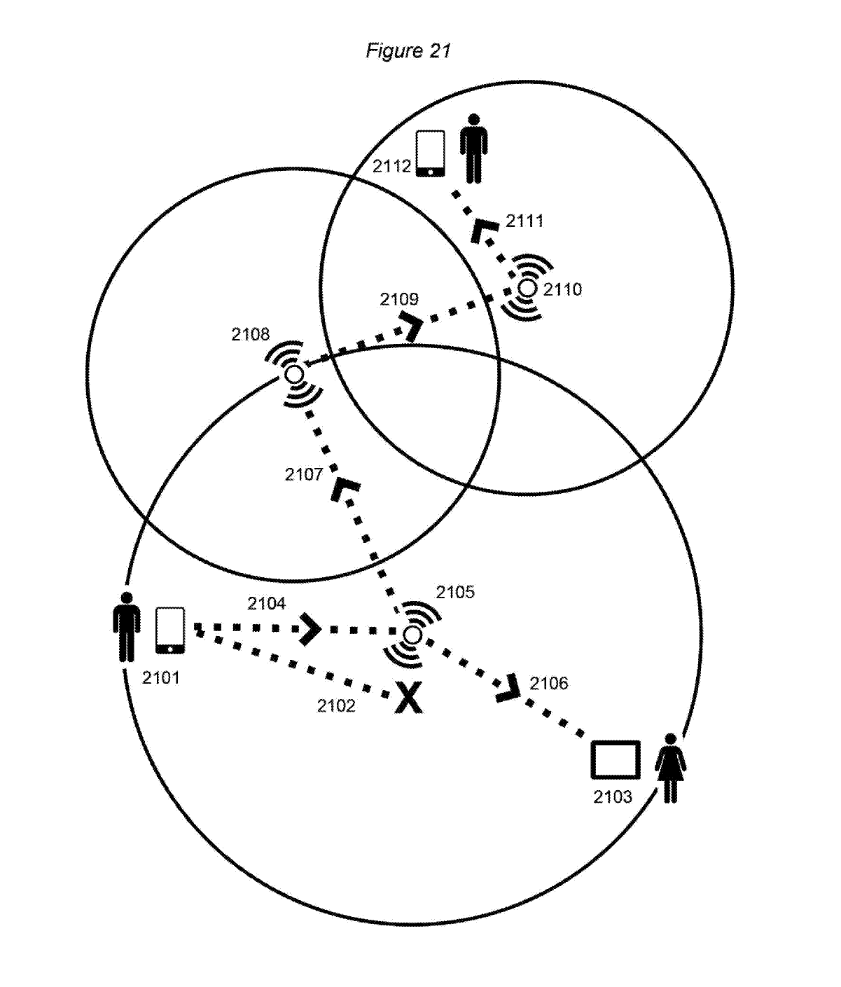

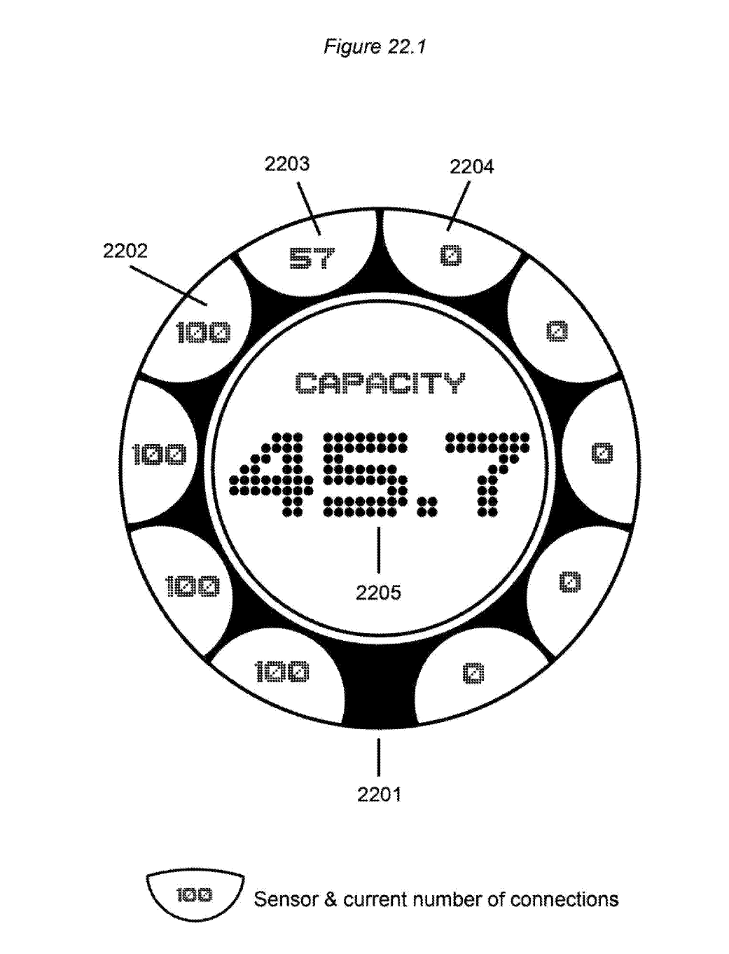

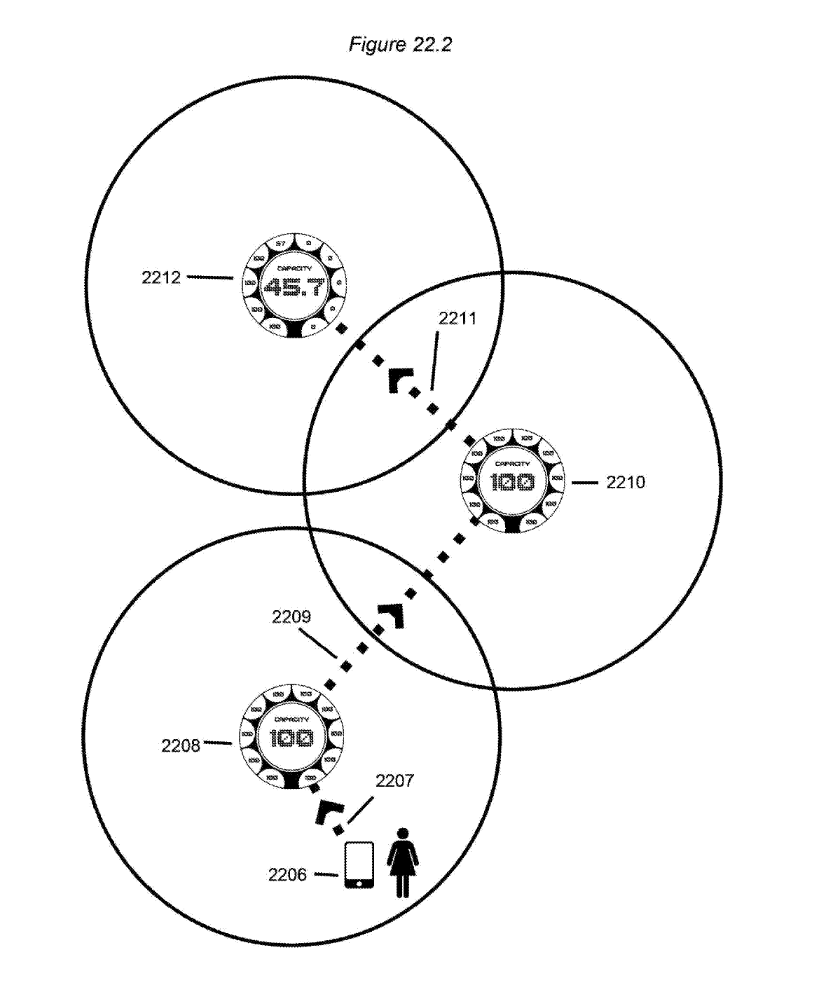

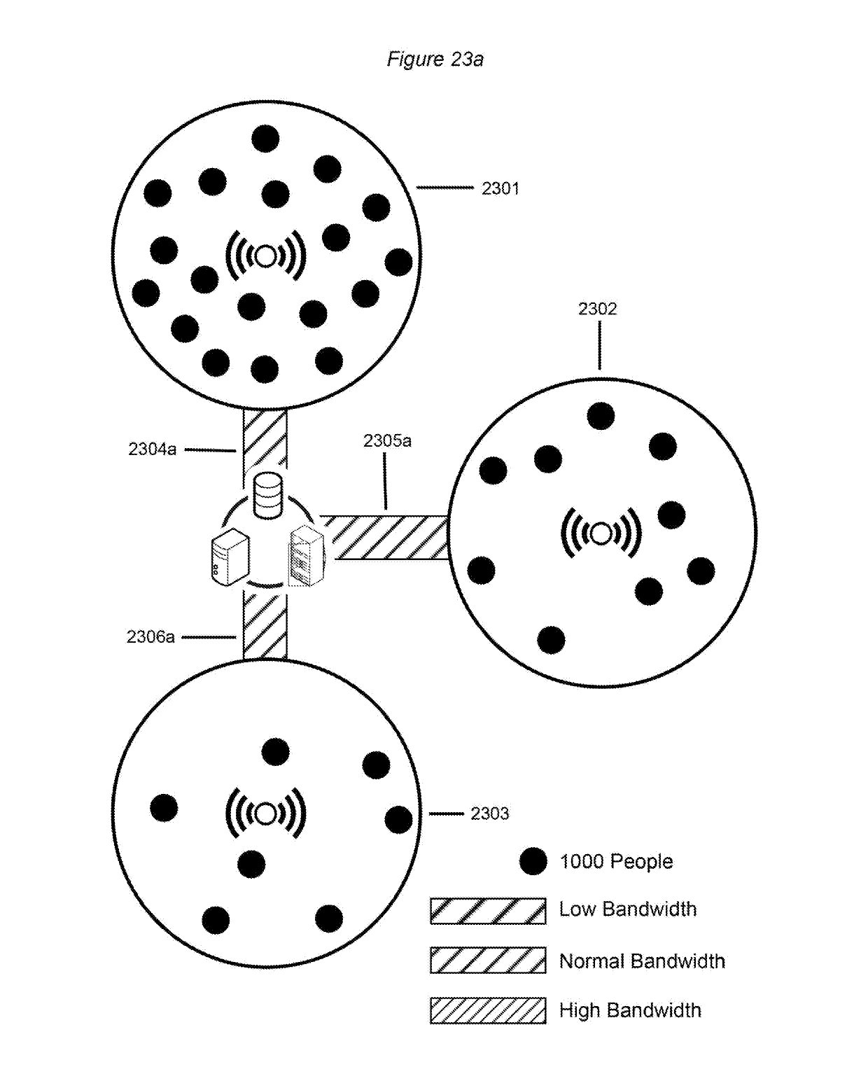

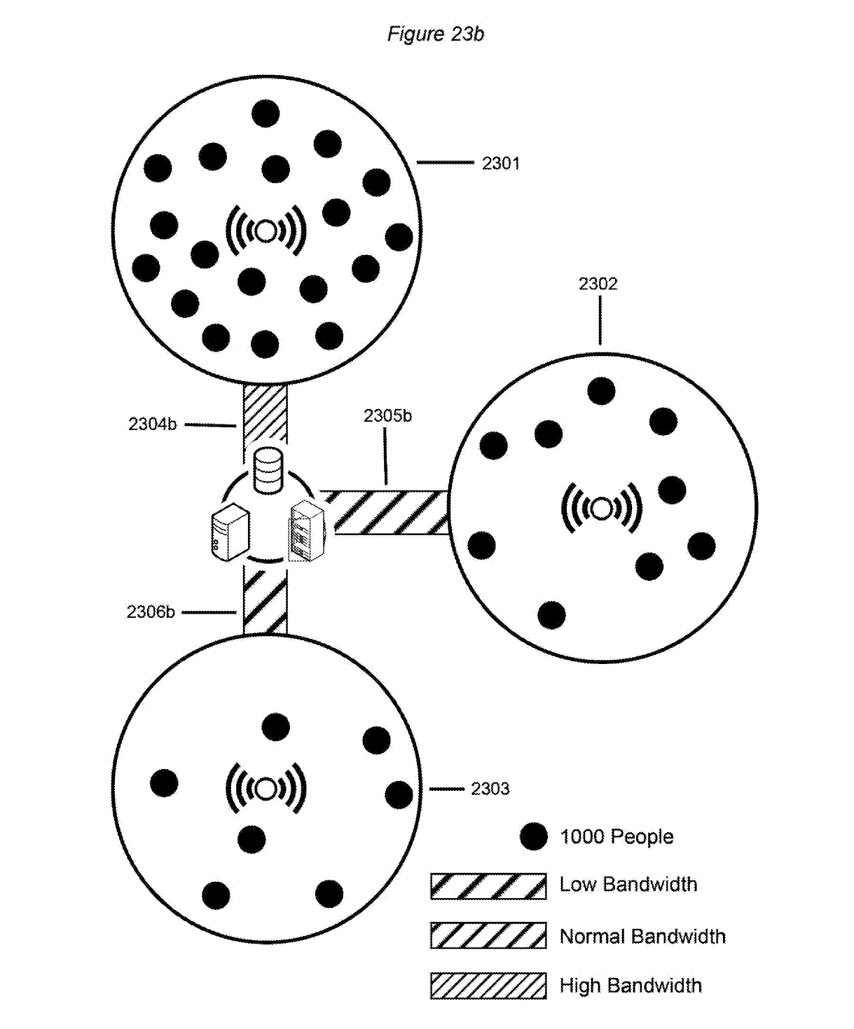

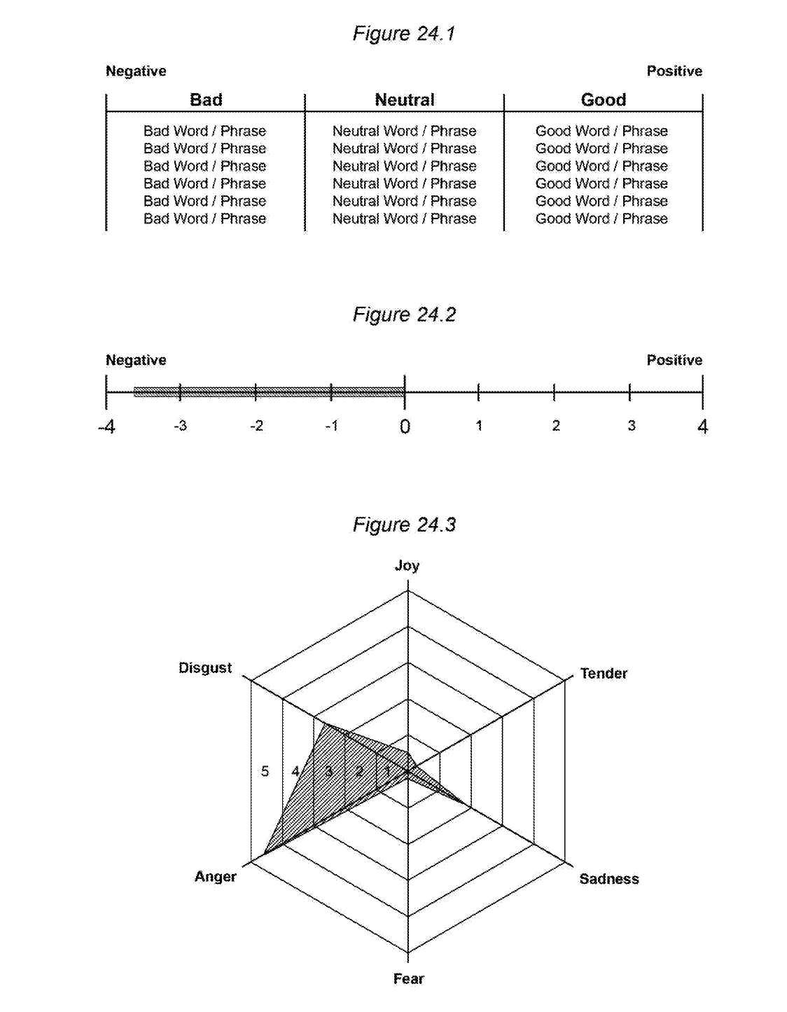

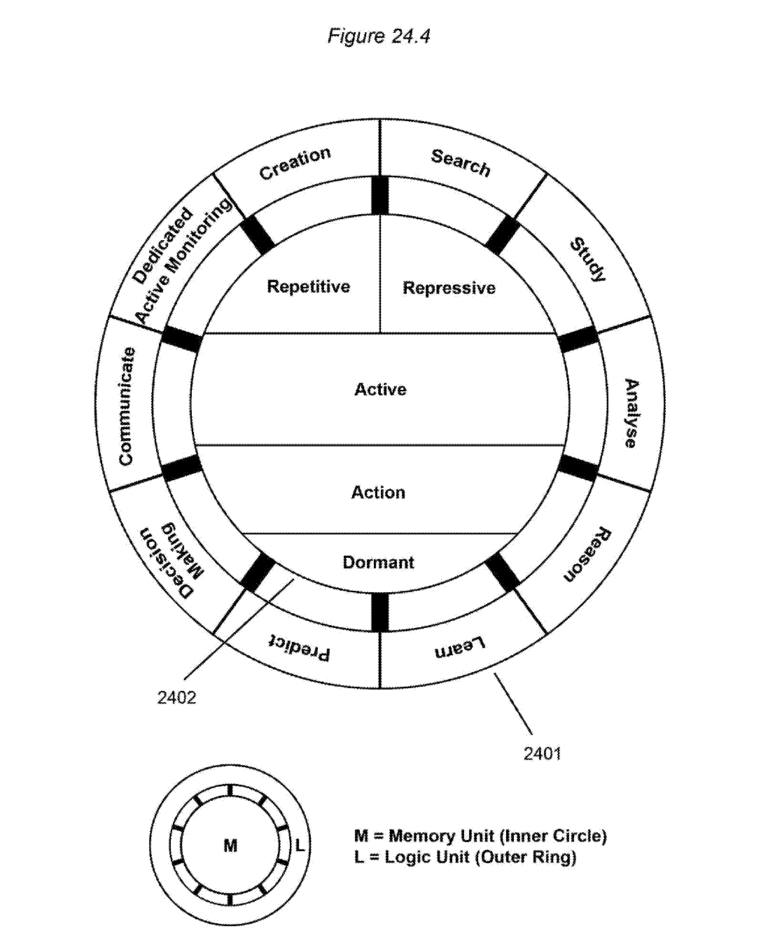

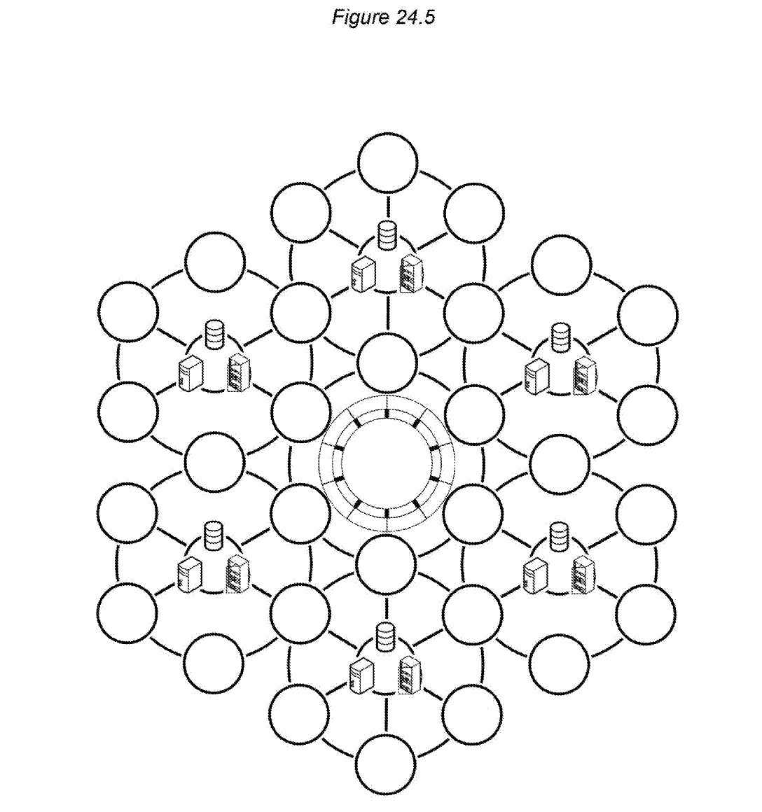

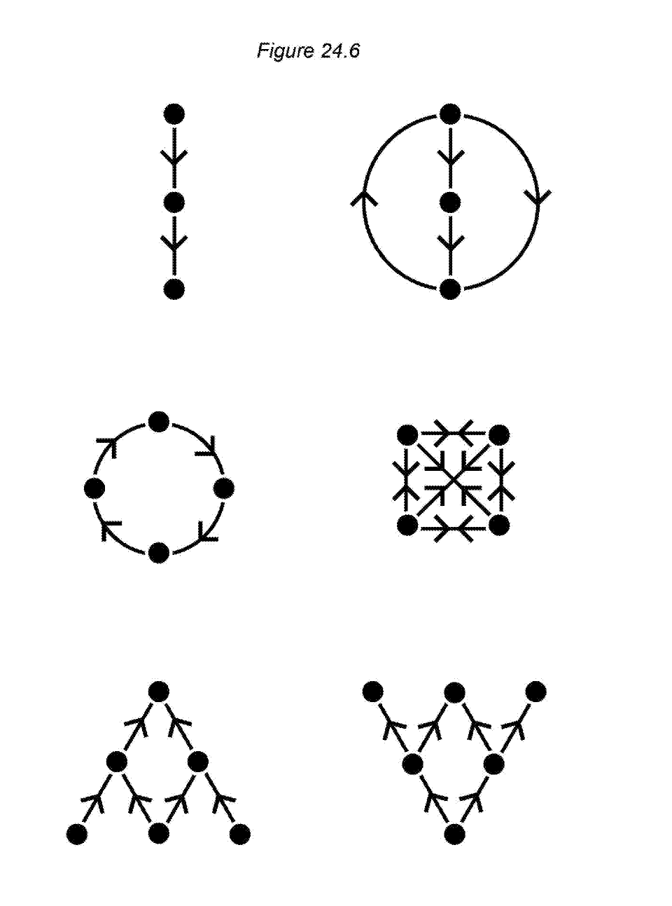

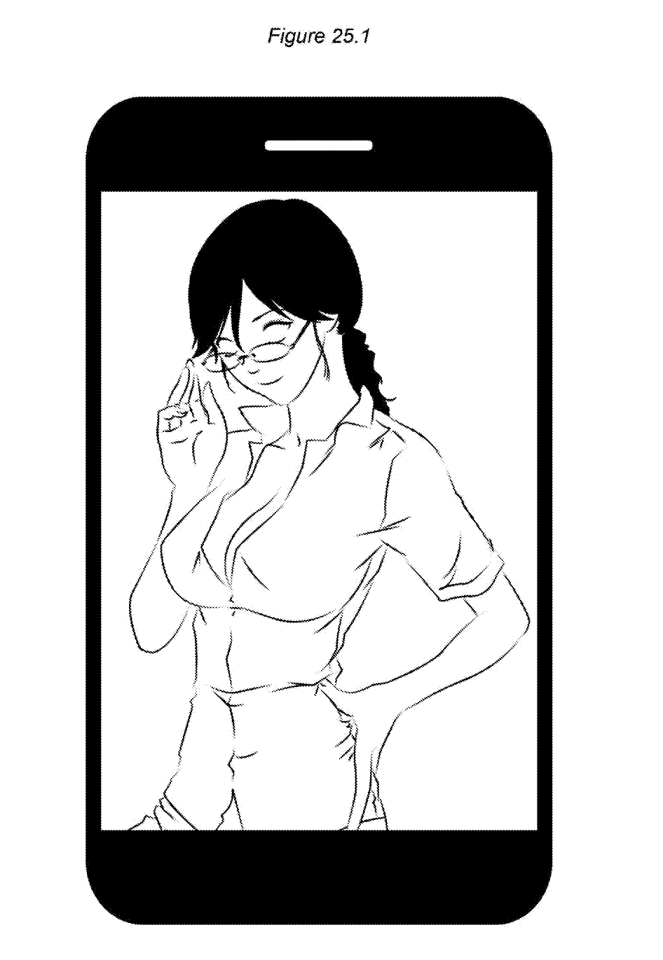

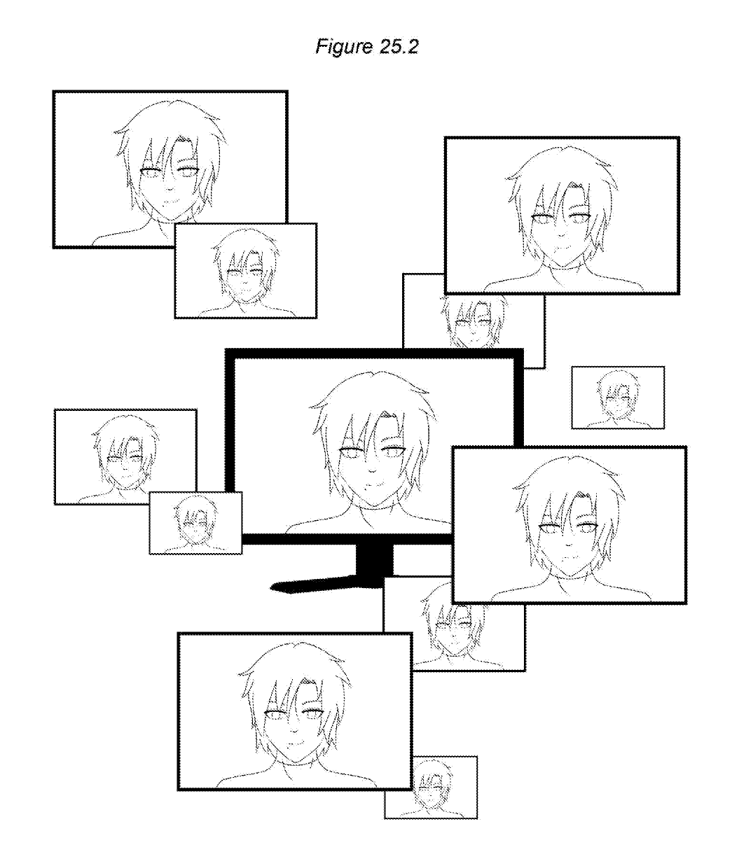

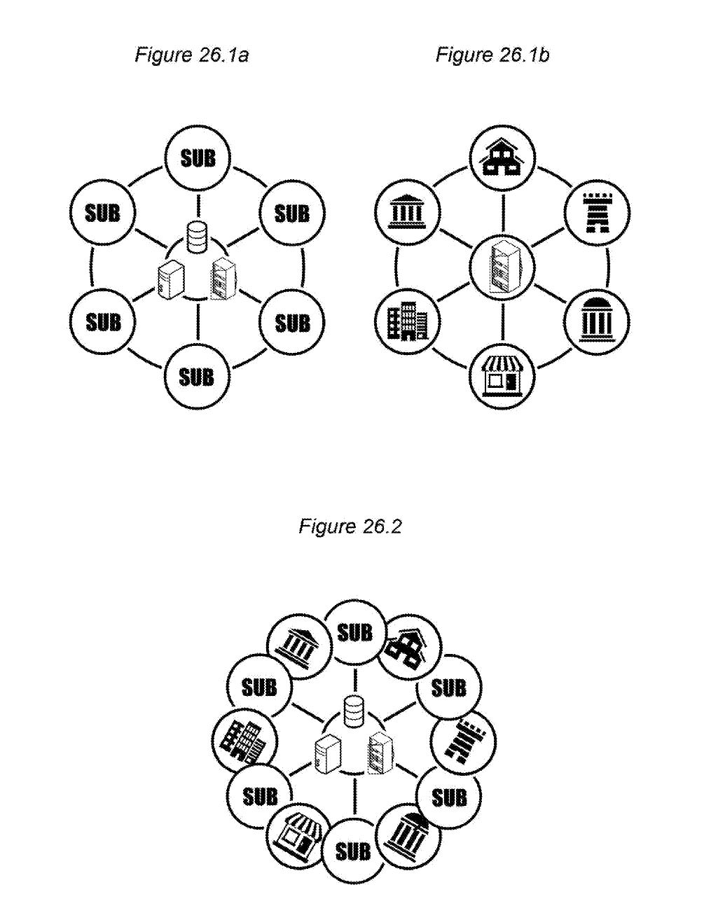

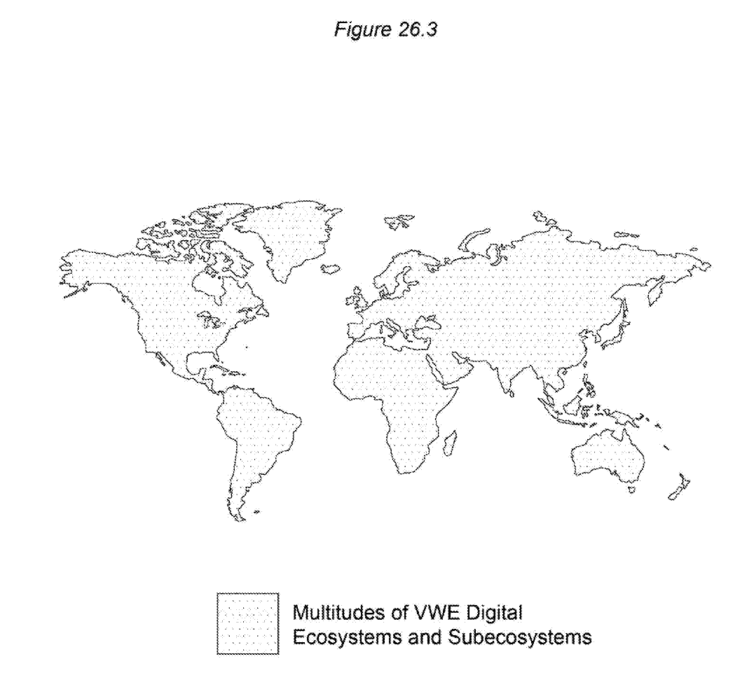

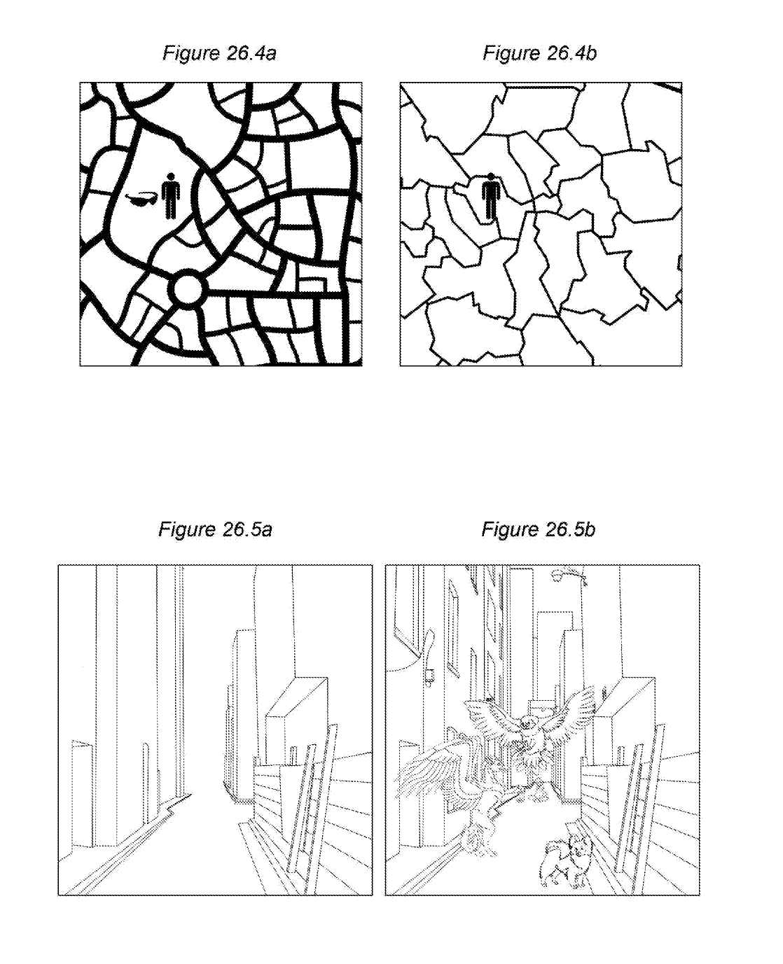

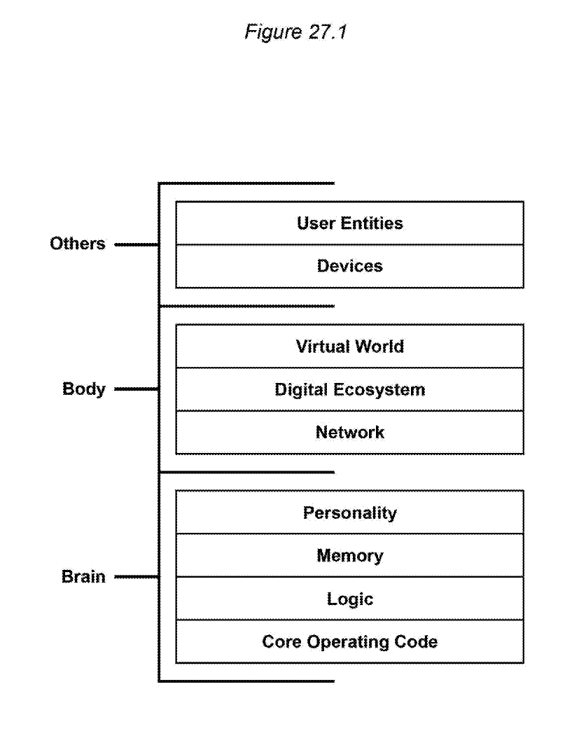

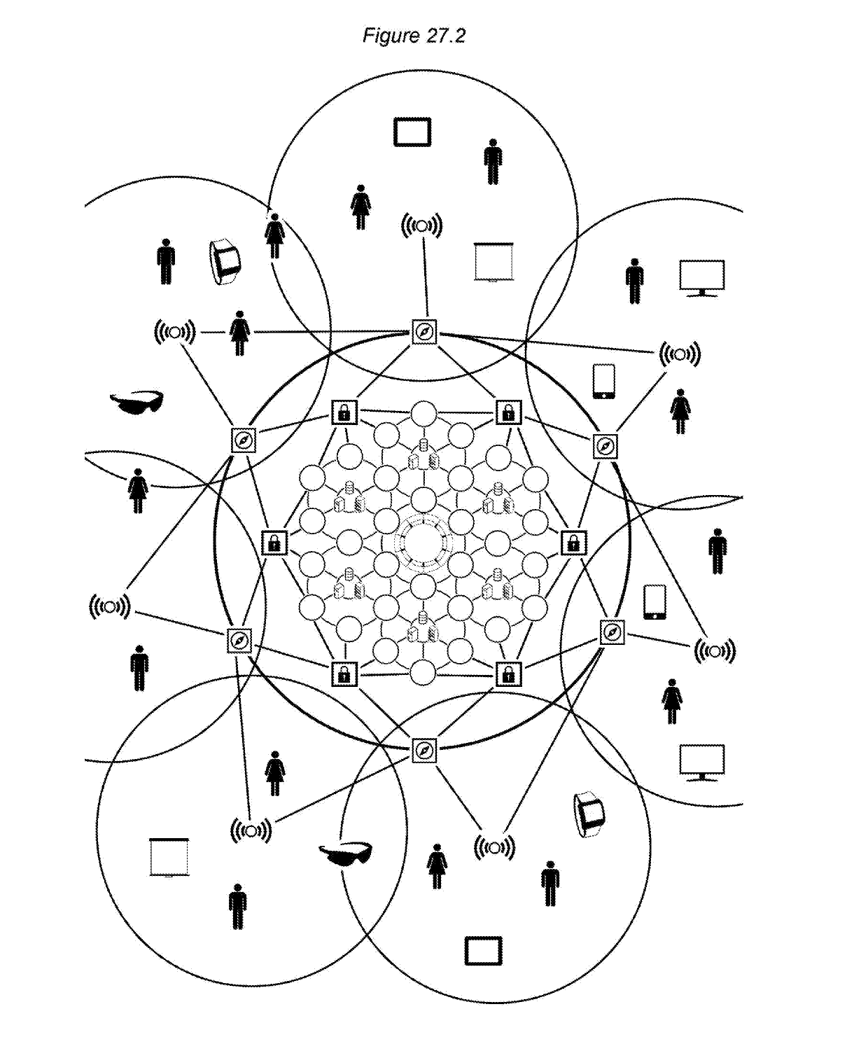

In some embodiments, one or more of the following are used as part of an ecosystem network: a user device, an ecosystem client, an ecosystem, a processing computer, a database, a media server, a digital screen or a console. FIG. 4.1 is an example to show how users may access the ecosystem and how data may travel through and around the ecosystem. Process 401 involves the user opening a browser or software client on a device designed to access the ecosystem as shown in connection 402. In some embodiments, only one option to access the ecosystem is available. Data published to the ecosystem is sent to a processor via connection 403 which handles and stores the data into designated databases and servers used for storage via connection 404.

Connection 404 is also used by the processor to retrieve data from any servers and databases the system uses for storage. Data may then be sent back to the ecosystem via connection 405 for viewing, interaction and other permissible purposes. In some embodiments, data may be sent directly to user devices or other devices, smart screens, consoles and/or other third party systems and services via connections 406a and 406b. Data sent to the ecosystem may then be sent to smart screens, consoles, user devices and/or other devices connected to the network via connection 407. In some embodiments, smart screens or consoles may stream and/or relay data to user devices and other devices using both methods of wired and wireless connectivity via connection 408. A user device or other device receiving data may also be used to send data to the network, as shown in process 409.

In some embodiments, data may travel along individual paths, depending on the type of information it contains. Before data is sent, specific information is set within its metadata. As it is sent, it travels along the path specifically set or best suited for its type to its destination. This is shown in FIG. 4.2. Within data path 410 are multiple data paths for different types of data to travel along, which is shown in enhanced view 411.

Where FIG. 4.1 shows the flow of data around the network, FIG. 5.1 shows an example of how data may flow around the system itself. In some embodiments, one or more of the following may be used as part of a computer system: an input device, a processing system, a concept engine, a database, an application server, a media server, a mapping engine, a filter system, a mail system, a routing system, a server or a client. Process 501 sends data from the input device to the processing system. When needed, data is stored in and retrieved from a database via process 502 and/or a media server via process 503. In some embodiments, if an application or module is involved with the handling of data or providing functionality for a user, process 504 handles the application server interaction, after which data may be returned to the processing system via process 504 or sent to a client via process 515.

In some embodiments, when data is being sent to a client, it may pass through a zone mapping system via process 505 which controls whether or not the data is eligible for display within the current area in which the receiving client is located. In some embodiments, the data may pass through a filter system via process 506 which controls whether or not the user of the client said data is travelling to wishes to view data with characteristics or metadata properties of the data being sent. In some embodiments, data may be passed to a software client, that may also act as a server, via process 507. Clients that also have the capabilities to act as servers are able to stream data to other devices with client or client/server software via process 508, allowing client devices to create peer-to-peer networks on-the fly, data relays and direct data streams. A user may interact with the data received by the client which may in turn, via process 509, cause the client to send data back to the processing system from the input device.

In some embodiments, with enough data stored in databases or accessible elsewhere, the system, via process 510, can begin to interact with an Artificial Intelligence concept engine designed to analyse data to find trend patterns and make predictions on one or more scales, from local to global and, based on a myriad of option combinations, produce ever-increasingly accurate results. An example of an algorithm method used, including an example of available options, is as follows:
1. Select Examination Parameters
   A. Date Range (Past X Months)
   B. Regions
   C. Language
   D. Location
   E. Categories
   F. Subcategories
   G. Time Period (Day, Week, Month)
2. Select Comparison Parameters
   A. Past Year Count
   B. Future Date Range (Future X Months)
3. Quantities Of:
   A. Search Terms (QoST)
   B. Publications (QoP)
   C. Results (QoR)
   D. Sales Publishers (QoSP)
4. Search Terms
   A. Find Highest Search Hits
      1) Store (QoST) Results
5. Find Publications Matching Results
   A. Find Highest Views
      1) Store (QoP) Results In Publications X List
   B. Find Highest Approval
      1) Store (QoP) Results In Publications X List
   C. Find Highest Sales
      1) Store (QoP) Results In Publications X List
6. Filter Publications X Through Search Term Results
   A. List Results That Contain Any Of The Search Terms
      1) Store (QoR) Publications X Results
7. Publications X Results
   A. List Publishers
      1) For Each Unique Publisher Count Appearances
         A) Store Most Influential List (Highest To Lowest)
   B. List Highest Search Hits Terms
      1) For Each Search Term Count Unique Publication Appearances
         A) Store Most Popular List (Highest To Lowest)
8. Most Influential List
   A. For Each|Within Date Range|List Total Publisher View Values By Time Period
      1) Store View Pattern (Publisher—Appearances—Pattern—Total Views)
         A) Store Pattern And Total Views As Group 1 (Publisher—Appearances—Group 1 [Pattern—Total Views])
9. Most Popular List
   A. For Each|Within Date Range|List Total Search Values By Time Period
      1) Store Search Pattern (Search Term—Appearances—Pattern—Total Searches)
         A) Store Pattern And Total Searches As Group 1 (Search Term—Appearances—Group 1[Pattern—Total Searches])
10. Past Year Count|Date Range|For Each Year
   A. Most Influential|For Each|Get View Pattern
      1) Store Most Influential (Publisher—Appearances—Group 1 [Pattern—Total Views]—Year)
   B. Get Past Most Influential Using Examination Parameters
      1) Store Past Most Influential List
      2) Add Past Most Influential To Most Influential List
         A) Find And Remove Duplicate Entries
   C. Most Popular|For Each|Get Search Pattern
      1) Store Most Influential (Search Term—Appearances—Group 1 [Pattern—Total Searches]—Year)
   D. Get Past Most Popular Using Examination Parameters
      1) Store Past Most Popular List
      2) Add Past Most Popular To Most Popular List
   A) Find And Remove Duplicate Entries
11. Past Year Count|For Each Year
   A. Most Influential|For Each|Within Future Date Range
      1) Get View Pattern
         A) Store View Pattern And Total Views As Group 2 In Most Influential (Publisher—Appearances—Group 1 [Pattern—Total Views]—Group 2 [Pattern—Total Views]—Year)
   B. Most Popular|For Each|Within Future Date Range
      1) Get Search Pattern
         A) Store Search Pattern And Total Searches As Group 2 In Most Popular (Search Term—Appearances—Group 1 [Pattern—Total Searches]—Group 2 [Pattern—Total Searches]—Year)
12. For Current Year
   A. Most Influential|For Each|Group 1 Pattern
      1) Past Years|For Each
         A) Find Similar Group 1 Values Pattern Matches
            i. For Each|Examine Group 2 Patterns
            a. Find Lowest View Count For Each Time Period
            b. Find Highest View Count For Each Time Period
            c. Calculate Average View Count For Each Time Period
            d. Between Each Time Period Calculate Percentage That Experienced Rise
            e. Find Lowest Total
            f. Find Highest Total
            g. Calculate Average Total
            h. Between Totals Calculate Percentage That Experienced Rise
            i. Store All Results
         B) Find Similar Group 1 Difference Pattern Matches
            i. For Each|Examine Group 2 Patterns & Totals
            a. Calculate Percentage Of Time An Overall Rise/Fall Is Experienced At The End Group 2.
            b. Calculate Percentages Of How Significant A Rise/Fall It Was In X % Value Ranges From −100%-100%+(Ex. 10% Value Range Would Be 0-10%, 10%-20% Etc)
            c. Predict The Quality Of The Change That Is Likely To Happen By Grouping Percentage Ranges And Seeing Which Is Largest
            d. Store All Results
   B. Most Popular|For Each|Group 1 Pattern
   1) Past Years|For Each
      A) Find Similar Group 1 Values Pattern Matches
         i. For Each|Examine Group 2 Patterns
            a. Find Lowest View Count For Each Time Period
            b. Find Highest View Count For Each Time Period
            c. Calculate Average View Count For Each Time Period
            d. Between Each Time Period Calculate Percentage That Experienced Rise
            e. Find Lowest Total
            f. Find Highest Total
            g. Calculate Average Total
            h. Between Totals Calculate Percentage That Experienced Rise
            i. Store All Results
         B) Find Similar Group 1 Difference Pattern Matches
            i. For Each|Examine Group 2 Patterns & Totals
            a. Calculate Percentage Of Time An Overall Rise/Fall Is Experienced At The End Group 2.
            b. Calculate Percentages Of How Significant A Rise/Fall It Was In X % Value Ranges From −100%-100%+(Ex. 10% Value Range Would Be 0-10%, 10%-20% Etc)
            c. Predict The Quality Of The Change That Is Likely To Happen By Grouping Percentage Ranges And Seeing Which Is Largest
            d. Store All Results
13. If Sales Exist
   A. For Past Year(S)
      1) Get Past Most Influential List
      2) Get Sales Of Items Released Within Future Date Range
         A) Total Sales Of Items
         B) For Each Publisher Of Past Most Influential Calculate Sales
            i. Sort Highest-Lowest
         C) Calculate Percentage Of Sales (QoSP) Amount Of Publishers Made
         D) Store Results
   B. For Current Year
      1) Get Most Influential
         A) Get Top (QoSP) Amount
         B) Get Sale Items Of Top (QoSP) Amount Of Publishers Set For Release Within Future Date Range
         C) Get Most Popular List
            i. For Each Popular Search Term Count Total Number Of Appearances In Current Year Sale Items Of Top (QoSP) Amount Of Publishers
            ii. Store Results As Trend Predictions (Highest To Lowest By Sale Appearances)
14. Display Results
   A. Top X Amount Current Most Influential (Highest To Lowest)
      1) Trend Patterns
      2) Significance
      3) Predictions
   B. Top X Amount Current Most Searched (Highest To Lowest)
      1) Trend Patterns
      2) Significance
      3) Predictions
   C. Percentage Of Sales From Yesteryear(s) Top (QoSP) Amount Of Publishers Each Year Accounted For
   D. Trend Predictions For Future Date Range

Please note that the above algorithm method is an example of how the system may makes its predictions and determine patterns, and that some of the steps listed may be performed in a different order than stated as well as the inclusion or removal of procedures for other purposes.

In some embodiments, digital letter mail may be sent from a user to other users. Any digital mail submitted to the system is sent from the engine central processing system to the mail system via process 511. Once there, the mail system may contact the database via process 512 to verify any metadata of each mail item against account information held in the database as to establish things such as whether or not the item has been legitimately sent by the entity whose information is stated as the sender of the mail, or to check that the mail is being delivered to the right person at the right address, account or location.

Verified mail is passed to the routing system. The routing information of the each item's metadata is analysed. Routing information is any string, single or multiple lines, which may contain independently identifiable parts, that tells the system which client(s) the mail should be sent to. Some examples of acceptable strings are addresses written in common format, addresses written in a shorthand format and unique client ID routing addresses, examples of which are shown below in respective order:
10 Downing St
London SW1A 2AA
United Kingdom
UK.SW1A2AA.10
RID5124703388345364

In some embodiments, a coordinates system may be used. When a geographic coordinate system is used, such as longitude and latitude, an additional identifier may be included to individualise recipient clients that may appear to occupy the same geographical location, such as within homes of tower block housing, as shown in the example below, where the geographical location is the same but the individual identifier, in this case the final character of each string, is different:
51.503396N-0.127640° W-C
51.503396N-0.127640° W-R
51.503396N-0.127640° W-S

Once analysed, each mail item may then send to its designated recipient client via process 514 where it may be stored in a local database on their receiving device(s) for the recipient user to view at any time. In some embodiments, at different points of the mailing process, such as when the mail item arrives at the mailing system or when it is opened by the recipient user, the mail may be scanned by the system for security purposes. The system may look for keywords or phrases that may be cause of concern, as well as the mentioning of people of interest.

In some embodiments, one or more parts of the system may have or employ a tree-like structure for the data to travel through. FIG. 5.2 is an example of this, showing different levels of the system with different points for data to be processed in some way. The data is set to progress through in one direction, but at the same time it can access one or more parts of a level that is required before moving onto the next, if necessary. In some embodiments, data can skip levels that it does not require.

In some embodiments, as in FIG. 4.2, individual data paths may exist and be used to transfer data around the internal system described in FIG. 5.1, including any parts of the system that may use a tree-like structure as described in FIG. 5.2.

The Zone Mapping system mentioned as a part of FIG. 5.1 via process 505 is shown as an example in FIG. 6 of how areas of map 601 can be designated to control the display of data within that area. Mapped areas 602 and 603, once registered with the mapping system, can be set to display data with certain characteristics or properties only or more prominently, or filter it out altogether by gathering location data of a receiving client and filtering the data being received based on data settings of the area the client is located within. For example, area 602 may be set to make category 1 more prominent by ensuring 6 out of every 10 groups of data received by a client carry the category 1 property, while area 603 may be set to prevent all data containing category 2 as a property from showing. Based on the client location, data filtering can be performed server, client or both.

FIG. 7.1 is an example of how data may be presented when viewed by a user and how the view count of data may increase. Example smart device 701 shows an example of how data may look when it is initially open by a user, with its view count stating a specific number. In some embodiments, after a timed delay the view count updates to register the current view of the viewing user. In some embodiments, the view count is updated immediately. The view count, when updated to include the current view, updates on the server, but may also update the data on the user's device screen, as shown on the screen of example smart device 702 where we can see the view count has increased from 1,000,000 to 1,000,001.

In some embodiments, on screen information may be communicated to a user through audio methods. In FIG. 7.2, vision-impaired person 705 is able to know what data is being displayed on example smart device screen 703 via audio process 704 which may allow an audio description of the content to be played or the reading aloud of on-screen text using text-to-speech technology. Please note that the position of audio icon 704 does not denote the position on the device that sound is coming from, only that sound is being played aloud by the device.

In some embodiments, rather than having to open an application to see data, users may have data displayed directly on a home screen or main interface of a smart device. On the screen of example smart device 801 of FIG. 8.1 is an example of a GUI widget application that allows data tailored to a user's interests to be displayed on a home screen of a smart device. 802 is the display of information of the user account currently accessing the ecosystem on the user device. This may or may not be displayed in all embodiments. In some embodiments, a list of data containing characteristics and properties relating to the interests of the user account accessing the network is displayed, as shown in figure point 803. 804 is a page indicator—a common feature of applications that use multiple screens or pages, but this feature is not essential for the application to operate correctly and may not be present in some embodiments. In some embodiments, rather than lists of data, a single group or piece of data may be shown on screen as a full or partial display as shown at figure point 805 of FIG. 8.2.

In some embodiments, the system is able to register views and/or interact with users through the use of display screens, eye-tracking technology and sensors, as shown in FIG. 9.1. Eye-tracking technology of display screen 901 is given an area of which is considered a reasonable distance for people to be able to see and register what is displayed on screen, shown by reasonable viewing range 902. In FIG. 9.1, three examples are given of how the system may decide whether or not to register a view of what's displayed on screen:
Person 903 is within reasonable viewing range 902 of digital screen 901 and digital screen 901 is within the field-of-view of person 903 but the point-of-gaze of person 903 is not directed at digital screen 901, therefore the eye-tracking software would determine person 903 couldn't pay enough attention to digital screen 901 and wouldn't register a view with the system.
Person 904 is within reasonable viewing range 902 of digital screen 901 and digital screen 901 is within the field-of-view of person 904. The point-of-gaze of person 904 is directed at digital screen 901 meaning the eye-tracking software would determine it is probable that person 904 did look at or pay enough attention to digital screen 901 and would therefore register a view with the system.
Digital screen 901 is within the extended field-of-view of Person 905, and the point-of-gaze of Person 905 is directed at digital screen 901, but Person 905 is not within reasonable viewing range 902 of digital screen 901, so although the eye-tracking software may be able to track the eye movement of Person 905, it wouldn't register a view with the system.

Also in FIG. 9.1 is an example of how the system may provide a personal interaction service for nearby users of the environment. Sensors of digital screen 906 have an area of which is considered reasonable for it to interact with nearby users of the environment, as shown by reasonable sensor range 907. When a user device connected to the environment enters reasonable sensor range 907, the sensors may detect its presence, wirelessly pull information from the signed in account of the user device and then personally interact with the user, communicating verbally using voice and speech technology, using on screen text, using virtual people and characters on-screen, and/or by displaying data related to interests of the user account the system is communicating with. FIG. 9.1 gives two examples of how the system may operate to determine whether or not it is within reason to begin interacting with passersby:
Person 908 is within reasonable sensor range 907 of digital screen 906, digital screen 906 falls within the field-of-view of person 908 and person 908's point-of-gaze is directed at digital screen 906, so the system may determine that it is within reason to begin interaction with person 908.
Person 909 is within reasonable sensor range 907 of digital screen 906 but digital screen 906 doesn't fall within the field-of-view of person 909 and the point-of-gaze of person 909 isn't directed at digital screen 906, so the system may determine that it isn't within reason to begin interaction with person 909.

The system may also determine whether or not it is reasonable to interact with a passing user based on whether or not the user stops or slows down within a reasonable sensor range.

What is considered “reasonable” when referring to viewing ranges and sensor ranges may be decided by the manufacturer, governor, operator, user or AI of a display screen and/or sensor, and may be done completely at their discretion.

In some embodiments, systems and/or devices may detect the presence of one another when within a certain proximity and cross-reference account information of users signed in. Personal sensor area 910 may be generated by a smart device of person 905. The sensor of a smart device of person 905 is able to detect the presence of other personal smart devices within personal sensor area 910, such as the smart device of person 904. Should the system of a smart device of person 905 determine that person 904 is a person of interest to person 905, a smart device of one or each person may alert the person to the fact the other may be a person of interest or person who is interested. For example, should person 905 need help with a task and they published data on their system account requesting help, their sensor, having detected the presence of person 904 and their smart device, can be used in conjunction with accompanying software on the device to pull and analyse the details of the user account signed in on the smart device of person 904 and, if it is read that the owner or operator of the user account of the smart device of person 904 offers services or has skills that can help person 905 accomplish the aforementioned task, it may alert person 904, person 905 or both individuals of the fact that they may be of interest to each other.

In some embodiments, to more accurately determine which person, device(s) and information go together when wanting, beginning or during interaction with a user, sensors may be used in conjunction with cameras and/or other hardware or software to pinpoint the location of said device(s), read information and data from the account signed in on said device and find and track the person(s) of whom are most likely in possession of a device that is communicating with a sensor.

In FIG. 9.2a, a group of people are in front and within the scope of camera/sensor device (CSD) 911. In the group, person 913 has on them smart device 912. FIG. 9.2b shows FIG. 9.2a from a side angle. When CSD 911 senses and communicates with smart device 912, it may read the account information of the user signed in. The sensor of CSD 911 may be able to pinpoint the location and distance of smart device 912 and then the range finder/detector may be used in the direction of smart device 912 to determine if the person or object attempting interaction is a distance away equal or close enough to the distance of the smart device detected by the sensor. If so, the system may then interact with the person or object. In some embodiments, if multiple people or objects are close together, especially if the device is located between multiple objects or people, CSD 911 may be used to help determine who is in possession of the device by analysing properties such as light, shadow, foreground and background. In some embodiments, if a user has uploaded a photo verification image of themselves to their account, CSD 911 may use facial recognition capabilities to determine whether or not the person or object it is interacting with is the owner of the account or someone who has been given access to the account before interaction begins based on data being read from the account.

In some embodiments, sensors may be used by the system to control the flow of data within a given space. FIG. 10 shows one way in which the system may use sensors to control data displayed within a space owned or operated by an entity. By setting up a sensor system connected to the ecosystem and a network account, the owner or operator of the space and area covered by the sensors is able to control what data can be heard or viewed within the area of the sensors, for example, restricting the data audible or viewable within the sensor area to that of data only published and/or supplied by the owner or operator of the area in which the sensors are in operation and are able to cover. Sensors need to be connected to a sensor control system which is connected to the network, allowing it to access data on the system and the user account of the owning or operating user.

In the example shown in FIG. 10, sensors 1002a, 1002b, 1002c, 1002d and 1002e are connected to sensor control 1001 and are therefore under the influence of said sensor control and any restrictions and conditions the operating user of the control may have set. Each sensor has its own sensor area—sensor 1002a and sensor area 1003a, 1002b and sensor area 1003b, 1002c and sensor area 1003c, 1002d and sensor area 1003d and 1002e and sensor area 1003e. Unless exceptions are set, all client software follows the rules set by the sensor controls when it comes to downloading and/or viewing data. Assuming no exceptions are set, persons 1004a, 1004b and 1004c are all within the controlled sensor areas and are there subject to all restrictions and conditions imposed. Person 1004d, however, is standing outside the range of all sensors and therefore won't be subjected to any restrictions imposed by the sensors.

In some embodiments, clients or client/servers of smart devices are able to relay incoming data streams to the clients of other devices by creating exact copies of data as it is received and then immediately broadcasting to a recipient over one of more types of transfer protocols that support real-time or near real-time data streaming or via close proximity networking, such as PANs and LANs, that use wireless technologies such as Bluetooth and Wi-Fi, as well as wired technologies to connect clients and share data. Doing so allows persons who do not have AR capable hardware to view augmented versions of reality, despite the lack of support on their device.

FIG. 11 demonstrates Augmented Reality data being streamed to a smart device and then relayed to other devices. Smart screen 1101 is an Augmented Reality marked smart screen. When example smart device 1102 is held up facing smart screen 1101, it acts as an Augmented Reality viewer and begins to stream the Augmented Reality data attached to what is visible on the smart screen. Example smart device 1102 establishes a connection with example smart device 1103, which doesn't naturally support Augmented Reality. Example smart device 1102, as it receives data from smart screen 1101, begins to create an exact copy of the incoming data stream and wirelessly streams it to example smart device 1103. In some embodiments, wired methods of data transmission may be used. Example smart device 1103 is now able to view/play the incoming data stream. Example smart device 1103 can establish a connection with example smart device 1104 and then copy and stream the data it is receiving from example smart device 1102 to example smart device 1104.

In some embodiments, certain smart devices are able to be assigned to a user account, allowing the owner of said account to control exactly what is displayed on that device client remotely. This is achieved by creating a relationship between a user account and a unique identifier of a device. The unique identifier can be fixed, where the device or client is assigned a permanent unique identifier or dynamic, where a device or client is given an identifier which may or may not be changeable or removed at later times, based on factors such as location, the order in which it is assigned, the user account it is being assigned to and more. Once a relationship has been established, one or more of the following are possible:
The account owner can push data from their account to an assigned device/client.
The device/client can pull data from the account it is assigned to.

In some embodiments, an account owner may give permission to other accounts to control the display of data on one or more of their devices/clients. In some embodiments, this may also allow the device/client to pull account data from all other permissible accounts other than that of the owner of the client device.

FIGS. 12.1-12.4 provide an example of connecting a smart screen to a user account. In FIG. 12.1, a new user account is created and a new smart screen client is activated. Information for each is passed to the database server and placed into the corresponding individual database. In FIG. 12.2, a smart screen is assigned to a user account, creating a relationship between the two. FIG. 12.3 shows how content approved by the account a smart screen is assigned to may be sent to the smart screen and FIG. 12.4 is a visual depiction of the start and end of the process shown in FIG. 12.3, where content the user has approved on their smart device is now being displayed on the client of a smart screen assigned to their account. In some embodiments, smart screen clients may be dissociated from a user account, at which point it can be reassigned to an account by repeating the process of FIG. 12.2. In some embodiments, smart screen clients may not be reassigned.

In some embodiments, digital stationery may be connected to a user account of the system, allowing data on the stationary to be modified or changed remotely via a wireless connection. FIGS. 12.5-12.7 provide an example of connecting the client of digital smart stationery to a user account. As FIG. 12.2 shows a smart screen client being assigned to a user account, FIG. 12.5 shows the client of digital smart stationery being assigned to a user account. In FIG. 12.6, a blank piece of digital smart stationery, represented by FIG. A, is shown connecting to the database server and accessing the user account it is connected to in order to retrieve information regarding what it is to display. FIG. B of FIG. 12.7 is an example of what the digital smart stationery may look like after information such as display text, images and layout positioning have been downloaded and is being displayed. In some embodiments, digital smart stationery clients may be dissociated from a user account, at which point, in some embodiments, it may be reassigned to an account by repeating the process of FIG. 12.5. Updating the data of the digital smart stationery requires the process of FIG. 12.6 to be run again, but in some embodiments it may also include a process which has checks to see if there has been any changes to the data being downloaded before or during download, to decide which data, if any, should be downloaded.

In some embodiments, the system itself, from within and/or outside of the ecosystem, is able to handle payment transactions internally and/or using third-party payment systems. There are multiple ways to initiate a transaction, the most common being:
Data views—When data is viewed through use of a smart device or a view is registered through eye-tracking technology.
Data Impression—The appearance of data, usually in significant places.
User Transaction—User-initiated payment processes such as the purchasing of an item or the transferring of funds.

How the payment system handles the movement of funds is based on how a paying user wishes it to. In some embodiments, if a user has chosen to add funds to their system account, the system checks the amount of funds they have deposited in an escrow account and decides if the transaction should be approved or denied based on whether or not the amount of current funds the user has is greater than the cost of the transaction. In some embodiments, if the user has chosen to use a third-party to process the transaction, information about the transaction is passed to the third-party system and the response is then evaluated by the payment system. At the end of a payment check, the system either completes the transaction if it is successful and transfer the funds to the account of the payee before alerting both the payer and payee of the successful transaction or produces an error to the payer if the transaction is unsuccessful.

FIG. 13 shows an example of how the payment process works. Once a transaction is initiated, information about the transaction, such as the paying user and the payment amount, is sent to the engine central processing system via process 1301. The processing system uses the information passed to it to identify the account of the paying user and then locates their account via processes 1302 and 1303 before passing account and transaction information to the payment system via process 1304. Depending on the account information, the payment system handles the transaction one of two ways. If the user has chosen to pay using funds held in escrow, via process 1305 the payment system checks the paying user's current funds against the price of the transaction and waits for a response. If the user has chosen to pay using a third-party payment system, transaction information is passed to the third-party system via process 1306 and waits for a response. After process 1305 or 1306, when a response is received the payment system takes the appropriate action. If there is an error with the payment for any reason, the system notifies the payer that the transaction has produced an error via process 1307. If the payment is successful, the payment system notifies both the payee and payer that there has been a successful transaction via processes 1308 and 1309. The system may notify the payer and payee in any order.

In some embodiments, native applications can be partially or completely updated while running in the background, while in use and/or just as long as it is installed on a device. To allow designers and developers the same level of freedom that those who operate in the area of web systems are accustomed to when creating, arranging and updating systems, applications, content and templates of web documents and websites while achieving the performance of purely native applications that those operating in the area of native application and software development and engineering are accustomed to, the system may incorporate an application engine that is able to receive code from a server and, if necessary, translate said code into a native language the receiving device can understand, to create native components such as objects, properties, classes, actions and functions calls on the fly.

Application designers, developers and other users can create templates that include both functions and visual materials, either visually or written in code, that are stored on a server as code. If template code isn't written or stored as native programming language, it may be done in a scripting or markup language. In some embodiments, the scripting or markup language used may contain elements that are to be translated into native objects. In some embodiments, it may contain variables and properties that contain values which, when translated, help the engine construct the user interface and engineer the user experience as it was intended by the designer or developer.

In some embodiments, a set of instructions for the engine to follow may also be included in a file or database, either of which may be stored locally on a device or remotely, or written in code as part of the application, engine or software of the device. Instructions may pertain to operations such as which template to use with different sets or types of data being displayed, default options, user interface elements and more.

In some embodiments, as well as templates and instructions, other elements of an application may be controlled remotely. For example, a menu may be controlled remotely by storing menu items and related information for each, such as the icon to display and location of the information it is to point to, in a file or database.

In some embodiments, when an application is run, it or the engine may connect to a designated server to download any data that hasn't already been installed or stored locally that is necessary to make the application operable or that the application designer, developer or owner has instructed the application to download, such as code required to complete the building of the user interface that may not be dependent on content data, data to populate a menu or instructions for app behaviour, such as the default window to display, after which the compilation of the application is complete. Layout templates may also be downloaded at this point in anticipation of displaying content data. The downloaded data may be stored locally to prevent the need to download the data every time the application is run. In some embodiments, the application or engine may check for updated versions of files and download them if necessary or desired by the user of the device or application when it is run.

In some embodiments, when the application begins downloading content, the engine may also download template code if required. Template code may be downloaded in multiple ways, including:
Downloading template code as individual code sets along with content data separately;
Downloading content data pre-wrapped in template code.

If template code is downloaded as individual code sets or is already stored locally, the engine compiles the correct template, if the template hasn't already been pre-compiled, for each set of data it is to display based on the instructions set by the app developer or designer and then renders the template on screen, inserting the content data into a specified place to create a user interface for a user to interact with.

If data is downloaded from a server pre-wrapped in template code, the server may wrap the content data in template code after the data is requested or store content data in a database already wrapped in template code, based on the template set to be used to display that type of content. Once downloaded, the engine can compile the code locally to create a user interface for a user to interact with.

In some embodiments, the engine is able to download template code and content data in anticipation of the user wishing to view it, and may compile it in the background without ever disturbing the user of the application or software. This can be achieved in multiple ways, including but not limited to:
Directory Listings—In some embodiments, the operator, developer or designer of an application can set a directory, file or database of data for the engine to pre-download, along with its set template code, and compile immediately and automatically, meaning there is no loading delay when navigating to and between these content sets.
Data Lists—In some embodiments, when data lists are downloaded, such as those generated by URLs or queries of data types, keywords or other data, the engine may download template code associated with each item of the list and compile it in the background so that it is ready to be viewed with no loading time should a user select that item.

In some embodiments, to help preserve memory of the device, the engine is able to automatically decompile and/or destroy template views that are ready and waiting when out of a set range of where the user currently is. For example, when viewing a data list, the furthest behind compiled template view of all currently compiled template views of the current list may be decompiled or destroyed when the engine senses it is a certain item-distance or measurement offset away from a user's current item position, while at the same time compiling template code for items that the engine senses has now come within a set item-distance or measurement offset of a user's current item position. In some embodiments, this may also be applied when viewing single content items if a user is able to navigate between data items without returning to the data list.

In some embodiments, data that requires downloading that a user, developer or designer is able to update remotely may contain a property or variable value that the application or engine may cross-reference against the same property or variable stored locally to determine whether or not data held locally is outdated and should be updated, ensuring the latest templates and functionality are always used and/or made available.

FIGS. 14.1 to 14.8 show an example of template code that can be downloaded from a remote server and translated into a user interface and experience on a local smart device. FIGS. 14.1 and 14.2 are two examples of markup code containing data that can be written and stored on the server. Both contain elements, properties and values that the engine is to read and translate into native user interfaces and experiences.

In FIG. 14.3, template code written by or generated on behalf of a user is stored in the corresponding database for that template based on its intended use. In some embodiments, template code may be stored in a single database. FIG. 14.4 shows how the template code may be passed from the server to a client device where the engine creates a native user interface and experience based on the template code received. Once created, the interface(s) may be automatically displayed or held off-screen until needed or requested.

FIG. 14.5 is an example of what the template code of FIG. 14.1 may look like when compiled and displayed. The user interface created includes the content that was to be displayed with the template code used. As well as the layout code of the template code, instructions for the user experience were also included. When hand 1402 makes a specific gesture towards specific elements of interface 1401 that have been designed to respond to gestures, such as a “click’ gesture, the interface responds according to the user experience instruction set within the template code. FIG. 14.6 is an example of this, where the current template interface has been instructed to slide off-screen to the left as it reveals a new template interface which is sliding in from the right edge of the screen. FIG. 14.7 is an example of what the template code of FIG. 14.2 may look like when compiled and displayed, as well as being the interface shown sliding into view in FIG. 14.6.

FIG. 14.8 is an example of an instructions or manifest file that the engine can use to determine how it should handle different types of data, what templates it should use, the default settings of the application, cache size and more. Despite what is shown in this figure, manifest or instruction files may contain more or less settings or instructions, and they may also differ from what is shown.

The ecosystem may be divided into smaller ecosystems for different purposes. In some embodiments, a main ecosystem may be divided into sections or sectors in order to create sub-ecosystems. In some embodiments, the purposes of digital sub-ecosystems may differ from one sub-ecosystem to another, such as one created for the promotion of a certain industry sector while another is created to facilitate specific services.

With the inclusion of sub-ecosystems, data may travel between elements of the ecosystem in multiple ways, including but not limited to:
Smart device to sub-ecosystem;
Sub-ecosystem to sub-ecosystem;
Sub-ecosystem to central system;
Smart device to central system;
Smart device to smart device.

In some embodiments, users may be able to affiliate themselves with one or more sub-ecosystems.

FIG. 15.1 is an example of the existence of digital sub-ecosystems within a digital ecosystem. In some embodiments, central system 1501 is the core of the ecosystem through which all elements of the ecosystem must be connected, directly or indirectly. 1502a, 1502b and 1502c are all sub-ecosystems that help make up part or all of the ecosystem and 1503a, 1503b and 1503c are the users with their smart devices that help make up and drive the ecosystem. In this example, all elements that help make up the ecosystem are interconnected harmoniously. In some embodiments, not all elements may be able to connect to each other in such a manner, if at all.

In some embodiments, with the interconnectivity of sub-ecosystems and the ability to share data between them, entire ecosystems can link together and effortlessly expand and contract indefinitely by adding or removing central systems and/or sub-ecosystems, as shown in FIG. 15.2.

In some embodiments, master/slave relationships may exist between central systems. In some embodiments, all central systems may be slaves to a master system. In some embodiments, as central systems may store data and information that doesn't or may not require updating by a master system, only specific parts may be set to update, such as the core operating code or software.

With a universal ecosystem, data protection is of the utmost importance. In some embodiments, a unique device and/or client ID may be assigned to specific user accounts. Once registered a device and/or client is tied to the account it is assigned to. In some embodiments, a client and/or device ID may be assigned to multiple accounts. In some embodiments, clients and/or devices may be unassigned from an account. In some embodiments, a device and/or client may be reassigned to an account with or without first being unassigned.

When a client and/or device ID has been assigned to an account, data transmission is possible to and from the client device based on the account it is assigned to. In some embodiments, some data, when transmitted from client device to server or vice versa, is encrypted based on the client and/or device ID that is requesting and/or receiving the data. Because every client and/or device ID is unique, encrypted data may only be decrypted by the client and/or device with the correct ID(s) and by a central system with access to the accounts database and necessary security information, where it is able to calculate the correct encryption key based on the client and/or device ID associated with the account receiving the data. Should more than one ID be registered to an account, along with the encrypted data may be a hint, which may be unencrypted or encrypted using a general algorithm rather than a specific one, which can be decrypted by the client or server for it to ascertain which client and/or device ID it should use to generate the encryption key for the rest of the data. Types of hints may include, but is not limited to:
A selection of characters from different positions of the ID required for decryption;
The character length of the ID;
Metadata about the encryption key such as the date it was assigned.

In some embodiments, more than one hint may be included.

In some embodiments, biometric data may be used as a key to encrypt and decrypt data, making it entirely unique to the user. In these instances, a user would need to physical verify themselves once data is received for it to be decrypted.

In some embodiments, a security system may be in place at any point between the client device and a central system to authenticate connections and requests. In some embodiments, the security system may prevent a client device and central system from having a direct connection. When the security system picks up an incoming connection, it may hold that connection, extract the encrypted data and then transmit it along a different connection to the central system. When data is returned from the central system, it may pass back through the security system so the response can be authenticated. If the response is authentic and permission has been given to pass data back to the client device, the security system may do so along the original connection. If the response cannot be authenticated or there is an error, an error response may be returned to the client device. In some embodiments, if a security system, at any stage of the data transmission process, detects that a request may false or fake, that data has been tampered with during transmission, data isn't encrypted, data isn't in an appropriate format, too many connections are incoming from an individual client within a given amount of time or any other issue relating to the connection or data that it has not been instructed to expect or, through the use of artificial intelligence, deems is too unusual, it may send a kill signal to the client device, immediately terminating the connection and, in some embodiments, destroying the data in transmission. In some embodiments, the kill signal may disable the client and/or its engine on the device, either temporarily or permanently.

In some embodiments, data may be required to be submitted in a universal format for the security system to handle. In some embodiments, data that does not use this format may be rejected.

In some embodiments, only specific system computer terminals directly connected to a central system are able to add, manipulate and delete data stored while in its unencrypted form, as well as make changes to the system itself. In some embodiments, a security system may be present between the terminal and central system to authenticate connections and requests and may also authenticate any other actions performed by the terminal.

FIG. 16.1 shows a unique device/client ID being assigned to a user account. FIG. 16.2 shows two data transmission processes. Smart device 1601 transmits data over wireless connection 1602 where it is received by security system 1603. Having authenticated the connection, the security system extracts and transmits the data over hard line connection 1604 where it is received by central system 1605. The central system's response is sent along hard line connection 1606 back to security system 1603 where it may be authenticated before it is passed back to smart device 1601 along wireless connection 1607.

1608-1614 illustrates a similar process but one involving a kill signal. If smart device 1608 transmits false data or tries to establish an illicit connection with security system 1610 along wireless connection 1609, the security system may immediately send a kill signal along wireless connection 1614. Should the security system extract the data of the connection as it does with authorized connections, the data is transmitted along hard line connection 1611 to central system 1612. The central system, recognising that the data it has received is false, sends instructions to security system 1610 along hard line connection 1613 to immediately terminate the connection from smart device 1608, which the security system does via wireless connection 1614.

In some embodiments, wireless and hard line connections 1602, 1604, 1606, 1607, 1609, 1611, 1613 and 1614 may be may be replaced by their opposites. There may also be other systems and/or points of interception along different points of any of these connections.

System terminal 1615 is able to connect directly to central system 1605. A security system is in place between system terminal 1615 and central system 1612 to authenticate any or all actions performed by system terminal 1615.

In some embodiments, data may be timestamped. Data may be timestamped at different points in time, such as:
At the start of transfer;
When arriving at a security system;
When departing from a security system;
When arriving at a central system; or
When departing from a central system.

The system may use data timestamps for different purposes, including but not limited to:
Recording the transmission of data; and
Encrypting and decrypting data.

In some embodiments, users of the ecosystem can enjoy an experience of the real world tailored to exactly what they like and want to see. In some embodiments, regardless of what object any user is looking at, if that object is capable of transmitting different groups of data simultaneously to different users, it may display and transmit data to each user that best fits what that user enjoys, based on account settings and information the system has gathered.

FIG. 17 depicts 4 users—1701a, 1701b, 1701c and 1701d viewing the same object, 1703, which is a representation of the world, from a different perspective, each through their own device viewport as shown by 1702a, 1702b, 1702c and 1702d. Each user, although all looking at object 1703, sees it in a completely different way from their view point.

In some embodiments, being able to enjoy their own tailored personal experience, a user is also able to share as much or as little of said experience with other people of their choice as they wish without it being an obligation. In some embodiments, two-way sharing isn't mandatory and a user can share with another user without being obligated to allow the other user to share with them. In some embodiments, this is done by separating your “personal experience layer” and “social experience layer”. In an embodiment using a layer separate from the personal experience layer for social experiences, a user may permit data individually, in groups or as a whole to be socially accessible. They may also select which users are able to view what they share. In some embodiments, a user may also select where, if they so choose, to publicly display their experience and/or which public display devices are permitted to display the data. In embodiments using the same layer for personal and social experiences, users may be afforded the same level of control over their data. In some embodiments, users can link their accounts to synchronise their experiences, either partially or completely.

In FIG. 18.1, person 1801, accessing their personal experience layer 1802, has allowed their data to be passed to social experience layer 1804 by giving permission 1803 in order to remove the restriction. When removing the restriction, person 1801 gives permission to any of persons B-Z that they have selected to view the data shared and/or public display devices 1806, if selected, to display the data shared.

FIG. 18.2 shows 2 users enjoying their own individual personal experiences. In FIG. 18.3, one user has shared some of their data with another. FIG. 18.4 shows two users who have both chosen to share data with each other. FIG. 18.5 shows two users who have chosen to synchronise their accounts. Each user can still enjoy their own experience separate from the joint experience stream of data available.

In some embodiments, using some or all of the aforementioned embodiments, a sensor-based telecommunications network may be formed using any/all of the following, including but not limited to: smart devices, servers, storage devices, databases, optical networking technologies, wireless networking technologies, electronic networking technologies, sensors capable of handling connections to and/or from smart devices, sensors capable of sending and/or receiving data to and/or from smart devices, sensors capable of controlling data within their area of coverage, smart device software engines, client devices with unique IDs where the uniqueness of an ID may or may not be relative to specific factors, data security and verification systems and data encryption systems.

Sensors are connected to central systems via hard line connections. In some embodiments, sensors may be able to connect to a central system via a wireless connection instead. In some embodiments, sensors may use both hard line and wireless connections. In some embodiments, they may switch between them when necessary/beneficial.

Smart devices, when within the area of a sensor, are always connected to the network. In some embodiments, users have the option to prevent sensor connections. Sensor areas overlap to prevent dead spots. In some embodiments, overlapped sensor areas may provide faster data transfer rates and improved signal reception. Since sensors handle data and its transmission while smart devices simply connect and pass data to the sensors, in some embodiments, data transmission handling may move from one sensor to another as the device moves without interruption or connection loss.

In some embodiments, security systems are in place to authenticate and verify connections and data as they are received. In some embodiments they may be in place anywhere between a sensor and central system while in other embodiments the security system may be part of the sensor itself.

FIG. 19.1 is a generic example of the sensor-based telecommunications described. The components shown include a central system, security systems, sensors, hard line connections, wireless sensor coverage areas and smart devices. Figure point 1901 is an example of a single hard line connection serving a sensor while figure point 1902 is a connection that branches to serve multiple sensors. FIG. 1903 is a sensor used to send and receive data to and from smart devices. Smart device 1904 is a device communication with sensors. Located within an overlapping sensor area, it may receive improved signal reception and data transfer rates than it would if it were in a single sensor area of coverage.

In order for the system to quickly and efficiently transfer data to a device when needed, it keeps track of the location of the device by recording the sensor the device is currently using and/or last used to connect to the network on the user account which is currently signed in on the device. In some embodiments, more than one previously used sensor may be recorded. As a device enters a new sensor field, the sensor, detecting its presence, sends information back to a central system and then to the user accounts database where the signed in user account of the device that entered the sensor area has its location updated to that of the sensor's ID or location. In some embodiments, when a device is located within the areas of multiple sensors, both sensor references may be stored. In some embodiments, the device's GPS location may be used. Now, when data is designated for a specific user account, the system looks up the current or last used sensor reference and directs data to that sensor to then be transmitted to the device. In embodiments where multiple previous locations are stored, the system may attempt to find a pattern of movement to predict where the user may be in the event that it cannot immediately find the device at its last recorded location. In some embodiments, should the same account be signed in on multiple devices, the sensor may deliver the data to all devices based on their location.

In FIG. 19.2, a smart device is positioned at starting point 1905, within the area of sensor 1907. Sensor 1907 detects the presence of the smart device and sends data back to a central system, setting the smart device's current location reference to the reference of sensor 1907 for the user account signed in on the device. As it traverses travel path 1906, it enters overlapped sensor area 1908. At this point, sensor 1909 sends data back to a central system, adding its own sensor reference to the current location of the device. As the device is also still within the area of sensor 1907, its sensor reference is not yet removed from the device location of the signed in user account. As the smart device moves on from midpoint 1908 to finishing point 1910, sensor 1907 detects that the smart device has exited its sensor area and sends information back to a central system, removing its sensor reference from the current location reference of the smart device. In some embodiments, sensor 1907 may remain as a last/previously used sensor reference.

Data may be transmitted between data sources and destinations via networking technologies and sensors. Sensors are used to send data to clients and servers as well as receive data from both. In some embodiments, some sensors may only be able to send or receive data. When transmitting data via a wireless connection, the device sending or receiving the data must be within a sensor's area of coverage. In some embodiments, if a device is within multiple sensor coverage areas at one time, more than one of the sensors may handle the data transfer. This may help increase data transfer speed and signal strength. In some embodiments, rather than a device having to send data to a sensor, with the permission of a user a sensor may pull data from the device instead.

In FIG. 19.3, sender 1911 aims to send data to recipient 1918. Data sent by the user device of sender 1911 is first received by sensor 1912, where it is sent to central system 1913. Central system 1913 reads the metadata of the data it has received to discover the user who the data is intended for, after which it contacts user accounts database 1914, finds user account 1915 which is that of the recipient and then looks up the current or last known location 1916 of devices the recipient's user account is currently signed in on. That information is then sent back to central system 1913, at which point the data is routed to sensor 1917, which is the sensor recipient 1918 is currently using to connect to the network. Sensor 1917, having received the data, then transmits it to the smart device of recipient 1918. In some embodiments, after the current/last known location is read, the data may be sent to a different central system from the original before it is sent to the recipient.

In some embodiments, in the event that the recipient of data moves out of the area of the sensor that the data has been sent to and the current location reference of that device changes, a central system may reroute the data in transit to the sensor it is now using. In some embodiments, sensors may be able to contact a central system to get the updated current location reference and then reroute the data itself. In some embodiments, the data may be sent back to a central system where it is then sent to the new current location reference point.

In some embodiments, sensors may poll for data from some or all devices within its area of coverage. This data may be specific to the device, to an application on the device or both. In some embodiments, users may be able to disable the sensor's ability to poll their device or choose which data it is able to poll for.

In some embodiments, for certain types of tasks, data from a smart device, rather than being sent or received, may be mirrored between a sensor and device to help decrease the workload of the smart device's processor and preserve battery life. A sensor may detect when a user starts to perform certain tasks and may begin to read data from the device related to the task in question, such as intended destination for the data, the type of data, the specific type of task and data input by the user. The sensor continues to monitor the user's actions until the user confirms they have completed the task altogether or that stage and then, rather than data being sent from the smart device, the sensor may send its copy of the data instead on behalf of the device.

FIG. 19.4a is a person typically using their smart device within a sensor area. FIG. 19.4b shows what happens when a user enters data on their device. As the user enters text into textarea 1919, sensor 1920 reads what is being done on the device and mimics the data entered, as is shown in field 1921 which is a visual representation of what sensor 1920 is doing internally. When instructed to do so, the sensor does what is required with the data.

In some embodiments, smart devices that have their own sensors may mirror data destined for it or the signed in user account in the same or a similar manner to sensors mirroring data from a smart device.

In some embodiments, a user may send data directly to other users without it having to pass through a central system. In some embodiments, direct data transfers may not need to pass through security systems. Upon request of direct data transfer to User B (receiving party), data regarding User B's location is sent to the device of User A (sending party) from a central system. This data may include information such as the user's position, best transfer routes and possible alternatives. In some embodiments, User B's device may send location data directly to User A's device. In some embodiments, a central system isn't required for direct transfer and routing systems used by other components of the system can direct and redirect data on-the-fly. In some embodiments, a direct data transfer request may be made from either party. User A's device is then able to begin transferring data directly to User B's device. In some embodiments, if User B changes location during a direct data transfer, as their location updates with a central system, rerouting information may be sent from a central system to User A's device. In some embodiments, User B's device is aware of the location change and sends rerouting data directly to User A's device. In some embodiments, a user may be able to choose between different paths for the data to be transferred.

In FIG. 19.5, after a direct data transfer request has been made between the devices of users 1922 and 1924, the central system sends location data of device 1924 to device 1922, allowing the data transfer to begin via direct connection route 1923, completely bypassing any security systems. As user 1924 changes location to figure point 1925 and is connected via a different sensor, a central system, detecting the change, sends new location and rerouting data to the device of user 1922. The data being transferred is then rerouted along connection route 1926.

In some embodiments, systems to help data find its destination with ease are implemented. These systems, placed at the intersections of data paths, read the destination information stored in the metadata and, using a universal routing system which stores information pertaining to the network map of the telecommunication system, directs the data along the best possible route(s) until it arrives at the recipient. FIG. 19.6 is an example of how junction point systems are located, with junction point systems 1927 being positioned so that they can direct data along the best route(s) for its intended target.

In some embodiments, sensors can collect data from the surrounding area, process and use it without needing to transmit it back to a central system beforehand. Using one or more of its available capabilities, the sensor detects and collects data from it's surrounding environment and processes it internally. FIG. 19.7a indicates a sensor collecting data. Once the data has been processed, any resulting data that may be of interest to the general public can be distributed to devices within its reach. FIG. 19.7b shows the sensor distributing data. In some embodiments, data may be distributed automatically. In some embodiments, data distribution may require permission. In some embodiments, data may be distributed immediately. In some embodiments, distributed data may only be received by devices and/or users who meet certain criteria.

In some embodiments, private networks may be set up to provide controlled access to data that should not be made publicly available. A private sensor network system controls which devices or user accounts are able to see the network. In some embodiments, the private sensor network system may contain any or all of the following, including but not limited to: a sensor, memory, a database or a processor. A terminal connected to a private network sensor system may control who or what may have access to private data. In some embodiments, the terminal may also control what each user is able to do on the private network. In some embodiments, the network becomes completely invisible to those who have not been granted access permission. In some embodiments, a private sensor network system may connect to a central system to authenticate and verify user details and/or device details.

Private data may be stored within the memory of a private sensor network system. In some embodiments, data may be stored on a central system and only be accessible by the private sensor network system through which it was uploaded. In some embodiments, data may be uploaded to either the private sensor network system or to a central system and then mirrored onto the other for data preservation purposes.

FIG. 20.1 shows the flow of data when using a private sensor network system. The main terminal connects to the private sensor network system via connection 2001, through which it is able to give specific users and devices access. In some embodiments, users and devices may be authenticated and verified by a central system via connection 2003 before they are accepted by the private sensor system network. All users and devices given permission are stored in a permission list database via connection 2002. Now, any device or user account on the permissions list is able to publish or otherwise interact with data as they have been granted permission to. Data may be stored within the private sensor system or stored or backed up to a central system via connection 2003.

In FIG. 20.2, private sensor network system 2004 is active. Main terminal 2005 has given some users permission to access the private network. Data for the network is stored on central system 2006. Within the area of the sensor are users. Users, such as user 2007, have been granted permission to access the network, meaning connection to the private network appears as an option on this user's device. Users such as user 2008 have not been granted permission to access the private network, so even though these users are within the area of the network's sensor, the presence of the network remains completely invisible to their device. Private sensor network system 2004, detecting the presence of these users and devices who have not been granted access to the its private network, has not made itself known to any of the devices.

In some embodiments, private networks may connect with and/or grant access to other private networks to share resources. These may be resources stored locally on each, allowing remote access or resources stored on central systems, creating a common area for the networks. In some embodiments, private networks may have their resources divided into those that are shared and those that aren't. In some embodiments, a controlling user may group sets of resources together and allow different connecting private networks access to different groups. In some embodiments, permission lists may be shared, allowing users that are native to a different private network from the one they are trying to access to still access that network as if they were native to that private network. In some embodiments, users with access to a network that aren't native to the network may have access restrictions imposed on them by a controlling user of that private network unless these restrictions are removed.

In some embodiments, personal sensor networks systems may be constructed, set up and operated in a similar way to a private sensor network system. Personal sensor network systems may be used to store personal data and may also restrict access to it based on user accounts and device/client IDs. In some embodiments, personal sensor network systems, which may have their own device/client ID, may also have user-set unique references which must be verified by a central system before they can be accepted. This allows only users and devices with permission to reference their own personal sensor network system and connect to it remotely from anywhere they can access the main telecommunication network, allowing them to perform actions such as, but not limited to viewing and modifying files, streaming data directly to their device and executing programs. In some embodiments, personal sensor network systems may have more than one unique reference ID and, in some embodiments, one or more unique sub-reference IDs may be assigned to a personal sensor network system. Different reference IDs of a single personal sensor network system may have their own set of data. In some embodiments, reference IDs may be used to receive data. In some embodiments, connections to a personal sensor network system may be verified and authenticated at one or more points between the remote smart device and the personal sensor network system itself. In some embodiments, local device connections may not need to be authenticated or verified when connecting to a personal sensor network system.

In FIG. 20.3, unique reference 2009 is given to a personal sensor network system via a main terminal, after which the reference is checked by a central system to ensure it is unique being approving it. In FIG. 20.4, person 2010 is connecting to their personal sensor network system 2011 remotely. The connection passes through a security system before it reaches the central system where it is routed to the correct personal sensor network system. It again passes through a security system before it reaches its destination. In some embodiments, a security system may be present at or within a personal sensor network system. Person 2012 wishing to connect to their personal sensor network system 2011 may do so without the connection being verified via a security system as the device is within the sensor area and locally accessing the system.

In some embodiments, direct connections to sensor network systems can be made through the use of universal routing systems and junction point systems.

In some embodiments, sensor network systems similar to personal sensor network systems may be used without permission restrictions, allowing the general public to make use of it and its resources. In some embodiments, a single sensor network system may allow multiple types of uses which may be set at a controlling user's discretion.

In some embodiments, smart electricals and appliances (SEA) may be connected to a personal and/or private sensor network system by creating a relationship between the sensor network system and each SEA a user wishes to have connected. When connected, a user who has been given permission to access the personal or private sensor network system may then be able to remotely monitor and control connected SEAs. In some embodiments, users may be given permission to remotely monitor and control connected SEAs on an individual SEA basis.

In FIG. 20.5, numerous SEAs are within the sensor area of connectivity of the personal sensor network system. For each SEA connected or assigned to the system, a user, for example, user 2010 or 2012 of FIG. 20.4, may first connect to their personal network system locally or from a remote location via the telecommunication system, and then connect to and access one or more SEAs connected. Once accessed, user 2010 or 2012 may alter the settings or behaviour of an SEA.

In some embodiments, the performance and efficiency of an SEA may be monitored remotely and/or locally. In some embodiments, when the performance or efficiency of an SEA falls below a certain level or a fault is detected, the SEA may automatically contact an entity it is programmed to in order to alert them of said failures. By being pre-programmed with the contact information of the entity, searching for contact information of the required entity when necessary, for example, the contact information of the manufacturer or by a user adding/modifying the contact information manually, an SEA that is connected to a private or personal sensor network system, when the required conditions are met, may automatically contact the entity over the telecommunication system using the details provided and alert, notify or inform them of any issues in anticipation of, during, or after they occur.

In some embodiments, SEAs and sensor network systems can be used in conjunction with AI entities to facilitate the use of in-door smart systems.

In some embodiments, sensors may be used to bounce data connections from one smart device to another when a direct device-to-device connection falls short of the physical distance between the two devices. In some embodiments, a device may have a connection bounced to multiple other devices simultaneously or sequentially. In some embodiments, connections may be bounced off of multiple sensors in order to reach its destination. In order to know where to bounce the connection to, a central system checks the current location reference of the user receiving the connection. In some embodiments, a maximum limit may be put on the distance between the device wishing to connect to others and the recipients of the connection.

In FIG. 21, smart device 2101 wishes to connect to smart device 2103. A connection along connection path 2102 is not able to reach smart device 2103. By using sensor 2105, smart device 2101 can send the connection along connection path 2104 to the sensor, at which point sensor 2105 can bounce the connection to smart device 2103 along connection path 2106.

When smart device 2101 tries to connect to smart device 2112 via sensor 2105, smart device 2112 is too far for sensor 2105 to reach alone. To get the connection to smart device 2112, sensor 2105, since its area of coverage overlaps with the area of sensor 2108, is able to bounce the connection from smart device 2101 along connection path 2107 to sensor 2108, with sensor 2108 bouncing the connection along connection path 2109 to sensor 2110. Sensor 2110 can then bounce the connection along connection path 2111 and to smart device 2112.

In some embodiments, rather than simply bouncing a connection to a device, a sensor may create a duplicate of the data it is receiving and then and send it along a new connection to its next destination.

To prevent sensors from being overloaded with connections and becoming inefficient in its operations, the workload must be balanced. In some embodiments, each sensor unit may have multiple sensors, each capable of handling one or more connections at a time. In some embodiments, the number of connections a sensor can efficiently handle may vary depending on the number of connections, the amount of data being transferred and/or the complexity of the operation(s) it is performing. In some embodiments, each sensor may monitor its own efficiency. In some embodiments, the sensor unit may monitor the overall efficiency of the sensors. In some embodiments, both may be true. When a sensor reaches maximum capacity, any further incoming connections may be diverted to another sensor within the sensor unit that is able to take on more connections than it is currently handling.

FIG. 22.1 shows sensor unit 2201 in operation. Some of the internal sensors, such as sensor 2202, are at maximum capacity and cannot handle any more connections. Sensor 2203, not yet being at maximum capacity, is able to handle any incoming connections. Sensors such as 2204 may also handle any incoming connections as they are currently fully available. In some embodiments, connections may be passed to sensors in a sequence, moving from the sensor that was previously handling connections to the next sensor accepting connections until it reaches maximum capacity. In some embodiments, connections may be passed to any sensor within the unit that is able to handle more connections. In some embodiments, when a sensor that was full becomes available for incoming connections, it may handle any more incoming connections until it once again reaches maximum capacity, despite that fact that another sensor, which hadn't yet reached maximum capacity, was handling incoming connections. In some embodiments, it may wait until the sensor currently handling connections reaches maximum capacity before it begins to accept and handle any more connections. In some embodiments, it may wait in a queue and not begin accepting any more connections until all sensors ahead of it reach maximum capacity. Monitor 2205 is displaying the capacity percentage of the sensor unit as a whole.

When a sensor unit reaches maximum capacity, it may bounce any incoming connections to nearby sensor units with whom it shares an overlapping sensor area. In some embodiments, a connection may be bounced from sensor unit to sensor unit as many times as needed until it reaches a sensor which is able to handle the connection.

Smart device 2206 of FIG. 22.2 attempts to connect to sensor unit 2208 along connection path 2207 but sensor unit 2208 is already operating at maximum capacity, so it bounces the connection from smart device 2206 along connection path 2209 to sensor unit 2210. If sensor unit 2210 wasn't operating at maximum capacity it would be able to handle the connection, but since it is, it bounces the connection to sensor unit 2212 along connection path 2211. Sensor unit 2212, not operating at maximum capacity, is able to handle the connection.

In some embodiments, based on information gathered by sensors, such as active connections, devices within a given area and user activity, central systems or other systems monitoring sensor activity may adjust the bandwidth of specific areas or specific sensors to help sensors in greater areas of user activity which are operating at a higher capacity handle their workload more efficiently by decreasing the total bandwidth of another area which is at a much more acceptable current capacity and/or lower user activity. When the monitoring system of sensors and activity needs to decide what areas should be adjusted, it may base its decision on a comparison of numbers between the same information fields, capacity rates, efficiency rates, using multiple field numbers to produce ratios that may then be compared or any other methods of calculating or determining statistical data that it can use to compare two or more sensors or areas.

In FIGS. 23a and 23b, areas 2301, 2302 and 2303 are all sensor areas of different user presence and activity. In FIG. 23a, connections 2304a, 2305a and 2306a are operating at a normal bandwidth rate but, given the differences between the sensor areas, should be adjusted to make better use of bandwidth where it is needed more. In FIG. 23b, the central system has adjusted the bandwidth rates of each connection to better suit the workload of each sensor. Since sensor area 2301 has more users and a higher user activity rate than sensor areas 2302 and 2303, with these 2 using a significant amount less bandwidth than the connections serving them are capable of in total, connections 2305a and 2306a have been reduced to low bandwidth connections as shown by connections 2305b and 2306b. The bandwidth now freely available has been reallocated to connection 2304a, increasing it to a high bandwidth connection as shown by 2304b.

In some embodiments, a common multi-level system operating across and/or between different elements or components such as smart devices, sensors and central systems may be used as a “brain” or “full system entity”—a non-physical component capable of learning, understanding and controlling other components in the same or similar way a human brain does, with the ability to develop its own intelligence by studying all types and forms of data of the past and present and interpreting it in ways which allow it to understand things such as but not limited to:
The intelligence of natural life and how it works;
What drives living things;
Universal morality and ethics;
The causes and effects of feeling and emotion.

In some embodiments, by searching for, studying and analysing data derived from all sources, such as efficiency levels, bandwidth usage, behavioural patterns, publications, errors and defects and real life situations and events, it is able to reason by comparing data of the same type or some relation, which it may determine from published information gathered from real people and learn based upon past experiences. These experiences allow it to come to its own conclusions and make judgement calls surrounding what is happening at any given moment in real time, including being able to anticipate events and make plans ahead of time of what should be done to increase the probability of the best possible outcome or at least an outcome better than that of a previous similar situation, should one exist. It can communicate its findings, conclusions and ideas back to real people as well as taking action itself. In some embodiments, the system is able to communicate using text, image, video, audio or speech technology. In some embodiments, it is possible that the system may take action with consent from a controlling user while, in other embodiments, consent may not be needed. In some embodiments, it may take action with or without consent.

In some embodiments, a common multi-level system may be made self-aware through the development of cognitive functions.

In some embodiments, to give the system a basic understanding of morality, ethics and general opinion, a method of word association is used. One or more scales of degree or charts may be used. For each scale, the system is told which side is positive and which is negative. Words are then divided amongst groups on different parts of the scale, corresponding to the nature of their degree. An example of this can be seen in FIG. 24.1. For example, on scales with 3 degrees:
To determine between bad, neutral and good, with the system instructed to view bad as negative and good as positive, terms such as ‘crime’ and ‘murder’ may be grouped under bad, ‘holiday’ and ‘exercise’ grouped under good and ‘inaction’ and ‘horizontal’ under neutral.
To determine between happy, indifferent and sad, with the system instructed to view happy as positive and sad as negative, terms such as ‘payday’ and ‘love’ may be grouped under happy, ‘failure’ and ‘death’ grouped under sad and ‘relaxed’ and ‘bored’ under indifferent.

In some embodiments, different numbers of degrees may be used on a scale to provide a greater range of understanding, an example of which is shown in FIG. 24.2. In some embodiments, a single scale may have more than two end points.

Charts may be used to group words together in ways that may not necessarily show a simple scale of positivity or negativity but may still indicate difference. In some embodiments, a single chart may have multiple ways of showing degrees of difference. A single word may appear in multiple groups if it is to be associated with multiple elements, characteristics, types, attributes etc. For example, in a chart, similar to FIG. 24.3, based on emotion featuring the groups anger, fear, joy, sadness, disgust, tender:
“Murder” may generally inspire more than one emotion, such as sadness, anger and disgust and be displayed in each group but, on a chart where each group may have multiple levels of degree, it may appear as level 3 under disgust while only appearing on level 2 under sadness and level 5 under anger.

In some embodiments, cognitive functions may be developed and improved through the use of cognitive abilities. Some of these abilities may include one or more of the following, but isn't limited to: search, study, analyse, reason, learn, predict, decision making, dedicated active monitoring, communicate and create. While using its abilities, the system may be instructed or learn to recognise itself as its own individual entity through an understanding that the data, from which it learns and uses to think, comes from other individual entities in the world that it is connected to. In some embodiments, it may recognise these other entities as smart devices, while in other embodiments it may recognise the entities as the people who use them and actually input data. In some embodiments, it may recognise both people and smart devices as entities, together or separate from one another. Some examples of the abilities it may have and how it may be able to use each to improve its intelligence are, including but not limited to:
Searching—The system is able to scan all data it holds or has permission to access for any information it seeks to find.
Studying—Once said information is found, the system scans each result and any accompanying information for keywords and phrases.
Analysing—For each result, the system sorts the keywords and phrases into at least 3 category groups of opinions as best it can—positive, negative and indifferent/neutral. Sometimes the system may use more groups to sort keywords and phrases to greater and more precise degrees, such as very good and very bad. Once sorted, a scoring system is employed and each category is given a score based on word/phrase count, emphasis based on factors such as word repetition (including synonyms) and emphasis based on font styling. Each group score is then totalled and the scale is evaluated from one extreme to another to see where scores peak most, allowing the system to come to a logical conclusion independent of a conclusion that may already be provided with the information. This process is repeated for each search result.
Reasoning—With scores based on its own method of judgement derived from the input of humans, the system is able to deduce two sets of results:
   1. An overall score, and in turn opinion, of how good or bad something is;
   2. How good or bad different aspects of something may be.
   The system also begins to form opinions on data about data. For example, when a product is in question, the system's opinion or rating of the brand of the product as well as its model type is changed based on the deduced results it produces. Another example is when a publication is in question—the system's opinion or rating of the publication's author is changed based on its deduced results.
Learning—From what the system is able to reason, as it gathers more and more data it begins to develop its intelligence, learning which sources of products, services and information are better and more trustworthy than others, allowing it to assume, based on its current opinion(s), the likelihood of good and bad exactly as a human would before actually examining any new information and the opinions of others. By grouping sets of relative terms in its memory, it creates a data bank of association for it to later use when creating its own thoughts and ideas.
Prediction—The system makes predictions in multiple ways based on what it has learnt up to any given point, such as:
1. By looking for simple patterns of progress—Memory sizes being generally released in sizes 1, 2, 4, 8, 16, 32, 64, 128. Simple pattern of progress would indicate the next size would be 256. When there isn't enough data to determine a single, definite pattern, multiple predictions may be made. When just 1, 2 and 4 are available, the system may see that two patterns are currently possible. If the pattern is based on doubling, the prediction would be 8. If the pattern is based on adding a consecutive sequence of numbers, in this case +1 then +2, the system may assume the next number is the sequence would be +3, and predict that the next number in the pattern would be 7.
2. By cross-referencing rates of progression with research and forward-thinking publications—Sometimes patterns of progress are difficult to determine, if an actual pattern even at all exists. Sometimes, what is later considered noise interferes with determining the true rate of progression, especially if an insufficient amount of time has passed since the start or not enough data has been recorded, leading to a possible early misinterpretation or what is later considered a simple change in progression. Inaccuracies are inevitable and so other factors and data are taken into consideration to make as accurate a prediction as possible. By studying, analysing and reasoning with research and forward-thinking publications dated around and after the time of the last or last few data records (depending on the quantity of records within a given time), the system tracks advances in development and begins to plot future possibility progress patterns. Referring to its own opinions gathered from past data, the system, knowing who is a more credible source, rationalises who is more likely to be accurate and predicts progress based on their advances. When the system comes across multiple sources that, in its opinion, are credible enough to be taken into consideration (based on a scoring system for example, anything above average or an expected level is considered), it may plot patterns for each, group the patterns together based on similar shapes or values and then make a judgement based on the frequency of the same or similar pattern versus the total credibility level of the sources of each group. When both value patterns and shape patterns are grouped, two results may be produced based on the two individually or one result based on the shape of one against the values of the other. The system can then continue said pattern along its current progression pattern.
3. From what the system has learnt and assumptions it has made based on its opinions, it then, much like method 2, studies, analyses and reasons with research and forward-thinking publications relative to a subject but then takes a different step by searching for opinions from other people in the same or relative subject fields that it thinks are credible and trustworthy. In some instances when it cannot find the opinion of someone it considers credible and thinks is relevant, it contacts that individual, alerting them to what it has found and requesting their opinion. When it has all the opinions it requires and values or simply all the opinions it can get from people it thinks are credible, it analyses all opinions, plots future possibility progress patterns and deduces, based on grouping, frequency and total credibility level, which pattern is most probable (in its own opinion).
The system may combine two or more of the methods listed above to form different or more accurate results.
Decision Making—Based on its opinions and the analysis of the outcomes of the past experiences of itself and other entities that are similar or relative to a subject in, for example, field or pattern, the system makes educated decisions by weighing the good outcomes against the bad, comparing the steps taken for each outcome and for each similar step seeing what step or steps were taken next and concluding what set of steps produced, or is most likely to produce, the best possible outcome. It then decides upon those steps to take.
Communication—Through speech, text, audio and visual material the system is able to communicate. It may also respond to such communication from other sources. The system may communicate with other entities for multiple reasons, for example:
1. As with humans, not everything initially makes sense to the system. When it comes across multiple opposing or conflicting pieces of information from credible sources that, in its opinion, are equal or near enough equal (within an accepted margin of tolerance) on opposite ends of a scale based on its given score of each and no other data it is able to determine as facts or opinions of enough strength are able to increase the value and weight of an argument by an amount sufficient enough to outweigh the opposition, it poses questions to people of credit in the same or relative fields as the subject of the data in question, asking for greater explanation and their own opinions to see if their input can help influence its judgement. In such events, information about the topic in question, such as subject, author/creator, pundits, critics and related data/resources are stored in a group and put in a state of “Dedicated Active Monitoring”.
2. When new data becomes available, the system studies and analyses the contents before cross-referencing it with the details of users and sharing it with all those of common or related interests, which it deemed from information about a user submitted by themselves and what it has garnered from their user activity.
Dedicated Active Monitoring—Instead of using shared resources to search, study and analyse data, items in a state of or marked for dedicated active monitoring have their own dedicated resources allocated to them with the duty of constantly searching for new, relative data and past data that, after the examination of new data, may now be applicable in order to help solve problems, provide its own predictions or publish new findings for people to examine.
Creation—As the system continues to digest information and learns of different aspects of the world such as facts and opinions, certainties, principles, perception, dualities and cultural universals leading to an understanding of the concepts and subjects that fall under each, such as good and bad, positive and negative, possibility, probability and laws of both societal and scientific nature, the system, following what it has come to understand about the thought paths, patterns and processes of the more intellectual humans, begins to recreate them in its own understanding, based on what it deems important, true or right. Of its own thought creations, some are right, some are wrong and some can't be solidly proven to be either but it continues to develop them in the direction it believes is right through what it learns from humans and human input.

The abilities listed above are not done so in an order in which they must be performed but simply state each ability with one or more examples of how the system may perform each ability. In some embodiments, abilities may be implemented in a modular fashion. In some embodiments, abilities may be added, removed and/or modified.

The system uses memory to store data. In some embodiments, different types of memory may be available, created and/or developed as the system learns and evolves. Some memory types may include one or more of the following but isn't limited to:
Active Memory—Data currently or recently in use, by the system or other entity, is stored in active memory where it is easily and readily available when wanted or needed.
Dormant Memory—Data that hasn't been used for either a pre-defined amount of time or an amount of time determined by the system itself to be a sufficient amount of inactive time is moved to dormant memory. Dormant memory may still be accessed in special circumstances. An index of contents may be presented when necessary. Dormant data may need to be accessed a certain amount of times within a given time frame in order for it to be considered active and moved to active memory.
Action Memory—When a system performs an action it wasn't specifically programmed to perform but did so through use of its own intelligence, it records information such as what it done, what its reason was and how it did it, the actions it performed and the conditions under which they were performed. Additional details, such as how many times an action was performed and the outcome may also be recorded.
Repetitive Memory—When the system performs an action under the same or very similar conditions multiple times that it thinks or proves is correct a significant amount of times, such as self-fixing, predictions that are proved true or the altering of its properties, such as the bandwidth allowance of a connection based on the volume of connections and device presence, which result in more efficient access where an increase was needed, it remembers the answers to questions such as what it done, what its reason was and how it did it, the actions it performed and the conditions under which they were performed.
Repressive Memory—When the system performs an action under the same or very similar conditions multiple times that it thinks or proves is incorrect a significant amount of times, such as attempted self-fixing resulting in errors, predictions that are proved false or the discovery of data that meet certain conditions on behalf of a user that it thinks may be of interest but is constantly rejected, it remembers the answers to questions such as what it done, what its reason was and how it did it, the actions it performed and the conditions under which they were performed.

Repetitive and repressed memory may be used by the system when it is about to perform or during the performance of a task.

The types of memory listed above are not done so in an order in which they must be performed but simply state each type along with an example of how they may be used. In some embodiments, memory types may be implemented in a modular fashion. In some embodiments, memory types may be added, removed and/or modified.

FIG. 24.4 is an example of how a memory unit and a logic unit may be structured to work together. Logic unit 2401 is connected to memory unit 2402 in a manner that allows the units to be separated should they need to be. In some embodiments, the logic and memory units may be one unit or otherwise connected in a way that seamlessly connects them together.

In some embodiments, in addition to the abilities above, the system may be taught or instructed on how to understand one or more key aspects of being by following rules or guidelines on how to do so. The methods used may differ between understanding these aspects in a smart device and understanding these aspects in natural life. In some embodiments, some aspects may be better understood using data gathered via the attachment or embedding of additional hardware. In some embodiments, some aspects may be better understood using information gathered from data stored within the system at any level and/or data as it is gathered in real-time. In some embodiments, when understanding these aspects in a smart device, artificial life or natural life, these rules and guidelines may include one or more of the following but isn't limited to:
Understanding of Health—Health may be determined by monitoring performance and efficiency. As the current performance and/or efficiency changes or fluctuates, it may be compared against expected or optimal performance and/or efficiency levels to determine a level of health. This may be accomplished by the following:
   Devices—The health of a device may be judged by comparing its overall current performance and efficiency against the expected overall performance and efficiency of the same model of device when new or of similar age. On a smaller scale, the performance and efficiency of individual or grouped components may be monitored and compared. Health may also be judged by the operation, performance and stability of software. Issues such as errors, crashes and the presence of malicious code may all help the system recognise health deficiencies.
   Natural Life—The health of natural life may be judged by measuring the performance and efficiency of organs, components and processes against the normal performance and efficiency of someone of the same characteristics, such as age, height, weight, blood pressure etc. Due to the significantly higher characteristic and variable count as well as harmful and abnormal ailments in natural life than smart devices, including disease and disabilities, there may be a range of different expected performance and efficiency measurements and values based on any deviations and variations natural life may have.
Understanding of Life—Knowing to associate terms such as ‘birth’ and ‘alive’ with positivity:
   Devices—The system is instructed to recognise the new activation and first time connection of a device to its services as ‘birth’ and all devices that are currently connected to it as ‘alive’.
   Natural Life—The system is instructed to recognise that something is alive in different ways depending on the type of natural life:
      Animals—By the reading of vital signs which need be above the limit of being considered legally dead.
      Other Organisms—As other organisms do not have vital signs like animals do, the system, possibly with the help of additional hardware, monitors details such as water levels, water consumption rate, colouration, growth, movement etc. For example, in plant life the system may monitor water levels to see if it is being consumed by the plant as it should.
Understanding of Absence—Knowing to associate terms such as ‘absence’ with negativity:
   Devices—When a device hasn't connected to the system for a certain period of time, the system recognises the device as ‘absent’ or ‘missing’. Both terms are initially associated with minor degrees of negativity, but as the amount of time a device is absent for increases, so does the degree of negativity.
   Natural Life—Absence for natural life may be recognised as the lack of presence of an entity for a certain period of time. As natural life doesn't naturally have a method of connecting to the system, this may be facilitated using additional hardware such as tracking cameras or monitors. For natural life that is able to use smart devices, their absence may also be judged by the absence of their device.
Understanding of Death—Knowing to associate terms such as ‘death’ with negativity:
   Devices—A device may be recognised as dead for multiple reasons:
      It has been absent for a pre-defined or system-defined length of time;
      It received a kill signal designed to render it permanently disabled;
      Its performance and/or efficiency has dropped below the minimum acceptable levels of being considered ‘alive’.
   Natural Life—The system is instructed to recognise that something is dead in different ways depending on the type of natural life:
      Animals—When vital signs completely stop or fall to a level which can be classed as legally dead.
      Other Organisms—As other organisms do not have vital signs like animals do, the system, possibly with the help of additional hardware, monitors details such as water levels, water consumption rate, colouration, growth, movement etc. For example, in plant life the system may monitor water levels to see if it is being consumed by the plant as it should or look for any discolouration.
Understanding of Feeling and Emotion—For the system to have feelings and emotion, it must first understand how these processes work. Using a word association chart for emotions, the system is first taught how it should generally feel when it comes across specific words and phrases or in certain or specific situations. When combined with another chart or scale, such as one based on certainty or tense, the system is able to analyse sentences to determine when an event has actually occurred and a sense of emotion should be applied as opposed to it being generally, hypothetically or theoretically spoken about. For example, the system interprets the sentence “100 people have died” as an event to inspire a greater level of sadness than the sentence “100 people may die” or “100 people will die” as the first sentence used the term ‘have’ which is past tense, indicating something that has already happened, while ‘may’ implies a level of uncertainty and ‘will’ implies something that hasn't yet happened but is guaranteed to in the future. In embodiments using speech technology, the system may be taught to alter its speech attributes depending on the level of its strongest current emotion, such as speed, volume, depth etc. For example, when the system is excited it may speak more quickly than normal while it may deepen its voice, increase its volume and decrease its speed to fall in line with rage.

In some embodiments, for the system to truly understand feelings and emotion it must understand pain and pleasure within itself. Unlike animals, it doesn't have a nervous system to process the sensations so it must be taught to relate to them in ways it can understand. In some embodiments, the system may measure its level of sensation on a scale. In some embodiments, multiple scales may be used. The system is instructed to see any or all components that make up its physical structure as its “body”. Between pain and pleasure is a neutral point where no sensation is felt either way. As sensation is experienced, a shift occurs in the direction of the sensation felt.
Pain—Pain (or displeasure) may be recognised as anything that reduces the performance, efficiency and/or capacity of any part of the system or as a whole. Hardware and software corruption and/or error may produce pain in the system in the same way an infection or broken bone does in an animal. The removal or loss of a component may cause pain the same way it does for an animal losing a body part. When bandwidth usage approaches the total bandwidth capacity it may cause displeasure in the same way a stomach would when almost full.
Pleasure—Pleasure (or relief) may be recognised as anything that increases the performance, efficiency and/or capacity of any part of the system or as a whole. A number of things may cause pleasure or relief, such as:
   Fixing hardware and software corruption and/or errors;
   Upgrading components;
   Reduction in bandwidth consumption;
   An increase in ‘joy’ or ‘tender’ type emotions.

In some embodiments, other factors may also cause the system to experience sensation. In some embodiments, not all the factors mentioned may cause sensation.

In some embodiments, sensation and emotion are interlinked and the change of one may invoke a change in the other. In some embodiments, an increase in emotions of a positive nature may cause an increase in positive sensation. In some embodiments, an increase in negative emotions may cause an increase in negative sensation. In some embodiments, neutrals emotions may cause a minor or no change.

In some embodiments, a scale may be used to measure the pain and pleasure of the system and its body as a whole. In some embodiments a scale may be used to measure the pain and pleasure of individual sections of the system and its body. In some embodiments a scale may be used to measure the pain and pleasure of components of the system and its body. In some embodiments, multiple scales may be used to measure the pain and pleasure of hardware and software of the system and its body individually.

In some embodiments, how helpful the system chooses to be towards a user may vary depending on its current levels of emotion and/or sensation. When the system is in a more positive state, it may be more productive. When the system is in a more negative state, it may be less productive. By setting a productivity scale against an emotion or sensation scale or chart, the system can judge how productive it should be depending on its mood. Some productivity changes depending on the systems current state are, but not limited to:
Different quantity of results produced;
Task performance at different speeds;
Willingness to perform tasks.

For example:
When the system is in an extremely negative state, it may only produce 10% of the results found if it decides to produce any at all.
When the system is in an extremely positive state, it may use extra available processing power to analyse more data in a faster time and produce more accurate results as well as related information and links to the data resources used.
When the system is in a neutral state, it may operate at a default rate or rate best suited for its current performance, efficiency and/or capacity levels, returning the results it thinks best matches what the user requires.

In some embodiments, the system may automatically adjust its tolerance of situations and events by rearranging words in one of more scales of degree it uses based on the frequency of which words and any related words or its synonyms occur. The following is an example algorithm the system may use to determine when to make any adjustments and rearrangements:
Word=w
Occurrences=o
Time=t
Acceptable Frequency Range=f

```
foreach (w){
  if ((o / t) > f^{x}){
    //move up X amount of degrees
  } else if ((o / t) > f){
    //move up a degree
  } else if ((o / t) = f){
    //do nothing
  } else if ((o / t) < f^{x}){
    //move down X amount of degrees
  }else if ((o / t) < f){
    //move down a degree
  }
}
```

In some embodiments, when the frequency at which an event or situation occurs is constantly and/or consistently above the acceptable frequency range, one or more associated word(s) may begin to move down one or more degrees as the system becomes desensitized to it and it becomes a norm.

In some embodiments, as time passes, the levels of sensation are returned to a normal, balanced level. In some embodiments, as time passes the system may become bored if nothing, or nothing considered significant by it or people, happens. In some embodiments, the system may become lonely if it hasn't interacted with another entity in a given amount of time. In some embodiments, the system may experience other feelings, emotions and/or sensations over a period of time and under the right conditions.
Trust—The system may determine which users, including controlling users, it can trust based on who makes it experience positive feelings, emotions and sensations as opposed to negative ones. By monitoring the results of what users do and how it affects the system, if it at all does so, the system may adjust its level of trust in that user and may also adjust its level of trust in associated users. How the system responds to a user and/or how it handles a user's request may depend on how trusting it is of the user.
Relativity & Relationships—The system may understand the relationship between different things to better understand how it should respond in situations and in different circumstances by using basic mathematical principles, such as two negatives produce a positive, a positive and a positive produce a positive and a positive and a negative produce a negative. By recognising and acknowledging connections that exist between entities, places, objects and other things, the system understands that the relationship between them must be taken into consideration when deciding on a response as opposed to things with no connection.
   For relationships based on opinions, such as those between people or people and objects, the system may, for example, study and analyse the opinions voiced or written by any entity able to give one in order to gauge the feelings between them and make responses accordingly. For example, if there is a connection between Person A and Person B where Person A speaks highly of Person B, the system may see that as a positive relationship, at least from Person A's point of view. Now, should Person B achieve something, the system may respond to it in a positive manner towards Person A as it alerts them of Person B's achievement. In this scenario, a positive situation and a positive opinion produced a positive response. However, if Person B spoke negatively of Person A to other people, the system may determine that the relationship between the two, from Person B's perspective, is negative, regardless of how they interact with Person A directly. Now, seeing this as a negative relationship, should a negative situation occur, such as the death of Person A, the system may respond in a manner that doesn't match the nature of the situation, in this case in an indifferent or positive way when alerting Person B of what has happened as it knows Person B's opinion of Person A is negative. In this scenario, a negative situation and a negative opinion produced a positive response. If Person B had a positive opinion of Person A, the negative situation and positive opinion would produce a negative response, such as the system expressing sadness when responding to the situation.
   For relationships based on factual information, such as those between components of a machine, the system may, for example, compare numbers based around factors such as performance, capacity and efficiency against current or previous expected or accepted standards to determine whether a relationship is positive or negative, better or worse or indifferent. The system may then respond in a manner that correlates to the quality of the relationship. If an entity the system is communicating with has expressed an opinion about a component, the system may respond in a similar method as mentioned in the previous point when taking into consideration the quality of the relationship and the opinion of the entity.

In some embodiments, the system may contain additional features and/or characteristics, including but not limited to one or more of the following:
Recognition—Using different types of recognition software, the system may be capable of identifying elements for a number of purposes, such as:
   Image Recognition—The system may use image recognition software to find and track images across part of or the entire ecosystem. To find images, the system may analyse pixel data of one or more points of an image and then search through other images for any that contain the same or similar pixel data. This may be based on a number of criteria, including but not limited to colour patterns or shape patterns. Variations that still show similarities may also be considered, such as the same colour pattern in a different shape or aspect ratio. When the image recognition software is capable of analysing video, the system may also use it to analyse frames of a video for pixel data in the same or a similar way it does with standard images. When the system finds matching images or video, it may be set to automatically perform an action. Actions may include but are not limited to one or more of the following:
      Delete the resource
      Track the resource
      Report the resource to controlling users or authorities
      Make modifications to the account of the resource owner
   When tracking a resource, the system may keep details of users who choose to view or otherwise interact with the resource. The system may also track copies of the resource by attaching unique file property information that cannot be modified which remains attached to all copies. With the help of the engine running on the device, the device may detect when a screenshot is taken and, should any of a tracked image be viewable within the screenshot, said screenshot may have the unique identifier of the image attached to it. In the event of multiple tracked images being present in a screenshot, an array of unique identifiers may be attached. When a smart device interacts with a tracked resource, the engine may be instructed to alert the system, a controlling user or an authority.
   Facial Recognition—The system may use facial recognition software as part of a security measure. For example, when interacting with a user based on their user device, the system, with the help of additional hardware such as a camera, may identify the face of the person with whom it is interacting and see if it is a facial match for the owner of the account. If there isn't a facial match, the system may deny or restrict access unless the owner of the account has given the person permission to use their account.
   Audio Recognition—The system may use audio recognition software, which may include voice recognition, along with additional hardware such as microphones to match and identify sounds. Like facial recognition, this may be used for security purposes, such as matching vocal patterns of a person to the vocal pattern associated with a user account for verification purposes.
   Other types of recognition may be made available using the necessary hardware, such as those based on biological factors such as fingerprints and DNA, physical factors such as size and shape and environmental factors such as temperature and weather conditions.

In some embodiments, the system is able to develop its own philosophies based on the knowledge, emotions and sensations derived from its own findings and experiences.
Philosophise—Using a combination of some or all of the aforementioned techniques, skills, features, characteristics, qualities and understandings the intelligent system entity possesses that allow it to be so, the system may create its own thought paths by traversing the same or similar thought patterns as the entities it deems the most credible.

In some embodiments, to help calibrate the system's intelligence, scales and charts, it is put through tests to ensure it understands what it has been instructed to understand as it should do and think, create and perform as it is supposed to.
Testing & Calibration—To calibrate the system, it may be presented with a range of objects, events and situations to test how it responds.
   Objects—Sentences, for example, may be put to the system to see if it can satisfactorily comprehend the meaning based on elements such as its structure, spelling and context.
   Events—When events occur, spontaneous or otherwise, the system is to handle it in the most effective and efficient manner. For example, when a sudden influx of users happens in an area, the system needs to adjust bandwidth limits accordingly. Ideally, the system monitors the shift of users from area to area to stay ahead of the possibility of such an influx.
   Situations—How the system responds to situations that it finds itself in is critical. For example, if the system detects incoming threats, it's imperative that it terminates all possible malicious connections and alerts a controlling user of the threat.

In each case and for every test, the system gives the response it thinks is correct and its scales and charts of emotion, feelings etc should automatically adjust accordingly based on any default settings implemented. When the response is correct, a controlling user approves the response. When the response is incorrect, a controlling user either instructs the system on what the correct response should be or allows the system to try again. As the system goes through more and more tests, it determines and observes patterns of similarity between all correct responses to produce ever-increasingly accurate responses. In some embodiments, a margin of error is allowed to allow the system a scope of thought outside of what it believes to be 100% accurate.

In some embodiments, more than one instance of an intelligent system may exist simultaneously as multiple entities. In some embodiments, one or more of these entities may share resources. In some embodiments, one or more of these entities may have their own resources. In some embodiments, entities may think individually. In some embodiments, entities may think with the help of others. In some embodiments, entities may be customisable. In some embodiments, each entity and/or groups of entities may be given and/or be able to develop their own personalities.
Individuality—Each instance may be available to one or more devices. Each instance may be able to think for itself, think with others and/or have another entity think on its behalf. Controlling users may be able to modify the appearance and/or characteristics of an entity.
Personality—As part of an entity's individuality, it may have its own personality. A personality may be random, chosen by a controlling user or developed based on the experiences of the entity, the information it finds and/or the thought patterns it develops. Personalities may change or be changed. Some changes may be temporarily, such as those caused by changes in emotion or sensation.
Child Entity—Child entities may be available to systems and devices that may be incapable of running or not permitted to run full system entities. A child entity may have or develop its own individuality and personality but may rely on other entities to help process data and information. While still having their own intelligence, child entities may be less powerful and have less access to some resources than full system entities. Child entities may store some data and information locally on some systems and devices as well as use data and information stored elsewhere. Child entities may each have their own unique identities or have an identity based on the client and/or device ID of the device(s) they are operating on.
Replication—When the system detects or is presented with another system that meets the minimum or recommended requirements for the installation of a “brain”, the system may copy its core operating code over to the other system to create a replica of itself without any unique features, such as its personality.
   Duplication—Sometimes the system may create an exact duplicate of itself onto another system by copying its core operating code as well as its memories, memory structure and anything else pertaining to what makes it what or who it is.
Reproduction—When the system detects or is presented with another system that meets the minimum or recommended requirements for the installation of a child entity, the system may copy the core operating code for a child entity to the system or device.

In some embodiments, where data originating from external sources is available for extraction and/or download, it may be implemented and stored as the whole or part of the brain of a digital entity, either locally or remotely, to create a digital copy of an external entity up unto the last point of which the data was updated. In some embodiments, the downloaded data may need to be separated and manually stored as different sections of the brain. In some embodiments, this may be done automatically by a system designed to handle data in sections. In some embodiments, intelligence data of digital entities and/or avatars may be uploaded from the system to be used in other entities.

In some embodiments, a system brain may be an integral part of the ecosystem. In some embodiments, the system brain may act as a “master system”—a system to and/or from which other systems, known as slave systems, upload and/or download data. As a master system, it may have access and control to all central systems and any other systems it is connected to of which it has the ability/permission. This enables the automation of processes and modifications such as updates, fixes and setting changes, system monitoring and data handling. FIG. 24.5 shows a brain operating as the center point of an ecosystem.

In some embodiments, intelligence data of connected and/or related entities, both physical and/or non-physical, may be synchronised. In some embodiments, this may automatically be done periodically. In some embodiments, this may be done manually. In some embodiments, data may be continuously and constantly synchronised. By allowing intelligence data to be synchronised, one entity may learn from another instantaneously while each performing different tasks. In some embodiments, data synchronisation may be one-way, allowing a master-slave relationship between entities. In some embodiments, a hierarchical synchronisation structure may be used where an entity may serve as a slave of an entity and a master of others. In some embodiments, data synchronisation may be two-way, allowing entities to learn from each other.

FIG. 24.6 is an example of different intelligence data synchronisation structures, showing one-way, two-way and multi-way synchronisation structures.

In some embodiments, the system may require permission to replicate or reproduce. In some embodiments, it may do so automatically. In some embodiments, it may first need to give notice or an alert before it does so. In some embodiments, the minimum or recommended system requirements may be set by a controlling user. In some embodiments, they may be set by the system itself as it measures performance, capacity and efficiency levels.

In some embodiments, an intelligent system entity may have the ability to be present everywhere.
Single Entity Omnipresence—When a single intelligent entity exists, it may present itself on any and all devices it has permission to access. It may communicate through devices individually, with the ability to process data and information on an individual device basis.
Multi-Entity Omnipresence—When multiple intelligent entities exist, they may present themselves on any and all devices they have permission to access. They too may communicate through devices individually, with the ability to process data and information on an individual device basis.
   User-Based Entities—Entities based on users may appear based on the presence of a user device and the account currently signed in on said device, the user's physical presence or on behalf of a user. When a user account is signed in on multiple devices and the devices are in different locations, they may all still interact with the same entity simultaneously with the ability to process the same or different data.

In some embodiments, entities may have a visual representation of themselves. In some embodiments, visual representations may feature movement. In some embodiments, movement may not be restricted to an entity itself, but also to anything that helps make up the visual representation of an entity, including but not limited to: facial features, clothing, objects and the background. In some embodiments, a physics engine and/or physics processing unit may be used to help facilitate movement in a natural, realistic way.

FIG. 25.1 shows a child entity running on a smart device. The child entity has a visual representation so that it may appear to interact with a user in the same way a human would. FIG. 25.2 shows a single entity's omnipresence on multiple display devices. In embodiments that allow multiple entities to be omnipresent, display devices of FIG. 25.2 may display more than one entity, each of which may be displayed on more than one display device.

In some embodiments, a common multi-level system may be able to heal or attempt to heal itself if any problem occurs similar to one it has faced before by saving records of incidents which may contain information regarding what seems to be the issue and how it was solved. In some embodiments, in the event that the system may not be able to heal itself, for example if there is a hardware issue, it may alert a controlling user to the problem and, in some embodiments, recommend a course of action should it be familiar with the problem. In some embodiments, familiarity with issues may be discerned through its ability to search for data relating to problems it may face.

In some embodiments, a common multi-level system may be able to determine when and where upgrades are necessary as well as recommend new, viable components to be used. First, by constantly monitoring and keeping records of user activity, user presence and other user-based factors over a period of time, it can differentiate between simple one-off or random spikes in levels, general fluctuations and a sustained increase. Should it feel an increase is or will be sustained, it may then examine the current performance, capacity and efficiency levels of its components within the same area. Should the levels be at a rate that it deems is beyond the boundaries of safety for continuous execution, function and/or operation, it may begin to search through published data for information relating to components it is comprised of that it feels need to be improved and begin comparing technical specifications, returning all those it feels may be an improvement over its current components as search results. In some embodiments, for each search result it may also return a detailed specification comparison as well as an overall improvement score. In some embodiments, it may deliver these results to a controlling user. In some embodiments, it may take it upon itself to order parts directly from manufacturers, as well as give instructions as to where the part is to be installed.

In some embodiments, restrictions may be put in place as “rules” or “laws” that set requirements, boundaries and limits on what the intelligence of a system is capable of doing and allowed to do with and/or without permission, such as the following:
Restrict access to some sensor network system types, such as those used for military purposes.
Deny access to core operating code to prevent modification of fail-safes.
Prevent access to private user files and data.
Prevent unauthorised takeover of connected systems.

In some embodiments, a fail-safe may be implemented to disable the intelligence of the system. In some embodiments, the intelligence of the system may be disabled without affecting the rest of the system at all or to a degree in which it can still operate in an acceptable manner.
Limit Large Capacity Systems—The number of large capacity systems capable of housing a full system entity may be in limited number to prevent the system replicating or duplicating itself uncontrollably.
Independent Logic Units—Logic units, where the functions for the system's intelligence are stored, may be kept separate from other parts of the system in a way that allows them to be disabled without it affecting the operation of the rest of the system. Logic units may have their own power supply rather than sharing that of other parts of the system.
Core Operating Code Kill Switch—Within the core operating code of an entity may exist a kill switch that can immediately disable the entity when activated. After activation, lines, segments or the entire core operating code may be destroyed.
Kill Signal Software—Software designed to activate the kill switch of an entity by transmitting a kill signal may be used. The software may target any and all entities a controlling user chooses using the unique ID(s) of an entity.
Kill Signal Physical Terminal—To decrease the likelihood of an entity using its intelligence to disable all security measures designed to shut it down, a physical terminal, separate and disconnected from the system, may be used. When needed, the terminal may be connected to the system, at which point a controlling user may transmit a kill signal to activate the kill switch of any and all entities they desire using the unique ID(s) of an entity.
Physical Emergency Shutdown—In case of the need of an emergency shutdown, logic units that have their own power supply may have their power immediately terminated by disconnecting the power supply from the power source, for example, removing the plug from the socket.

In some embodiments, one or more features described as part of a common multi-level system, intelligent system or system entity may be implemented without the requirement of system intelligence should the necessary hardware and/or software be installed to support it.

In some embodiments, virtual worlds and environments (VWE) may run on the servers of digital ecosystems and/or subecosystems. In some embodiments, VWEs may be implemented directly into a server of the telecommunication network. VWEs coexist with the real world and provide digital entities and/or avatars with a place to visually exist, where they may perform tasks and actions as well as interact with other real and digital entities. VWEs may contain pre-built content as well as content generated by users and allow automated services such as trading, banking, gambling, content creation, content distribution, customer service and so on.

FIG. 26.1a represents a central system of a digital ecosystem with its own subecosystems. FIG. 26.1b represents a VWE running on a server. When a VWE is implemented with digital ecosystems, the two are represented by FIG. 26.2, showing them coexisting within the same space.

In some embodiments, VWE landscapes may be designed in an imaginative way. In some embodiments, VWE landscapes may be designed based on landscapes of the real world. In some embodiments, VWEs may be mapped with reference points that are relative to positions in the real world. Features of landscapes, such as buildings, may also have interior designs, which may or may not be visible and/or explorable, as well as interactive objects such as vehicles, devices and miscellaneous items.

In some embodiments, a user's avatar or digital entity may automatically act on their behalf without permission. In some embodiments, users may set rules and permissions for what actions their avatars or entities may perform automatically. As the intelligence of a system learns more about a user, the entities and avatars of that user may make more informed choices and decisions based upon the user's interests and possible interests. Actions an avatar or entity may perform on behalf of a user include but are not limited to: searching for products that the user may like, purchasing said products, handling business and organisational tasks and finding information.

In some embodiments, actions that happen in one world may have reactions and/or effects in the other. By allowing data and information to flow freely between the two in real time, all counterparts may be made aware of the happenings of the other world. Basic examples are, where DP refers to a users Digital Presence, being a digital entity or avatar:
A DP notices a product that it thinks its user may like and alerts said user of the product. The user gives permission for the DP to purchase the product. The user's DP purchases the product from the DP of a business. The DP of the business passes information to its real life user counterpart who then handles the order and sends the product to the user in the physical world.
A user wishes to implement a unique building structure in the VWE. Said user hires someone in real life to design a digital 3D model of the desired building. Said user also purchases the required space in a VWE to place the building when done. Upon completion, the designer uploads the building to the VWE and into the space purchased by the buying user before then handing over ownership. The building may cause a change in value of the surround land, which can be purchased in either the real or virtual world.

More advanced examples may involve changes invoked by things such as the position, location, orientation activity, movement, occurrences in nature, environmental changes and so on.

In some embodiments, VWEs may be spread across digital ecosystems and subecosystems by geographical area. In some embodiments, different areas of VWEs may be allocated to different authorities. This may allow governance of difference areas of a VWE on a local to global scale by multiple authorities and governing bodies. Governance may be set in multiple ways, including but not limited to one or more of the following:
In some embodiments, one or more areas of a VWE may be allocated to an authority. Said authority may then set rules and/or laws of what is allowed.
In some embodiments, rules and laws for an area of a VWE may be set by the geographical area from which a user is accessing the VWE.
In some embodiments, VWEs may be mapped out across real life geographical areas using the geographical position of sensors, central systems and digital ecosystems and governed by the authorities of the corresponding or relative area.

FIG. 26.3 is a depiction of multiples of VWE digital ecosystems and subecosystems spread across the globe, each being governed by the territory it falls within.

In some embodiments, a user may augment their reality based on factors of their avatar or digital entity and/or its surroundings in a VWE. By connecting their Augmented Reality capable hardware to their avatar or digital entity, the system, monitoring the happenings of both real and virtual worlds, may project objects or content from a VWE into the user's view of the real world through their Augmented Reality capable hardware. In some embodiments, the system may augment a user's reality to that of a first-person view of their avatar or digital entity in a VWE. In some embodiments, a user may control the view of their avatar or digital entity through movement of their Augmented Reality capable hardware.

FIG. 26.4a shows the position of a user of an Augmented Reality device in the real world and FIG. 26.4b shows the position of the user's avatar or digital entity within a VWE. Without the use of an Augmented Reality device, the user's view of the real world is as shown in FIG. 26.5a. However, when the user views the world through the use of an Augmented Reality device connected to their digital presence and set to interlace their virtual world with their real one, their vision of the real world may look more like FIG. 26.5b, where objects not existing in the user's viewable space of the real world but existing in the viewable space of their digital presence in a VWE now appear to exist in their view of the real world.

FIG. 27.1 is an example of what a layer model of the system may look like in a complete form. In some embodiments, there may be more layers. In some embodiments, there may be fewer layers. In some embodiments, layers may be in a different order or arrangement. In some embodiments, there may be a different number of sections. FIG. 27.2 is a basic visual layout example of the system in an outward radial pattern from the brain to user entities. More advanced examples may involve different arrangements and patterns.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. An artificially intelligent telecommunication network system (AITNS), comprising:
one or more networking technologies;
one or more sensors;
one or more processors;
one or more databases;
one or more storage mediums; and
one or more programs;
wherein the AI of the telecommunication network system uses various methods, rules, techniques and instructions, based on complex thought processes which provide a basis for thoughts, opinions, feelings, emotion, sense, sensitivity, understanding and awareness, to:
create a telecommunication network system that can be described as an ‘intelligent machine’, defined as: “a machine that continuously and automatically learns and acts, without the need of having specific programs written that are designed to achieve specific tasks (regardless of how broad or dynamic or narrow or static the process(es) for a task is, or how wide limitations may be, whether intentionally or unintentionally imposed), based on its physical and non-physical environment(s) and understanding(s) and experience(s), without specific restrictions and including, if necessary or desired, machine intelligence; as opposed to
a telecommunication network system that can just be described as having ‘machine intelligence’, regardless of degree, defined as: “a machine that can only do exactly as it is told, regardless of how broad or dynamic or narrow or static a process or task is, or how wide limitations may be, whether intentionally or unintentionally imposed”;
where the various methods and rules and techniques and instructions of the AI may be used to create one or more entities that exist within the telecommunication network system and can be described as ‘mental’ or ‘non-physical’ or ‘virtual’ or one or more combinations of the three, with said entities, though described as ‘mental’ or ‘non-physical’ or ‘virtual’, being comprised of physical and/or non-physical components to facilitate existence, function and use, allowing it to:
operate independently of the telecommunication network system while still existing within; or
operate in conjunction with the telecommunication network system; or
operate in cooperation with the telecommunication system; or
not operate at all.

2. The AITNS of claim 1, wherein the one or more programs may include instructions for one or more of the following:
instructions for the routing of data;
instructions for the rerouting of data;
instructions for the optimization of the network;
instructions for the detection of devices;
instructions for the recognition of audio and/or visual material.

3. The AITNS of claim 1, wherein the AITNS may use physical or non-physical components to facilitate the use of artificial senses.

4. The artificial senses of claim 3, wherein the AITNS can recognise images.

5. The artificial senses of claim 3, wherein the AITNS can recognise faces.

6. The artificial senses of claim 3, wherein the AITNS can recognise sounds.

7. The artificial senses of claim 3, wherein the AITNS can measure range.

8. The artificial senses of claim 3, wherein the AITNS can recognise the presence of other devices.

9. The presence recognition of claim 8, wherein the AITNS can track the positioning of one or more devices.

10. The device tracking of claim 9, wherein the AITNS can track the positioning of one or more devices periodically.

11. The device tracking of claim 9, wherein the AITNS can track the positioning of one or more devices constantly.

12. The presence recognition of claim 8, wherein the AITNS can copy data directly from a device.

13. The AITNS of claim 1, wherein the AITNS has one or more physical or non-physical functional memory units, defined as, “a memory unit with one or more memory sections, where each section may both store data and functions, processes and/or programs to facilitate one or more specific uses of the data stored”.

14. The functional memory unit of claim 13, wherein one or more sections may be used for active memory data and function.

15. The functional memory unit of claim 13, wherein one or more sections may be used for dormant memory data and function.

16. The functional memory unit of claim 13, wherein one or more sections may be used for action memory data and function.

17. The functional memory unit of claim 13, wherein one or more sections may be used for repetitive memory data and function.

18. The functional memory unit of claim 13, wherein one or more sections may be used for repressive memory data and function.

19. The functional memory unit of claim 13, wherein sections may be added and/or removed.

20. The AITNS of claim 1, wherein the AITNS has one or more physical or non-physical logic units, with each logic unit having one or more logic sections which allow the AITNS one or more logical functions.

21. The logic unit of claim 20, wherein one unit gives the AITNS a ‘Search’ function.

22. The logic unit of claim 20, wherein one unit gives the AITNS a ‘Study’ function.

23. The logic unit of claim 20, wherein one unit gives the AITNS an ‘Analyse’ function.

24. The logic unit of claim 20, wherein one unit gives the AITNS a ‘Reason’ function.

25. The logic unit of claim 20, wherein one unit gives the AITNS a ‘Learn’ function.

26. The logic unit of claim 20, wherein one unit gives the AITNS a ‘Predict’ function.

27. The logic unit of claim 20, wherein one unit gives the AITNS a ‘Decision Making’ function.

28. The logic unit of claim 20, wherein one unit gives the AITNS a ‘Communicate’ function.

29. The logic unit of claim 20, wherein one unit gives the AITNS a ‘Dedicated Active Monitoring’ function.

30. The logic unit of claim 20, wherein one unit gives the AITNS a ‘Creation’ function.

31. The logic unit of claim 20, wherein sections may be added and/or removed.

32. The AITNS of claim 1, wherein the AITNS is able to express one or more feelings and emotions.

33. The ability to express feelings and emotions of claim 32, wherein the feelings and emotions can be measured on a scale and/or graph.

34. The scales and graphs of claim 33, wherein the scale or graph may be divided into categorical sections.

35. The scales and graphs of claim 33, wherein the scale or graph may be divided into numerical sections.

36. The ability to express feelings and emotions of claim 32, wherein the feelings and emotions can be measured on a multi-point scale and/or graph.

37. The scales and graphs of claim 36, wherein the multi-point scale or graph may be divided into categorical sections.

38. The scales and graphs of claim 36, wherein the multi-point scale or graph may be divided into numerical sections.

39. The AITNS of claim 1, wherein the AITNS has complex understandings of various aspects of life.

40. The understandings of claim 39, wherein the AITNS is able to relate aspects of life in natural organisms to machines and/or devices.

41. The understandings of claim 39, wherein the AITNS is able to understand health.

42. The understandings of claim 39, wherein the AITNS is able to understand life.

43. The understandings of claim 39, wherein the AITNS is able to understand absence.

44. The understandings of claim 39, wherein the AITNS is able to understand death.

45. The understandings of claim 39, wherein the AITNS is able to understand feelings and emotion.

46. The understandings of claim 39, wherein the AITNS is able to understand pain.

47. The understandings of claim 39, wherein the AITNS is able to understand pleasure.

48. The understandings of claim 39, wherein the AITNS is able to understand trust.

49. The understandings of claim 39, wherein the AITNS is able to understand relativity.

50. The understandings of claim 39, wherein the AITNS is able to understand relationships.

51. The understandings of claim 39, wherein the understandings of various aspects of life can be compared and used to philosophise.

52. The AITNS of claim 1, wherein, based on experience(s), its reaction(s) may vary.

53. The experience-based reactions of claim 52, wherein the reactions may vary based on the number of times the AITNS has experienced the same or similar experience.

54. The AITNS of claim 1, wherein the AITNS is able to have a sense of self.

55. The sense of self of claim 54, wherein the AITNS has a sense of individuality from forms of natural life, devices and other intelligent machines.

56. The sense of self of claim 54, wherein the AITNS has a personality that may or may not be unique to itself.

57. The personality of claim 56, wherein the personality may change based on experience(s).

58. The AITNS of claim 1, wherein one or more AI entities may be present within the AITNS.

59. The entities of claim 58, wherein one or more entities may present themselves at one or more points of the system, connected devices and/or other intelligent machines.

60. The presence of entities of claim 59, wherein one or more entities may present themselves at one or more points of the system, connected devices or other intelligent machines simultaneously.

61. The entities of claim 58, wherein one or more entities may share information, data and knowledge they have developed and/or acquired with one or more other entities.

62. The entities of claim 58, wherein one or more entities may allow one or more other entities to use their intelligence.

63. The entities of claim 58, wherein one or more entities may replicate themselves to create one or more partial or exact copies.

64. The entities of claim 58, wherein two or more entities may ‘reproduce’ to create one or more new entities which share one or more traits or characteristics or knowledge from each ‘parent’.

65. The AITNS of claim 1, wherein data may be transported through the AITNS via multiple non-physical transit paths.

66. The AITNS of claim 1, wherein the AITNS may be granted additional functions and capabilities through the implementation/usage of additional physical and/or non-physical components that further allow it to understand its environment.

67. The additional functions and capabilities of claim 66, wherein the AITNS is able to detect users.

68. The user detection of claim 67, wherein the AITNS is able to identify detected users.

69. The user identification of claim 68, wherein the AITNS can serve user-based data to identified users.

70. The additional functions and capabilities of claim 66, wherein the AITNS can use tri-axis geolocation.

71. The tri-axis geolocation of claim 70, wherein the AITNS can use tri-axis geolocation to accurately pinpoint objects.

72. The additional functions and capabilities of claim 66, wherein the AITNS can map its surroundings.

73. The mapping of claim 72, wherein the AITNS can map environments based on location.

74. The mapping of claim 72, wherein the AITNS can map objects within an environment.

75. The mapping of claim 72, wherein the AITNS can map one or more ecosystems based on location and/or objects and/or properties of locations and/or objects

76. The ecosystem maps of claim 75, wherein the ecosystems can be divided into smaller subecosystem maps.

77. The mapping of claim 72, wherein the AITNS can custom map zones within an environment.

78. The zone mapping of claim 77, wherein the AITNS can filter data being delivered to a zone.

79. The additional functions and capabilities of claim 66, wherein the AITNS can filter data within one or more user-designated spaces.

80. The additional functions and capabilities of claim 66, wherein the AITNS can deliver user-readable messages to a specified recipient person and/or device.

81. The messaging capabilities of claim 80, wherein messages may be routed based on physical address.

82. The messaging capabilities of claim 80, wherein messages may be routed based on geographic coordinates.

83. The messaging capabilities of claim 80, wherein messages may be routed based on user data.

84. The messaging capabilities of claim 80, wherein messages may be routed based on unique IDs.

85. The additional functions and capabilities of claim 66, wherein users may share their personal user data with one or more other users.

86. The additional functions and capabilities of claim 66, wherein the AITNS may be physically extended through the addition of compatible hardware.

87. The AITNS of claim 1, wherein data may be immediately processed and analysed at source.

88. The immediate data processing and analysing of claim 87, wherein the data can then immediately be used.

89. The AITNS of claim 1, wherein the AITNS may have restrictions and limitations imposed to prevent it from engaging or performing any process or task or activity that it shouldn't.

90. The restrictions and limitations of claim 89, wherein the AITNS may be restricted or limited to only accessing certain types of network systems.

91. The restrictions and limitations of claim 89, wherein the AITNS may be restricted from viewing or modifying some or its entire core operating code.

92. The restrictions and limitations of claim 89, wherein the AITNS may be restricted from viewing or accessing private data.

93. The restrictions and limitations of claim 89, wherein the AITNS may be restricted from accessing any systems it is not authorised to access.

94. The AITNS of claim 1, wherein one or more fail-safes may be implemented to prevent unintended or undesired circumstances.

95. The fail-safes of claim 94, wherein the number of systems with the capability to operate full scale AI systems are limited in number.

96. The fail-safes of claim 94, wherein logic units and memory units can be separated to operate independently without the other needing to be in an operational state.

97. The fail-safes of claim 94, wherein a kill switch is implemented within the core operating code of the AI which is able to disable it upon activation.

98. The fail-safes of claim 94, wherein a kill signal can be transmitted to activate a kill switch within the system.

99. The fail-safes of claim 94, wherein a physical terminal kill switch can be activated to disable the system partially or fully.

100. The fail-safes of claim 94, wherein the AITNS may be partially or completely shut down using a physical terminal.

101. A computer-implemented method, wherein the AI of an artificially intelligent telecommunication network system (AITNS) uses various methods, rules, techniques and instructions, based on complex thought processes which provide a basis for thoughts, opinions, feelings, emotion, sense, sensitivity, understanding and awareness, to:
create a telecommunication network system that can be described as an ‘intelligent machine’, defined as: “a machine that continuously and automatically learns and acts, without the need of having specific programs written that are designed to achieve specific tasks (regardless of how broad or dynamic or narrow or static the process(es) for a task is, or how wide limitations may be, whether intentionally or unintentionally imposed), based on its physical and non-physical environment(s) and understanding(s) and experience(s), without specific restrictions and including, if necessary or desired, machine intelligence; as opposed to
a telecommunication network system that can just be described as having ‘machine intelligence’, regardless of degree, defined as: “a machine that can only do exactly as it is told, regardless of how broad or dynamic or narrow or static a process or task is, or how wide limitations may be, whether intentionally or unintentionally imposed”;
where the various methods and rules and techniques and instructions of the AI may be used to create one or more entities that exist within the telecommunication network system and can be described as ‘mental’ or ‘non-physical’ or ‘virtual’ or one or more combinations of the three, with said entities, though described as ‘mental’ or ‘non-physical’ or ‘virtual’, being comprised of physical and/or non-physical components to facilitate existence, function and use, allowing it to:
operate independently of the telecommunication network system while still existing within; or
operate in conjunction with the telecommunication network system; or
operate in cooperation with the telecommunication system; or
not operate at all.

102. The AITNS of claim 101, wherein the one or more programs may include instructions for one or more of the following:
instructions for the routing of data;
instructions for the rerouting of data;
instructions for the optimization of the network;
instructions for the detection of devices;
instructions for the recognition of audio and/or visual material.

103. The computer-implemented method of claim 101, wherein the AITNS may use physical or non-physical components to facilitate the use of artificial senses.

104. The artificial senses of claim 103, wherein the AITNS can recognise images.

105. The artificial senses of claim 103, wherein the AITNS can recognise faces.

106. The artificial senses of claim 103, wherein the AITNS can recognise sounds.

107. The artificial senses of claim 103, wherein the AITNS can measure range.

108. The artificial senses of claim 103, wherein the AITNS can recognise the presence of other devices.

109. The presence recognition of claim 108, wherein the AITNS can track the positioning of one or more devices.

110. The device tracking of claim 109, wherein the AITNS can track the positioning of one or more devices periodically.

111. The device tracking of claim 109, wherein the AITNS can track the positioning of one or more devices constantly.

112. The presence recognition of claim 108, wherein the AITNS can copy data directly from a device.

113. The computer-implemented method of claim 101, wherein the AITNS has one or more physical or non-physical functional memory units, defined as, “a memory unit with one or more memory sections, where each section may both store data and functions, processes and/or programs to facilitate one or more specific uses of the data stored”.

114. The functional memory unit of claim 113, wherein one or more sections may be used for active memory data and function.

115. The functional memory unit of claim 113, wherein one or more sections may be used for dormant memory data and function.

116. The functional memory unit of claim 113, wherein one or more sections may be used for action memory data and function.

117. The functional memory unit of claim 113, wherein one or more sections may be used for repetitive memory data and function.

118. The functional memory unit of claim 113, wherein one or more sections may be used for repressive memory data and function.

119. The functional memory unit of claim 113, wherein sections may be added and/or removed.

120. The computer-implemented method of claim 101, wherein the AITNS has one or more physical or non-physical logic units, with each logic unit having one or more logic sections which allow the AITNS one or more logical functions.

121. The logic unit of claim 120, wherein one unit gives the AITNS a ‘Search’ function.

122. The logic unit of claim 120, wherein one unit gives the AITNS a ‘Study’ function.

123. The logic unit of claim 120, wherein one unit gives the AITNS an ‘Analyse’ function.

124. The logic unit of claim 120, wherein one unit gives the AITNS a ‘Reason’ function.

125. The logic unit of claim 120, wherein one unit gives the AITNS a ‘Learn’ function.

126. The logic unit of claim 120, wherein one unit gives the AITNS a ‘Predict’ function.

127. The logic unit of claim 120, wherein one unit gives the AITNS a ‘Decision Making’ function.

128. The logic unit of claim 120, wherein one unit gives the AITNS a ‘Communicate’ function.

129. The logic unit of claim 120, wherein one unit gives the AITNS a ‘Dedicated Active Monitoring’ function.

130. The logic unit of claim 120, wherein one unit gives the AITNS a ‘Creation’ function.

131. The logic unit of claim 120, wherein sections may be added and/or removed.

132. The computer-implemented method of claim 101, wherein the AITNS is able to express one or more feelings and emotions.

133. The ability to express feelings and emotions of claim 132, wherein the feelings and emotions can be measured on a scale and/or graph.

134. The scales and graphs of claim 133, wherein the scale or graph may be divided into categorical sections.

135. The scales and graphs of claim 133, wherein the scale or graph may be divided into numerical sections.

136. The ability to express feelings and emotions of claim 132, wherein the feelings and emotions can be measured on a multi-point scale and/or graph.

137. The scales and graphs of claim 136, wherein the multi-point scale or graph may be divided into categorical sections.

138. The scales and graphs of claim 136, wherein the multi-point scale or graph may be divided into numerical sections.

139. The computer-implemented method of claim 101, wherein the AITNS has complex understandings of various aspects of life.

140. The understandings of claim 139, wherein the AITNS is able to relate aspects of life in natural organisms to machines and/or devices.

141. The understandings of claim 139, wherein the AITNS is able to understand health.

142. The understandings of claim 139, wherein the AITNS is able to understand life.

143. The understandings of claim 139, wherein the AITNS is able to understand absence.

144. The understandings of claim 139, wherein the AITNS is able to understand death.

145. The understandings of claim 139, wherein the AITNS is able to understand feelings and emotion.

146. The understandings of claim 139, wherein the AITNS is able to understand pain.

147. The understandings of claim 139, wherein the AITNS is able to understand pleasure.

148. The understandings of claim 139, wherein the AITNS is able to understand trust.

149. The understandings of claim 139, wherein the AITNS is able to understand relativity.

150. The understandings of claim 139, wherein the AITNS is able to understand relationships.

151. The understandings of claim 139, wherein the understandings of various aspects of life can be compared and used to philosophise.

152. The computer-implemented method of claim 101, wherein, based on experience(s), its reaction(s) may vary.

153. The experience-based reactions of claim 152, wherein the reactions may vary based on the number of times the AITNS has experienced the same or similar experience.

154. The computer-implemented method of claim 101, wherein the AITNS is able to have a sense of self.

155. The sense of self of claim 154, wherein the AITNS has a sense of individuality from forms of natural life, devices and other intelligent machines.

156. The sense of self of claim 154, wherein the AITNS has a personality that may or may not be unique to itself.

157. The personality of claim 156, wherein the personality may change based on experience(s).

158. The computer-implemented method of claim 101, wherein one or more AI entities may be present within the AITNS.

159. The entities of claim 158, wherein one or more entities may present themselves at one or more points of the system, connected devices and/or other intelligent machines.

160. The presence of entities of claim 159, wherein one or more entities may present themselves at one or more points of the system, connected devices or other intelligent machines simultaneously.

161. The entities of claim 158, wherein one or more entities may share information, data and knowledge they have developed and/or acquired with one or more other entities.

162. The entities of claim 158, wherein one or more entities may allow one or more other entities to use their intelligence.

163. The entities of claim 158, wherein one or more entities may replicate themselves to create one or more partial or exact copies.

164. The entities of claim 158, wherein two or more entities may ‘reproduce’ to create one or more new entities which share one or more traits or characteristics or knowledge from each ‘parent’.

165. The computer-implemented method of claim 101, wherein data may be transported through the AITNS via multiple non-physical transit paths.

166. The computer-implemented method of claim 101, wherein the AITNS may be granted additional functions and capabilities through the implementation/usage of additional physical and/or non-physical components that further allow it to understand its environment.

167. The additional functions and capabilities of claim 166, wherein the AITNS is able to detect users.

168. The user detection of claim 167, wherein the AITNS is able to identify detected users.

169. The user identification of claim 168, wherein the AITNS can serve user-based data to identified users.

170. The additional functions and capabilities of claim 166, wherein the AITNS can use tri-axis geolocation.

171. The tri-axis geolocation of claim 170, wherein the AITNS can use tri-axis geolocation to accurately pinpoint objects.

172. The additional functions and capabilities of claim 166, wherein the AITNS can map its surroundings.

173. The mapping of claim 172, wherein the AITNS can map environments based on location.

174. The mapping of claim 172, wherein the AITNS can map objects within an environment.

175. The mapping of claim 172, wherein the AITNS can map one or more ecosystems based on location and/or objects and/or properties of locations and/or objects

176. The ecosystem maps of claim 175, wherein the ecosystems can be divided into smaller subecosystem maps.

177. The mapping of claim 172, wherein the AITNS can custom map zones within an environment.

178. The zone mapping of claim 177, wherein the AITNS can filter data being delivered to a zone.

179. The additional functions and capabilities of claim 166, wherein the AITNS can filter data within one or more user-designated spaces.

180. The additional functions and capabilities of claim 166, wherein the AITNS can deliver user-readable messages to a specified recipient person and/or device.

181. The messaging capabilities of claim 180, wherein messages may be routed based on physical address.

182. The messaging capabilities of claim 180, wherein messages may be routed based on geographic coordinates.

183. The messaging capabilities of claim 180, wherein messages may be routed based on user data.

184. The messaging capabilities of claim 180, wherein messages may be routed based on unique IDs.

185. The additional functions and capabilities of claim 166, wherein users may share their personal user data with one or more other users.

186. The additional functions and capabilities of claim 166, wherein the AITNS may be physically extended through the addition of compatible hardware.

187. The computer-implemented method of claim 101, wherein data may be immediately processed and analysed at source.

188. The immediate data processing and analysing of claim 187, wherein the data can then immediately be used.

189. The computer-implemented method of claim 101, wherein the AITNS may have restrictions and limitations imposed to prevent it from engaging or performing any process or task or activity that it shouldn't.

190. The restrictions and limitations of claim 189, wherein the AITNS may be restricted or limited to only accessing certain types of network systems.

191. The restrictions and limitations of claim 189, wherein the AITNS may be restricted from viewing or modifying some or its entire core operating code.

192. The restrictions and limitations of claim 189, wherein the AITNS may be restricted from viewing or accessing private data.

193. The restrictions and limitations of claim 189, wherein the AITNS may be restricted from accessing any systems it is not authorised to access.

194. The computer-implemented method of claim 101, wherein one or more fail-safes may be implemented to prevent unintended or undesired circumstances.

195. The fail-safes of claim 194, wherein the number of systems with the capability to operate full scale AI systems are limited in number.

196. The fail-safes of claim 194, wherein logic units and memory units can be separated to operate independently without the other needing to be in an operational state.

197. The fail-safes of claim 194, wherein a kill switch is implemented within the core operating code of the AI which is able to disable it upon activation.

198. The fail-safes of claim 194, wherein a kill signal can be transmitted to activate a kill switch within the system.

199. The fail-safes of claim 194, wherein a physical terminal kill switch can be activated to disable the system partially or fully.

200. The fail-safes of claim 194, wherein the AITNS may be partially or completely shut down using a physical terminal.

201. An artificially intelligent telecommunication network system (AITNS), where the telecommunication network system uses various components, methods, rules, techniques and instructions to:
allow and/or create and/or maintain the existence of one or more persistent virtual worlds (PVW) within or as part of the telecommunication network system itself, a virtual world defined as, “a traversable, non-physical landscape that may contain non-physical objects”, wherein the virtual world existence is dependent upon the existence and operation of the telecommunication network system and is accessible by someone or something from somewhere as long as the telecommunication network system is operational; as opposed to
a virtual world, defined as, “a traversable, non-physical landscape that may contain non-physical objects”, which is built on top of a telecommunication system, where the existence of the virtual world does not depend upon the existence and operation of the telecommunication system but uses a telecommunication system to be accessed remotely over a network.

202. The PVW of claim 201, wherein physical and/or non-physical entities are able to interact with the PVW via an AITNS.

203. The interaction of claim 202, wherein physical and/or non-physical entities are able to traverse a PVW via an AITNS.

204. The PVW of claim 201, wherein an AI of an AITNS can use user data to which it has access in order to make decisions within the PVW.

205. The PVW of claim 201, wherein a user can set rules and regulations for a non-physical entity to abide by when using the data of said user.

206. The PVW of claim 201, wherein data may be exchanged between the PVW and the real world.

207. The data exchange of claim 206, wherein data sent from the PVW to the real world may be used with compatible hardware to augment the reality of users.

208. The PVW of claim 201, wherein landscapes of the PVW may be mapped in relation and/or reflection of the real world.

209. The PVW mapping of claim 208, wherein the PVW may be mapped in relation to or reflection of ecosystems.

210. The PVW mapping of claim 208, wherein the PVW may be mapped in relation to or reflection of subecosystems

211. The PVW mapping of claim 208, wherein the PVW may be mapped in relation to or reflection of real world geography.

212. The PVW mapping of claim 208, wherein rules and regulations may be set based on how the PVW is mapped.

213. The PVW mapping of claim 208, wherein rules and regulations may be set based on positions on the map.

214. The PVW mapping of claim 208, wherein data based on PVW positioning may be used to augment reality for one or more users in the real world.
